(19) United States
(12) Patent Application Publication
(10) Pub. No.: US 2004/0220858 A1
(43) Pub. Date: Nov. 4, 2004

(54) Method and system for verifying exposure to message content delivered via subscription networks

(76) Inventor: Frank S. Maggio, St. Petersburg, FL (US)

Correspondence Address: KING & SPALDING LLP, 191 PEACHTREE STREET, N.E., ATLANTA, GA, 30303-1763, US

(21) Appl. No.: 10/835,771

(22) Filed: Apr. 30, 2004

Related U.S. Application Data
(60) Provisional application No. 60/467,759, filed on May 2, 2003.

(51) Int. Cl. G06F 17/60; H04N 7/16; H04H 9/00; H04N 7/025; H04N 7/10

(52) U.S. Cl. 705/14; 725/22; 725/32

(57) ABSTRACT

Providing advertising comprises communicating, through a mass-media, non-interactive broadcast network, an advertisement pod comprising multiple advertisements. Each advertisement comprises advertising content. A prize pool is created based on subscription fees, advertising premiums, sponsorship fees, user fees, entrance fees, and/or non-cash prizes. A query is communicated about a selected portion of the advertising content of at least one of the advertisements. An offer of a reward is presented as an incentive for each recipient to review the advertisements and to submit a response to the query. The reward is based on the prize pool. Respective responses to the query are collected through a response device from responding ones of the recipients. Receipt of each response having a correct reply to the query verifies that the responding recipient has been exposed to the selected portion of the advertising content. A winner of the reward is selected from responding recipients.

### RELATED APPLICATIONS

This application claims priority under 35 U.S.C. § 119 to U.S. Provisional Patent Application No. 60/467,759 filed May 2, 2003 and entitled “A System and Process of Distributing One or Multiple Synchronous Reactive CR\overline{A}V ads or Ad Pods Over One or Multiple Broadcast, Cable, Satellite, or Other Network Channels, Including Subscription Based Channels, and Utilizing An Information Gathering Network and System to Collect Reactive Responses to the CR\overline{A}V ads and Pods, and to Substantially Reward A Portion of Those Reacting to the CR\overline{A}V ads or Ad Pods.”

This application also is related to U.S. patent application Ser. No. 10/439,121 filed May 15, 2003 and entitled “Method and System for Verifying Exposure to Message Content Delivered Via Outdoor Media or in a Concentrated Format,” which claims priority under 35 U.S.C. § 119 to U.S. Provisional Patent Application No. 60/381,149, filed May 16, 2002 and entitled “Mass Media Advertising Distribution and Usage System,” and which is a continuation-in-part of U.S. patent application Ser. No. 10/434,622 filed May 9, 2003 and entitled “Method and System for Verifying Exposure to Message Content Via a Printed Response,” which claims priority under 35 U.S.C. § 119 to U.S. Provisional Patent Application No. 60/379,799, filed May 10, 2002 and entitled “Methods and Systems of Utilizing Printed Responses and Other Printed Items as response devices in the CR\overline{A}V Immersion Verification and Registration System and Process,” and is a continuation-in-part of U.S. patent application Ser. No. 09/820,482 (now U.S. Pat. No. 6,606,745), filed Mar. 29, 2001 and entitled “Method and System for Communicating Advertising and Entertainment Content and Gathering Consumer Information,” which claims priority under 35 U.S.C. § 119 to U.S. Provisional Patent Application No. 60/239,631, filed Oct. 12, 2000 and entitled “System and Method for Using Linked Sponsorships to Increase Mass-Market Appeal of Content.”

The complete disclosure of each of the priority and related applications listed above is hereby fully incorporated herein by reference.

### FIELD OF THE INVENTION

The present invention relates to techniques for communicating content, and more particularly to techniques for communicating advertising content and entertainment content. Specifically, the present invention relates to verifying content exposure via a response to an immersion verification query.

### BACKGROUND OF THE INVENTION

In the traditional advertising model, media (e.g., TV networks, radio stations, newspapers, magazines) develop entertainment content (e.g., a TV show) of interest to consumers. The consumers are persons who may use an advertiser's commodity or service, and who view, hear, read, or otherwise absorb the entertainment content, as well as advertising content (“ads”). The advertisers are entities that distribute the ads to induce the consumers to buy, use, or do something. The media delivers the entertainment content and the ads to the consumers (e.g., over the air, by cable transmission, by print media mass distribution, outdoor media, Internet, and private networks). Media may charge the consumers for the entertainment content delivery, but typically media receives most revenue from the advertisers in exchange for delivering ads with the entertainment content.

Promoters initiate, develop, generate, and/or distribute entertainment content, attracting many of the consumers and, in turn, attracting the advertisers. The advertisers sponsor the entertainment content by paying the promoters to deliver the ads with the entertainment content. Advertising fees generally increase as the number of the consumers absorbing the ads increases. The promoters use the advertising fees to offset the promoters' costs to produce and distribute the advertising content and to make a profit. The consumers usually do not pay to see, hear, or otherwise absorb the entertainment content. The consumers also do not receive payment for seeing, hearing, or otherwise absorbing the ads. The consumers' traditional reward is the ability to see, hear, or otherwise absorb and enjoy the entertainment content for little or no charge, in exchange for tolerating the ads.

Recent technological advancements (i.e., the Internet) have caused an increase in possible broadcast outlets. With this increase, the consumers are distracted by multiple entertainment forms. As a result, the advertisers have more difficulty reaching mass numbers of the consumers. In addition, the promoters have more difficulty guaranteeing many of the consumers will watch, hear, or otherwise absorb the entertainment content and the ads. This phenomenon has led to lower advertising fees and thus lower profitability to the promoters.

The advertisers' goal is to provide the consumers with ads they will remember that include information on the advertisers' product or service. However, the consumers typically ignore and avoid the ads. The consumers often “tune out,” change the channel, or walk away when the ads appear. In addition, the consumers increasingly turn to less advertising-dependent entertainment forms (e.g., premium channels), or use technology (e.g., video recorders, personal recording devices) to skip the ads.

Advertising can be divided into two classes: mass-media advertising and targeted advertising. Mass media advertising (e.g., over a broadcast network such as TV, radio, newspaper, magazine, mass mail, mass e-mail, etc.) sends broadly based advertising messages to a wide spectrum of the consumers. In that regard, mass-media broadcasting of advertisements comprises presenting one or more advertisements through the broadcast network such that anyone receiving the broadcast network receives the same advertising content, regardless of the person's demographics or other criteria. For example, each person tuning into the same TV channel, Internet website, or radio station, or reading the same magazine page, newspaper page, or billboard, will receive the same advertisement content. Accordingly, those advertisements comprise mass-media broadcast advertisements. On the other hand, targeted advertising focuses on delivering specific, personalized advertising to the consumers that meet a demographic profile specified by the advertisers. Mass media advertising is usually less expensive per impression than targeted advertising. However, targeted advertising is usually more effective and has become less expensive per impression as technology has progressed. As a result, the effectiveness of mass-media advertising has been questioned.

In view of the foregoing, there is a need for a cost-effective, entertaining, rewarding, and effective way of mass-media advertising. A need also exists for verifying consumer immersion in the mass-media advertising. In addition, there is a need for a cost-effective way to gather information useful to the advertisers. A need also exists for increasing available prize pools based on subscription fees for mass-media, broadcast networks.

### SUMMARY OF THE INVENTION

The present invention solves the above problems by providing a cost-effective, entertaining, rewarding, and effective way to present entertainment content and ads to a mass audience. For example, the present invention can transform advertising from something consumers avoid to a drawing card that attracts the consumers. The consumers can be presented with an opportunity to remember ads and to win valuable prizes. This opportunity may increase viewership, consumer entertainment, and advertising immersion.

The present invention can communicate Consumer Rewarded Advertising Vehicle Immersive Ad Bundles (“CR\overline{A}V ads”). The CR\overline{A}V ads can comprise an ad including an advertising vignette (“vignette”) and a verification query (“query”). An optional immersion alert (“alert”) may also be added. In addition, an optional correct answer (“answer”) may be added. The CR\overline{A}V ads may be any duration. The CR\overline{A}V ads may be visual and/or audible. The CR\overline{A}V ads may be spoken, printed, displayed, heard, or communicated by any possible means, or any combination of possible means. Another option, called a “sneak peek” vignette, may be used to promote the CR\overline{A}V ads. The sneak peek vignette may be identical to the CR\overline{A}V ad vignette. The sneak peek vignette may also contain other information that helps the consumers answer the query.

The present invention can involve a broadcast network, a response device, an information gathering system, and a data storage center. The consumers, advertisers, promoters, or other entities can use the present invention. The consumers comprise persons (recipients) who may use the advertiser's commodity or service, and who view, hear, read, or otherwise absorb the entertainment content and the ads. The advertisers comprise entities that distribute the ads to induce the consumers to buy, use, or do something. The promoters can initiate, develop, generate, and/or distribute entertainment content attracting many of the consumers and will in turn attract the advertisers.

The broadcast network can connect the consumers with the entertainment content and the ads. According to one aspect of the present invention, the broadcast network can comprise TV, cable, radio, printed media (magazines, newspapers) outdoor media (billboards, signs, buses) mass mail, mass e-mail, streaming Internet, private networks, or any other mass-media broadcast. The broadcast network can charge a subscription fee for consumers to receive the entertainment and advertising content broadcast via the network. The subscription fee can increase the prize pool available to consumers that respond to CR\overline{A}V ads.

Consumers can communicate consumer information and answers to queries about the CR\overline{A}V ads via the response devices to the information gathering system. The information gathering system can collect and forward that information to the data storage center. The data storage center can parse the responses for correct answers to the queries and can select a winner of a prize based on the prize pool.

Subscription fees can further enhance the efficacy of CR\overline{A}V ads by increasing audience sizes and excitement through increased prizing levels or pools promoted across one or more broadcast (mass-media) networks. In addition to collecting traditional advertising fees for embedded advertising within entertainment content, the promoter can charge a subscription fee to consumers who purchase access to the broadcast signal. The promoter can redistribute a portion of the subscription fee to the subscriber base in exchange for skill-based correct or random responses to queries about content, CR\overline{A}V ads, or a combination thereof. The subscription fees also can subsidize or pay for the costs of some or the entire technical and human resource infrastructure required to develop, support, and broadcast televised content across the network or networks. To attract larger and more diverse audiences, multiple networks with targeted content channels can broadcast simultaneously, and the promoter can combine subscription fees with CR\overline{A}V ad premiums from all channels to increase the CR\overline{A}V prize pools. The larger CR\overline{A}V prize pools can entice more consumers (recipients) to participate in the reactive CR\overline{A}V ad process. The promoters can charge the CR\overline{A}V ad premiums because consumers are more likely to immerse themselves in CR\overline{A}V ad content.

### BRIEF DESCRIPTION OF THE DRAWINGS

FIG. 1 is a block diagram illustrating the primary components of an exemplary embodiment of the present invention.

FIG. 2 is a flow diagram illustrating an overview of an exemplary CR\overline{A}V ad process.

FIG. 3 is a flow diagram illustrating an exemplary process describing how the promoters sell the CR\overline{A}V ads to the advertisers.

FIG. 4 is a flow diagram illustrating an exemplary process describing how the promoters and the advertisers use the broadcast network to promote future CR\overline{A}V ads.

FIG. 5 is a flow diagram illustrating an exemplary process describing how the privacy option applies to the invention.

FIG. 6 is a flow diagram illustrating an exemplary process describing how the promoters use the broadcast network, the device, the information gathering system, and the data storage center to communicate the CR\overline{A}V ads to the consumers and to interact with the consumers.

FIG. 7 is a flow diagram illustrating an exemplary process describing how the promoter communicates the alert, the vignette, and the query using the broadcast network.

FIG. 8 is a flow diagram illustrating an exemplary process describing how the consumers answer the CR\overline{A}V ads.

FIGS. 9A and 9B, together comprising FIG. 9, are picture diagrams illustrating an exemplary nationwide network for gathering CR\overline{A}V ad responses.

FIG. 10 is a picture diagram illustrating how the information gathering system sends the registration and the response information to the data storage center in an exemplary embodiment.

FIG. 11 is a flow diagram illustrating an exemplary process describing how the promoters select winners and distribute prizes.

FIG. 12 is a flow diagram illustrating an exemplary process describing an overview of a CR\overline{A}V ad process.

FIG. 13 is a flow diagram illustrating an exemplary process describing how the ad slots are sold.

FIG. 14 is a chart illustrating how the ad price is determined in an exemplary embodiment.

FIG. 15 is a picture flow diagram illustrating an exemplary CR\overline{A}V ad process for ABS and ACME to promote future CR\overline{A}V ads.

FIG. 16 is a chart illustrating a CR\overline{A}V record in an exemplary embodiment.

FIG. 17 is a flow chart illustrating how ABS broadcasts the CR\overline{A}V ads in an exemplary embodiment.

FIG. 18 illustrates the CR\overline{A}V ad the consumers see in an exemplary embodiment.

FIG. 19 is a flow diagram illustrating how the CR\overline{A}V ads are answered by the customers in an exemplary embodiment.

FIG. 20 is a flow diagram illustrating how the CR\overline{A}V ads are answered by the Dalys in an exemplary embodiment.

FIG. 21 illustrates a representative OMR printed response according to an exemplary embodiment of the present invention.

FIG. 22 illustrates a representative OCR printed response according to an exemplary embodiment of the present invention.

FIG. 23 illustrates a representative manual data entry printed response according to an exemplary embodiment of the present invention.

FIG. 24 illustrates a representative multiple-entry printed response according to an exemplary embodiment of the present invention.

FIG. 25 is a flow chart depicting a method for providing an advertisement that combines CR\overline{A}V ad elements with the interactive portion of a reply according to an exemplary embodiment of the present invention.

FIG. 26 illustrates a print media advertisement according to an exemplary embodiment of the present invention.

FIG. 27 illustrates a print media advertisement pod according to an exemplary embodiment of the present invention.

FIG. 28 illustrates a CR\overline{A}V ad broadcast over a convergence of mass-media formats according to an exemplary embodiment of the present invention.

FIG. 29 illustrates the ratio of ad minutes to content minutes in a conventional programming hour-long broadcast.

FIG. 30 illustrates the ratio of ad minutes to hosted program minutes in a CR\overline{A}V game show hour-long broadcast according to an exemplary embodiment of the present invention.

FIG. 31 illustrates a representative CR\overline{A}V game show two minute segment according to an exemplary embodiment of the present invention.

FIG. 32 illustrates the substitution of conventional advertising segments with CR\overline{A}V ad segments broadcast on a continuous CR\overline{A}V network according to an exemplary embodiment of the present invention.

FIG. 33 is a flowchart depicting a method for substituting a CR\overline{A}V advertisement for a conventional advertisement according to an exemplary embodiment of the present invention.

FIG. 34 is a flow chart depicting a method for immersion-based advertising according to an exemplary embodiment of the present invention.

FIG. 35 is a flow chart depicting a method for creating a prize pool according to an exemplary embodiment of the present invention.

FIG. 36 is a pie chart depicting content distribution of a broadcast hour according to an exemplary embodiment of the present invention.

### DETAILED DESCRIPTION OF THE EXEMPLARY EMBODIMENTS

The present invention solves the above problems by providing a cost-effective, entertaining, rewarding, and effective way to present ads to an audience. For example, the present invention transforms advertising from something consumers avoid to a drawing card that attracts the consumers. The consumers are presented with an opportunity to win valuable prizes. This opportunity increases viewership, consumer entertainment, and advertising immersion.

The present invention may be used by promoters to increase an ad's appeal, while substantially and cost-effectively enhancing an advertiser's promotion and retention of its products and services. When compared to traditional mass-media advertising, an exemplary embodiment delivers ads that cause the consumers to fully immerse themselves in the ad. An exemplary embodiment can deliver ads in print, by radio, by TV, as a game show, or by any other method that communicates with the consumers.

Immersion is a heightened attention level that causes the consumers to remember the ads. Immersion is the highest, most effective, and valuable attention level. Immersion helps the advertisers achieve a maximized share of the consumers' mind for their product. Products are remembered easier and faster than competing products.

Immersion is enhanced by several methods. First, immersion is enhanced when the ad triggers an immediate emotional response within the brain, such as a warning or alert signal. This signal causes the consumers to pay more attention to the ads, and increases the likelihood the consumers will remember the ads. When the consumers interact with the ads, as opposed to passively viewing or hearing the ads, the consumers are more likely to remember the ads. A memorization request also increases immersion by testing the consumers' ability to recall the ads. In addition, extended exposure, which is obtained by a longer effective ad length, increases the likelihood of immersion. Effective length begins from the first moment one recognizes the brand advertised. Another advertising technique that increases immersion is using alternate, multiple media vehicles for distributing advertising (i.e., using print or Internet-based advertising simultaneously, or following, TV advertising). Rewards also help to create immersion because the consumers like challenges and rewards, and likable ads are more readily and easily recalled.

CR\overline{A}V Ad Description

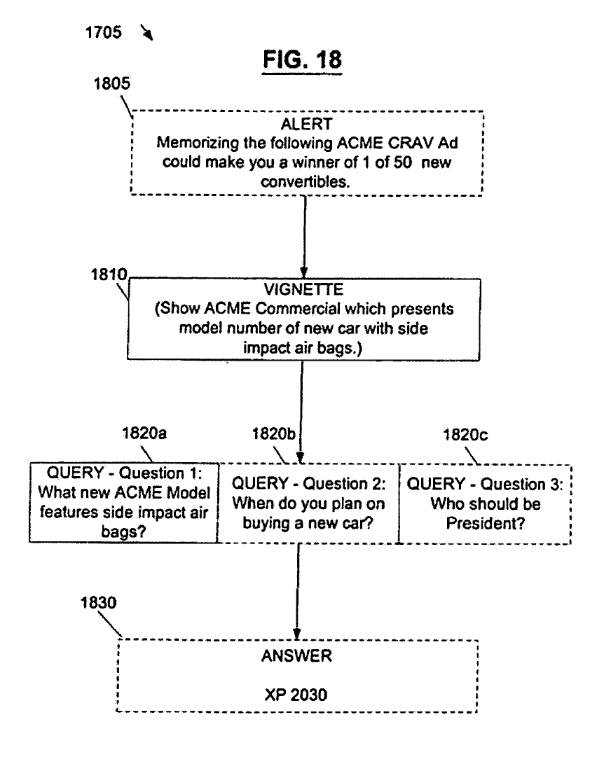

Consumer Rewarded advertising Vehicle Immersive Ad Bundles (“CR\overline{A}V ads”) provide a process for promoters to increase viewership and immersion. A CR\overline{A}V ad example will be discussed while referring to FIG. 18 later in this document. However, for purpose of defining the CR\overline{A}V ad, it is useful to refer to FIG. 18 at this time.

Turning now to FIG. 18, an exemplary CR\overline{A}V ad is displayed. The CR\overline{A}V ad is an ad including at least an advertising vignette (“vignette”) 1810 and a verification query (“query”) 1820. An immersion alert (“alert”) 1805 also can be included. In addition, an optional correct answer (“answer”) 1830 may be added. These parts create a CR\overline{A}V ad that may be any duration. The CR\overline{A}V ad may be visual and/or audible. The CR\overline{A}V ad may be spoken, printed, displayed, heard, or communicated by any other possible means, or any combination of possible means. A CR\overline{A}V ad, or a series of CR\overline{A}V ads, may also be the basis for an entire show.

Some or all of the components of the query 1820 may be “detached” from the vignette 1810 (i.e., the vignette 1810 may be in print and the query 1820 may be posted on-line or by phone). In addition, the response time for the query 1820 may be limited to cause the consumers to memorize the vignette 1810 for expedited recall (from memory) when asked the query 1820. Similarly, the alert 1805 and/or the answer 1830 may be detached from the vignette 1810 and/or the query 1820. Accordingly, the vignette, query, alert, and offer of a reward can be communicated via the same communications media or different communications media. The communications media can comprise a broadcast network 105 or a response device 111.

The alert 1805, which is optional (as indicated by the dashed lines), is a warning to the consumers that the upcoming vignette 1810 should be memorized so the consumers may become eligible to win a reward. The alert 1805 could be any cue or operational procedure that leads the consumers to believe that immersion may lead to a reward. The alert 1805 may be as simple as a logo (such as a CR\overline{A}V logo), a sound, or some other discrete notice. The alert 1805 may also include much more extensive data. The alert 1805 may include the product's brand name and information on the identity of the available rewards. By providing branding during the alert 1805, the advertisers effectively begin the CR\overline{A}V ad's exposure time. The alert 1805 is an urgency signal and a memorization request. These advertising techniques increase the likelihood of the consumer remembering the ad. The alert 1805 may be any duration.

Following the alert 1805, a vignette 1810 is broadcast. The vignette 1810 may be a conventional commercial for a product or service or any other information designed for presentation to a consuming audience. This may include key product or service benefits, pricing information, image building information, etc. The vignette 1810 may be any duration.

Following the vignette 1810 broadcast, the query 1820 is broadcast. The query 1820 includes one or more questions. One question may be linked to the vignette 1810. This question is designed to require the consumers to remember certain information. The other questions may ask for public opinion, trivia, or other information, and these questions may be asked on-line or off-line. The query 1820 questions may be displayed on a separate screen following the vignette 1810, asked by a crawl-line below the entertainment content, or shown in an alternative way, such as off-line. The query 1820 may serve to increase the effective length of the CR\overline{A}V ad, even though the traditional ad (i.e., video or audio clip) extends for a conventional duration, because the consumers must continue concentrating on the product as advertised during the immersion verification and query response process. During the query 1820, the promoters or the advertisers may provide potential multiple choice answers or require the consumers to provide the answer without the aid of multiple choice answers. The query 1820 includes one or more questions and may include reward information, registration or login instructions, multiple choice answers, a “time remaining” counter, and brand information. The CR\overline{A}V ad may end following the query 1820.

The answer 1830 may be added and is optional, as shown by the dashed lines in the answer 1830. The answer 1830 extends the CR\overline{A}V ad's effective length. The answer 1830 includes the answer or answers to the query's 1820 one or more questions, where applicable. The answer 1830 also may include logo or other information. The answer 1830 may be broadcast via a TV medium, or distributed by an alternate communications medium (e.g., radio, print, Phone 145, Internet 130).

Another option, called the “sneak peek” vignette, may be incorporated. The sneak peek may be identical to the CR\overline{A}V ad vignette 1810. The sneak peek may also contain other information to help the consumers answer the query 1820. The sneak peek is not shown during the actual CR\overline{A}V ad, but is shown prior to the CR\overline{A}V ad. The sneak peek may be featured several minutes, hours, days, weeks, etc. before the CR\overline{A}V ad. The sneak peek vignette may be indicated by a logo, sound, or another method. Alternatively, the consumers may be informed only that the sneak peek will occur at some point during a particular show. The consumers are told one or more ads are CR\overline{A}V ad sneak peek vignettes. The consumers will then pay greater attention to the particular commercial, or all the possible commercials so they may get additional information to help them answer the CR\overline{A}V ad query 1820. For example, a sneak peek could read: “1 of the following 6 ads will be featured in a CR\overline{A}V ad next Sunday. Please pay attention to ALL of them, because we will not tell you at this time which ad is the CR\overline{A}V ad.” This same process could apply to the vignettes, in addition to the Sneak Peaks. Thus, for example, during the communication of numerous ads, an alert in the form of a logo could appear on the corner of the ads, which are in the form of vignettes. After communicating the vignettes, one or more Queries with immersion verification questions for one or more of the vignettes would be shown (i.e., at the bottom of the screen while the entertainment content continues). When the user calls, the user could be required to answer one or more of the shown immersion verification questions.

CR\overline{A}V ad System

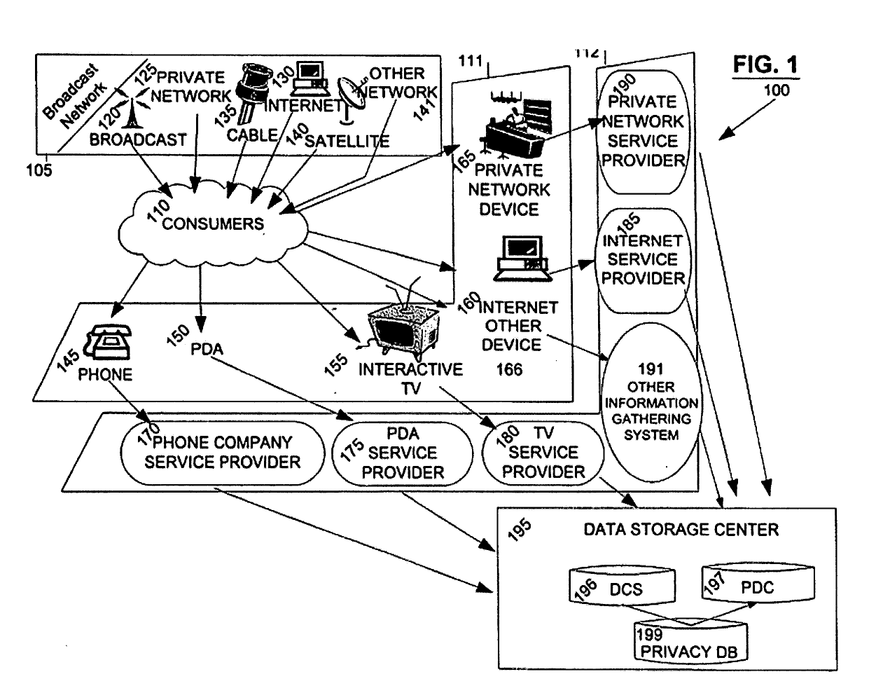

FIG. 1 is a block diagram illustrating the primary components of an exemplary embodiment of the present invention. Turning to FIG. 1, the CR\overline{A}V ad system 100 includes a broadcast network 105, the consumers 110, an answering device (“device”) 111, an information gathering system 112, and a data storage center 195. The consumers 110, the advertisers, the promoters, or other entities, use the present invention. The consumers 110 are the recipients of the ads and are persons who may use the advertiser's commodity or service, who view, hear, read, or otherwise absorb the entertainment content and the ads. The advertisers are entities that distribute the ads to induce the consumers to buy, use, or do something. The promoters initiate, develop, generate, and/or distribute entertainment content attracting many of the consumers, and in turn attracting the advertisers. While the invention is described in the context of the consumers, the advertiser, and the promoters, those experienced in the art will recognize that other entities can be used.

The broadcast network 105 is a means of connecting the consumers 110 with the entertainment content and the ads. The device 111 is a means of communicating the registration and the response information to the information gathering system 112. The device 111 also can be a means of communicating with the consumers 110 by broadcasting an immersion verification question and other questions, and subsequently forwarding related registration and response information to the information gathering system 112. The information gathering system 112 is a means of forwarding the registration and the response information to the data storage center 195. The data storage center 195 is a means for storing the registration and response information.

The broadcast network 105 may include a Broadcast TV Network 120, a Private Network 125, a Cable Network 135, an Internet Network 130, a Satellite Network 140, or any other Network 141 (e.g., newspaper). Those experienced in the art will recognize numerous communications networks and systems (including presently available systems and future systems) may be substituted or interchanged with the broadcast network 105. For example, the broadcast network 105 also can comprise any of radio, outdoor media (billboards, signs, buses), print media (newspapers, magazines), direct mail, or other broadcast network.

The response device 111 can comprise a Phone 145, a Personal Digital Assistant (“PDA”) 150, an Interactive TV 155, an Internet Computer 130, a Hospitality Industry Private Network (i.e., a Sports Bar and Pub device) 165, or any other device 166. In an exemplary embodiment, the other response device 166 can comprise a printed response device, which can be completed by a consumer and delivered subsequently to the data storage center 195. For example, the printed response device can comprise a handwritten or typewritten response.

The devices 111 can include computer-related devices such as cellular phone networks, two-way pagers, and two-way contained network devices such as proprietary NTN systems found in numerous restaurants and pubs throughout the United States. Different instructions and methods may be used to register or answer. Those experienced in the art will recognize numerous devices (including presently available devices and future devices) may be substituted or interchanged as the device 111. In addition, those experienced in the art will recognize that one device 111 can be used to register, and another device 111 used to respond to the CR\overline{A}V ad.

The information gathering system 112 may include numerous service providers (“SPs”), including a Phone Company SP 170, a PDA SP 175, a TV SP 180, an Internet SP 185, a Private Network SP 190, and any other information gathering system 191. For example, the other information gathering system 191 can comprise a private delivery network, such as the U.S. Postal Service, a facsimile machine, or other system. Those experienced in the art will recognize numerous distribution systems (including presently available systems and future systems) may be substituted or interchanged as the information gathering system 112.

The information gathering system 112 connects to a data storage center 195, which stores data gathered by the information gathering system 112. The data storage center 195 may include a Personal Data Center (“PDC”) Database 197 and a Data Compiling and Storage (“DCS”) Center Database 196. The data storage center 195 includes registration information and response information, random winner selection, and long-term storage of data collected for future data mining ventures. The PDC 197 stores the consumers' personal information, which may include the name, address, social security number (which is typically obtained only from prize winners for tax reporting purposes), personal ID number, phone number, etc. The DCS 196 may store demographic data collected during registration, a CR\overline{A}V ID, and CR\overline{A}V ad query 1820 answers.

The data storage center 195 may also include a Privacy Database 199. The Privacy Database 199 is used when the promoters decide to implement privacy protection for the consumers 110 that respond to the CR\overline{A}V ads, who have provided personal and confidential data while registering. The Privacy Database 199 requires records from the PDC 197 and the DCS 196 to match before consumers' identities are matched with demographic and historical records. This matching helps ensure security, data protection, and isolation levels.

CR\overline{A}V ad Process Overview

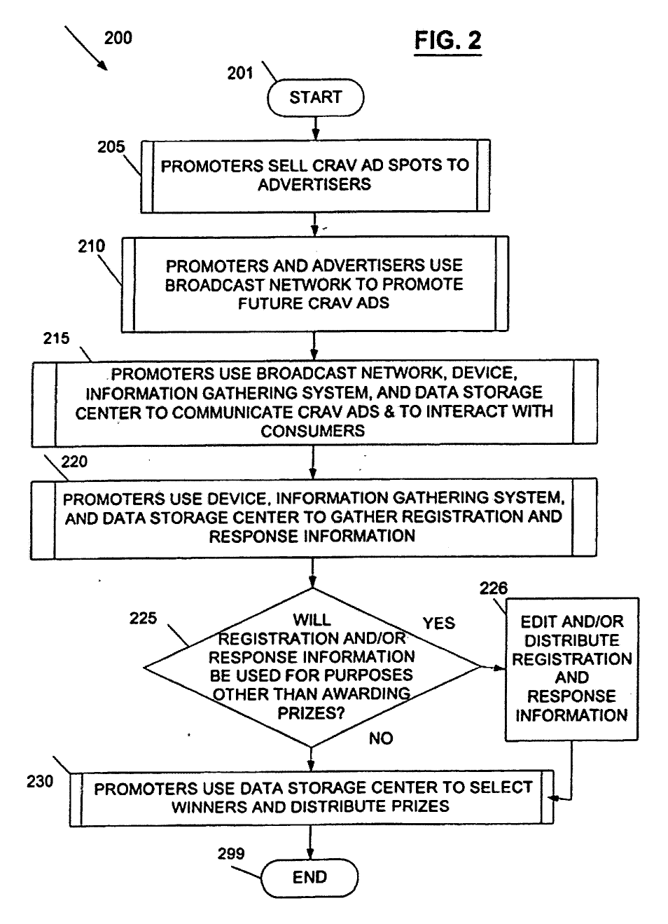

FIG. 2 is a flow diagram illustrating an overview of an exemplary CR\overline{A}V ad process. Turning now to FIG. 2, an exemplary CR\overline{A}V ad process 200 is initiated at the “START” step 201. In step 205, the promoters sell the CR\overline{A}V ads to the advertisers. In step 210, the promoters and the advertisers use the broadcast network 105 to promote future CR\overline{A}V ads. In step 215, the promoters use the broadcast network 105, the device 111, the information gathering system 112, and the data storage center 195 to communicate the CR\overline{A}V ads to the consumers 110 and to interact with the consumers 110. In step 220, the promoters use the device 111, the information gathering system 112, and the data storage center 195 to gather the consumers' registration information and response information. In step 225, it is determined whether or not the registration and/or the response information will be used for purposes other than awarding prizes. If the answer to step 225 is “YES” and the registration and/or the response information will be used, the process moves to step 226, where the promoters edit and/or distribute the registration and the response information to the advertisers and other interested entities. If the answer to step 225 is “NO” and the registration and the response information will not be used, the process moves directly to step 230. In step 230, the promoters use the data storage center to select the winners and distribute the prizes. The process then proceeds to the “END” step 299 and terminates.

CR\overline{A}V ads Are Sold

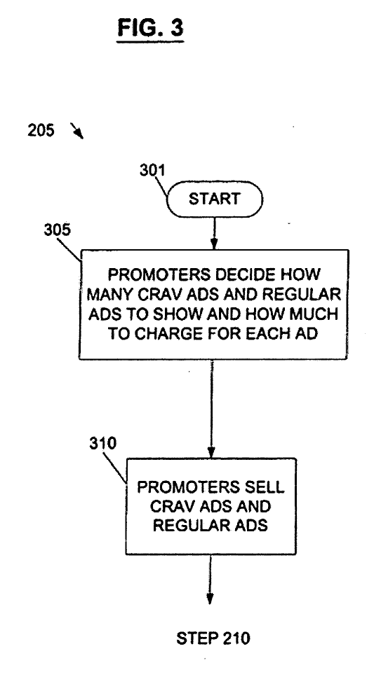

FIG. 3 is a flow diagram illustrating an exemplary process describing how the promoters sell the CR\overline{A}V ads to the advertisers, as set forth in step 205 of FIG. 2. Turning now to FIG. 3, an exemplary CR\overline{A}V ad process 205 is initiated at the “START” step 301. In step 305, the promoters decide how many of the CR\overline{A}V ads and the regular ads to communicate and how much to charge for each ad. In step 310, the promoters sell the CR\overline{A}V ads and the regular ads. The process then moves to step 210 of FIG. 2.

The CR\overline{A}V ads may be priced in numerous ways. For example, the price may be dependent on the program's audience size (i.e., ratings), or may be priced based on an auction or bidding process, where the CR\overline{A}V ads are rewarded to the highest bidder. To establish pricing, the promoters may analyze the existing program profitability based on standard production, promotion, and broadcast costs. This may be offset by standard advertising fees for standard advertising. The promoters CR\overline{A}V ad price may include the value of a larger audience size and a higher quality of immersion among consumers 110. This legitimizes a higher cost-per-minute advertising fee, with the additional fee revenues helping to offset CR\overline{A}V ad reward costs, CR\overline{A}V ad licensing and promotion costs, and query 1820 response management process costs.

When determining CR\overline{A}V ad prices, the following may also be considered: the promotion costs, the simultaneous broadcast venues used, the number and type of immersion rewards, the number of questions in the query 1820 (i.e., immersion verification question, polling question, trivia-based questions of varied difficulties to reduce the number of fully correct responses), on-air versus off-air immersion verification responses, registration requirements, query 1820 response gathering methodology, and winner selection and prize awarding responsibility. The promoters must also determine if the consumers 110 will be required to answer one or more special advertiser-designed questions during the immersion verification process. This market data may be very valuable to the advertisers, and may further substantiate the fee being charged by the promoters. The promoters may also elect to add one or more special public opinion questions to the query 1820. This data may be related to the promoters' other programs, may determine the consumers' 110 interest levels to certain programming types, or may address any other marketing related issues. These public opinion questions may also be conducted as a service to public opinion agencies, which may pay the promoters for providing the public opinion response results.

CR\overline{A}V Ad is Presented to Consumers

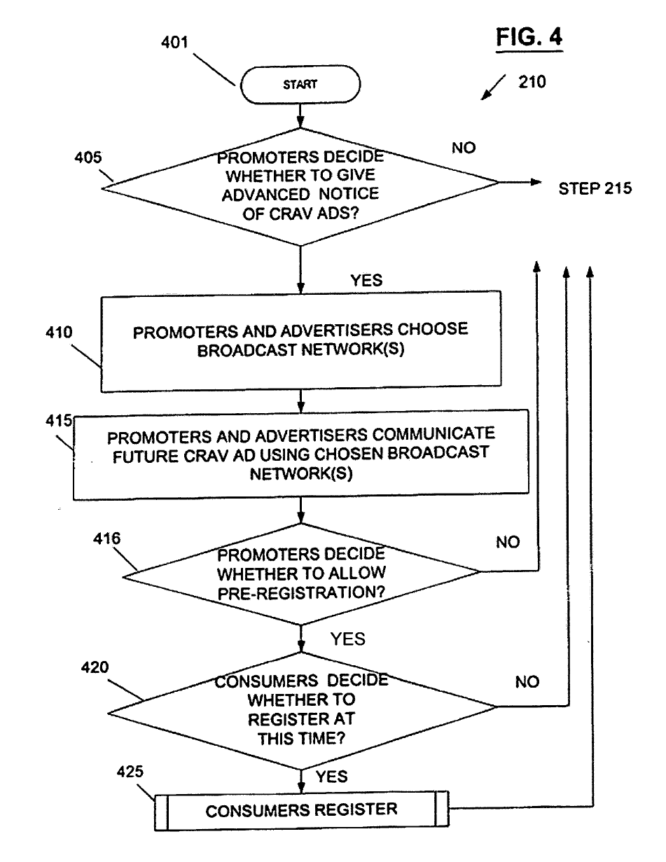

FIG. 4 is a flow diagram illustrating an exemplary process describing how the promoters and the advertisers use the broadcast network 105 to promote future CR\overline{A}V ads, as set forth in step 210 of FIG. 2. The public is preferably notified about the broadcast of the CR\overline{A}V ad to maximize the program's audience size. Prior to the communication including the CR\overline{A}V ad, the promoters provide advance warning to the consumers 110 who may receive programs where the CR\overline{A}V ads will be communicated. This advanced warning may include educational, general public information informing the consumers 110 about the CR\overline{A}V ads, and how successful immersion may result in the consumers 110 receiving substantial rewards. These advance warnings also may include specific prize information, reveal the name and/or logo, and invite registration by the consumers 110 prior to the broadcast. The promoters and the advertisers may provide this advanced notice.

Turning now to FIG. 4, an exemplary CR\overline{A}V ad process 210 is initiated at the “START” step 401. In step 405, the promoters determine whether or not to give advanced notice of the future CR\overline{A}V ad broadcast. If the answer is “NO,” then the process moves to step 215 of FIG. 2. If the answer is “YES,” the process moves to step 410, where the promoters and the advertisers choose the broadcast network 105 for the advanced notice. The broadcast network 105 that can be used for the advanced notice includes the Broadcast TV Network 120, the Private Network 125, the Cable Network 135, the Internet 130, the Satellite Network 140, or any other System 141. In step 415, the promoters and the advertisers communicate the availability of future CR\overline{A}V ads to the consumers 110 using the chosen broadcast network(s) 105. In step 416, the promoter decides whether to allow the consumers 110 to pre-register. If the answer is “NO,” then the process moves to step 215 of FIG. 2. If the answer is “YES,” the process moves to step 420.

In step 420, the consumers 110 decide whether or not to register to respond to the CR\overline{A}V ads using the device 111. If the answer to step 420 is “NO,” the process moves to step 215 of FIG. 2. In one alternative exemplary embodiment, the CR\overline{A}V ad system is simple, and registration is not required. However, in alternative exemplary embodiments, registration is required during the process. Registration allows the promoters and the advertisers to collect detailed information about the consumers 110. If the answer to step 420 is “YES,” the consumers 110 register, as set forth in step 425. The process then moves to step 215 of FIG. 2.

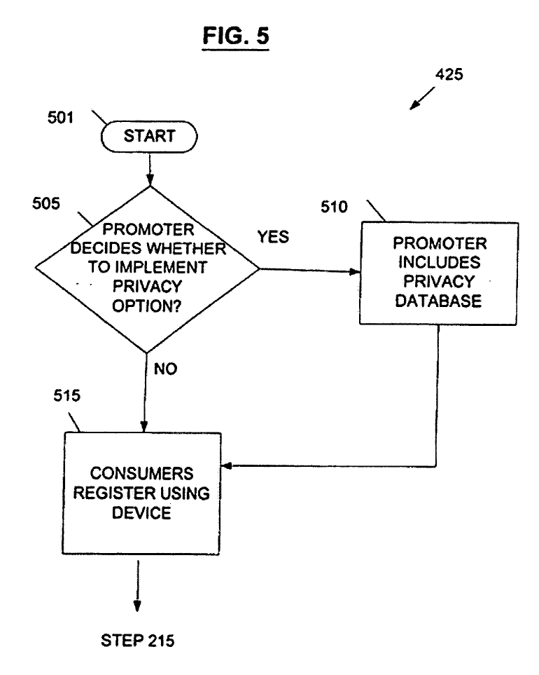

FIG. 5 is a flow diagram illustrating an exemplary process describing how the privacy option applies to the registration process, as set forth in step 425 of FIG. 4. Turning now to FIG. 5, an exemplary CR\overline{A}V ad process 425 is initiated at the “START” step 501. In step 505, the promoters decide whether to implement the privacy option. The privacy option segregates confidential personal data from demographic data. If the privacy option is used, the data storage center 195 includes the Privacy Database 199, as set forth in step 510. The process then moves to step 515. If the privacy option is not implemented, the process moves directly from step 505 to step 515. In step 515, the consumers 110 register using the device 111, and the process moves to step 215 of FIG. 2.

The privacy option is important because it allows the consumers 110 to be less concerned that their personal registration information will be matched with their demographic and response information by outside parties.

Registration

Because the query 1820 may be short in duration, the consumers 110 may not be able to fully register and respond to the CR\overline{A}V ad within the allocated CR\overline{A}V ad time. Therefore, the consumers 110 will usually want to register before the CR\overline{A}V ad is broadcast. Several registration options are available.

Registration information may include a variety of data. In one exemplary embodiment, the promoters do not want to use demographic information and simply seek to identify the consumers 110 for tracking and prize awarding purposes. The consumers 110 are thus asked to provide simple information where they may be reached and identified if selected as a winner. This information may include a phone number, a social security number (or portion thereof), a birthday, a name, and an address. After providing the registration information, the consumers 110 are provided with a unique “CR\overline{A}V ID”. This number may be a randomly generated unique number, or an easily remembered number or a series of numbers (such as a birthday and phone number combination), which may also provide ID information within the number.

In another exemplary embodiment for registration, the promoters may wish to obtain ID information, product-related information, or public opinion-related information. The demographic profile of each consumer 110 may include age, sex, race, weight, height, zip code, physical home or e-mail address, occupation, individual annual earning, educational background, political affiliation, religious affiliation, family size, number of TVs and computers, advertiser-related or public opinion survey questions, and prior CR\overline{A}V ad answers (historical response information). A detailed registration may be required for each CR\overline{A}V ad. However, gathering this information for each CR\overline{A}V ad makes the registration process time-consuming, costly, and redundant, and may deter the consumers 110 from submitting a response. Thus, a one-time registration process is also available. In this mode, only changed/updated demographic or ID information (such as a change in marital status, phone number, etc.) is added for each CR\overline{A}V ad response after the original registration. Under this scenario, the original registration information is stored in the PDC 197. As new responses or update information are transmitted to the data storage center 195, the data storage center 195 is updated.

In another alternative embodiment for registration, when only one registration is used (as described above), the advertisers may have the consumers 10 with existing CR\overline{A}V IDs enter additional demographic information to be qualified for the rewards. In this case, new “response” information is added for each additional CR\overline{A}V ad response after the original registration. Under this scenario, the original registration information would be stored in the DCS 196, and as new responses are transmitted to the data storage center 195, the registration information can be added to the data storage center 195. The CR\overline{A}V ID would be required before allowing additions to CR\overline{A}V ad records.

Broadcast CR\overline{A}V ad and Interaction with Consumers

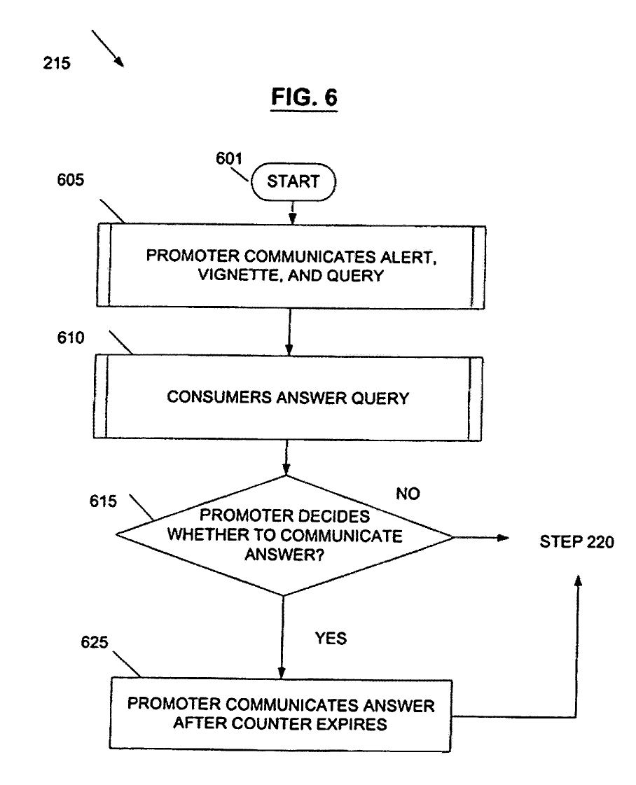

FIG. 6 is a flow diagram illustrating an exemplary process describing how the promoters use the broadcast network 105, the device 111, the information gathering system 112, and the data storage center 195 to communicate the CR\overline{A}V ads to the consumers 110 and to interact with the consumers 110, as set forth in step 215 of FIG. 2. Turning now to FIG. 6, an exemplary CR\overline{A}V ad process 215 is initiated at the “START” step 601. In step 605, the promoter communicates the alert 1805, the vignette 1810, and the query 1820 using the broadcast network 105. The alert 1805 is a warning to the consumers that the upcoming vignette 1810 should be memorized so the consumers may become eligible to win a reward. The vignette 1810 may be a conventional commercial for a product or service or any other information designed for presentation to a consuming audience. The query 1820 includes one or more questions. In step 610, the consumers 110 answer the query 1820. In step 615, the option to communicate the answer 1830 is provided, based on whether or not the promoters wish to use this option. The answer 1830 includes the answer to at least one of the query's 1820 question or questions. If the answer to step 615 is “NO”, and the answer 1830 is not communicated, the process moves to step 220 of FIG. 2. If the answer to step 615 is “YES”, the promoter communicates the answer 1830 after the counter time has expired using the broadcast network 105, as set forth in step 620. The process then moves to step 220 of FIG. 2.

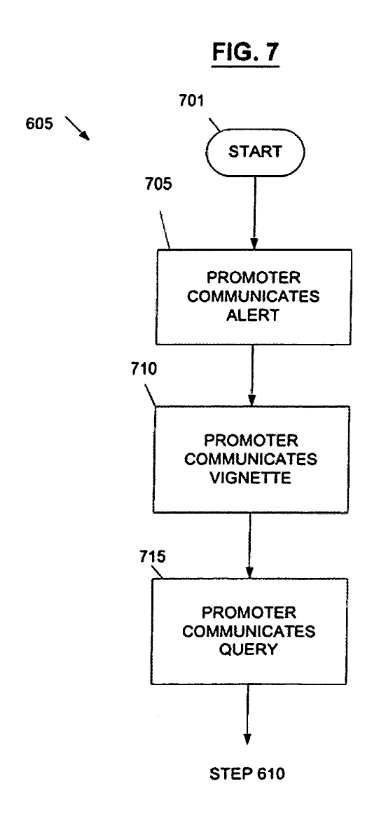

FIG. 7 is a flow diagram illustrating an exemplary process describing how the promoter communicates the alert 1805, the vignette 1810, and the query 1820 using the broadcast network 105, as set forth in step 605 of FIG. 6. Turning now to FIG. 7, an exemplary CR\overline{A}V ad process 605 is initiated at the “START” step 701. In step 705, the promoter communicates the alert 1805 using the broadcast network 105. The alert 1805 may include a prize description and an advertiser and/or promoter logo. The alert 1805 may also include any other information the promoters, or some other entity, wishes to display. In step 710, the promoter communicates the vignette 1810 using the broadcast network 105. The vignette 1810 may include an Ad and the advertiser and/or promoter logo. The vignette 1810 may also include any other information the promoters, or some other entity, wishes to display. In step 715, the promoter communicates the query 1820 using the broadcast network 105. Alternatively, the promoter can communicate the query 1820 using one or more of the response devices 111. The query 1820 may include questions, possible answers, login response information, a time remaining counter, and the advertiser and/or promoter logo. The CR\overline{A}V ad query 1820 may also include any other information the promoter wishes to include. The process then moves to step 610 of FIG. 6.

CR\overline{A}V ad is Answered

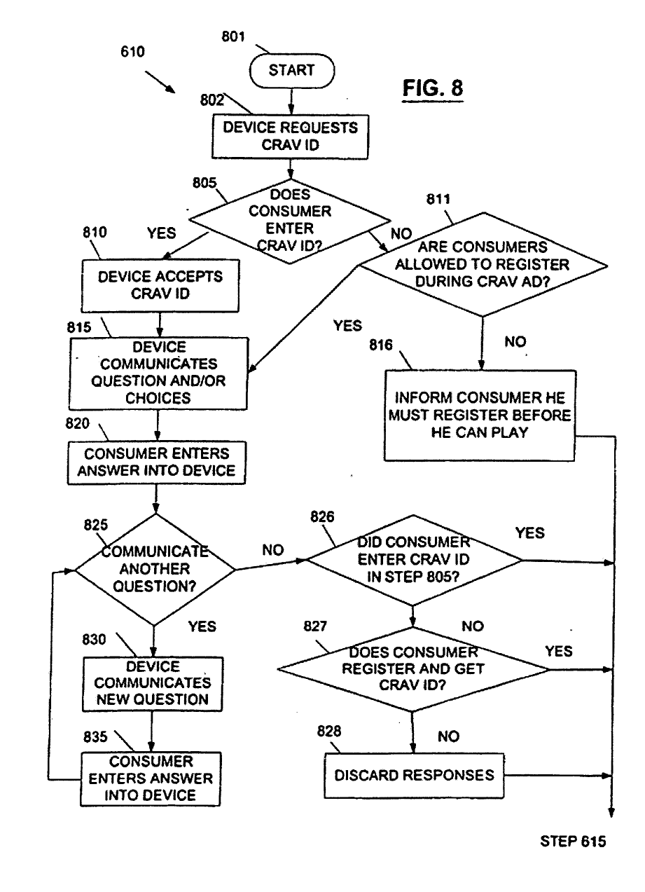

FIG. 8 is a flow diagram illustrating an exemplary process describing how the consumers 110 answer the CR\overline{A}V ads, as set forth in step 610 of FIG. 6. Turning now to FIG. 8, an exemplary CR\overline{A}V ad process 610 is initiated at the “START” step 801. In step 802, the device 111 prompts the consumers 110 to enter their CR\overline{A}V ID. In step 805, it is determined whether or not consumers 110 have entered a CR\overline{A}V ID. If the answer to step 805 is “NO” and the consumers 110 do not enter a CR\overline{A}V ID, registration may be allowed, as set forth in step 811. If registration is allowed, the process moves to step 815. If registration is not allowed, the consumers 110 are informed that they must register before they can submit a response to the CR\overline{A}V ad, as set forth in step 816. The process then moves to step 615 of FIG. 6.

If the answer to step 805 is “YES”, and the consumers 110 have entered a CR\overline{A}V ID using the device 111, the device 111 accepts the CR\overline{A}V ID as set forth in step 810. The CR\overline{A}V ID may be a number assigned by the promoter or the advertiser. It may be stored in memory to eliminate the need for manual entry. Examples of how to store the CR\overline{A}V ID into memory include using a cookie over the Internet, or entering a stored number into a phone (speed dial memory function). In step 815, the broadcast network 105 or device 111 communicates the first question of the CR\overline{A}V ad query 1820 and the answer choices. The question can be an immersion verification question, a polling question, a trivia question, or any other type of question. The answer choices may be a set of predetermined response options a, b, c, d, etc., or the consumers 110 may be required to enter the answer itself. The options for answering may include the broadcast of unique numbers or letters that may differ between broadcasters, which allow subsequent decoding by the data storage center 195 to determine the broadcast medium or location used by the consumers 110 to view the CR\overline{A}V ad. In step 820, the consumers 110 enter their answer into the device 111. In step 825, the promoters may communicate another question as part of the same query 1820 using the broadcast network 105 or device 111. This question may be another immersion verification question, or a question used to get information about the consumers 110. This information may include demographic information or other information. If the promoter chooses “YES” to decision step 825, the process moves to step 830, and the device 111 communicates the new question. In step 835, the consumer enters the answer into the device 111. The process then moves back to step 825 and is repeated. If the answer to step 825 is “NO”, and no other questions will be asked, the process moves to step 826. In step 826, it is determined whether or not the consumer 110 entered a CR\overline{A}V ID in step 805. If the answer to step 826 is “YES”, the process moves to step 615 of FIG. 6. If the answer to step 826 is “NO”, the process moves to step 827, where consumers 110 have the option to register. If the answer to step 827 is “YES”, and the consumers 110 register, the process moves to step 615 of FIG. 6. If the answer is “NO”, and the consumers 110 don't register, or don't completely register, the process moves to step 828 and the responses are discarded. The process then moves to step 615 of FIG. 6.

CR\overline{A}V ad Answers are Gathered

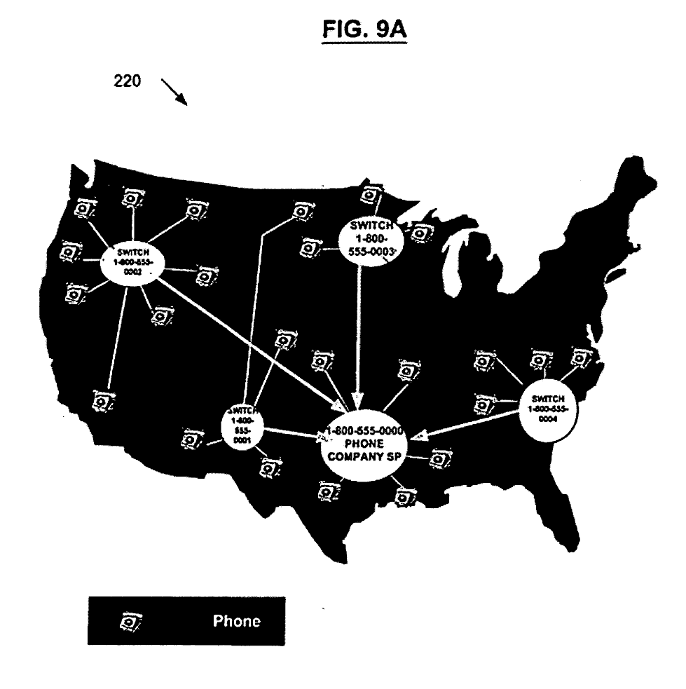

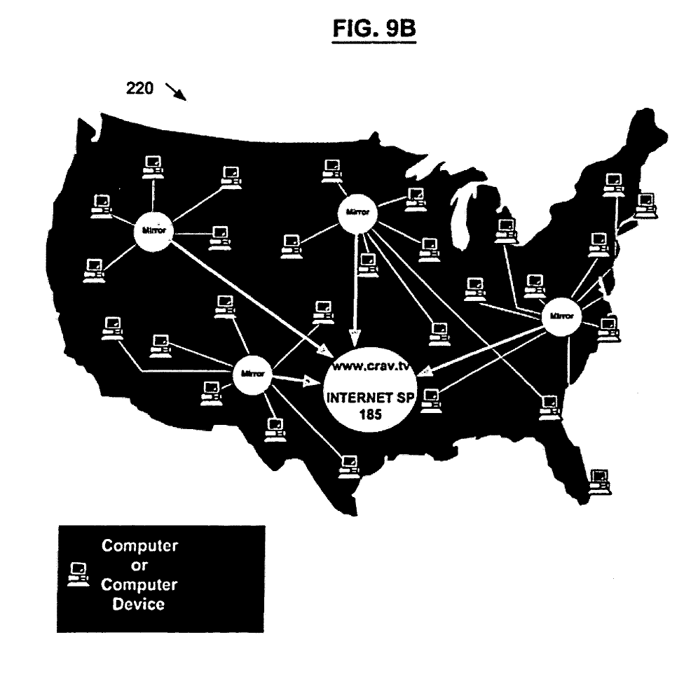

FIGS. 9A and 9B, together comprising FIG. 9, are picture diagrams illustrating an exemplary nationwide network for gathering the registration and response information, as set forth in step 220 of FIG. 2. The query 1820 gathering network is designed to accommodate two variables in any data collection activity. First, expected traffic and geographic/time zone requirements must be met. Second, the registration and the response information must be sent to the data storage center 195. FIG. 9A illustrates the United States map, and shows how conventional Phones 145 forward the registration and the response information to the Phone Company SP 170. FIG. 9B illustrates the United States map, and shows how the Internet computer 130 forwards the registration and the response information to the Internet SP 185. Although the Figures illustrate the United States, one experienced in the art will recognize that the collection system may be implemented in any country, or in multiple countries.

Turning now to FIG. 9A, a network is illustrated showing how consumer responses are forwarded by the Phone 145 to the Phone Company SP 170. Those experienced in the art will recognize the multiple ways to meet expected traffic and geographic/time zone requirements. Similar to traffic terminology, the traveling information is called “traffic”, the length between two points is “distance”, and impeded traffic is “congestion.” In an exemplary embodiment, a single Web site and a single phone number would be sufficient to handle query 1820 responses. However, in most cases, multiple lines are necessary to handle the numerous response traffic.

For telecommunication lines, design elements may assist in reducing distance and avoiding congestion. For example, multiple phone numbers (connected to one or multiple information gathering systems 112) may be located in geographically centered locations. In addition, one published phone number, which incorporates a switch directing incoming calls to one or multiple information gathering systems 112, may be located in geographically centered locations, directed based on the incoming call's origin point. FIG. 9A illustrates the option of the Phones 145 forwarding the registration and the response information to the Phone Company SP 170.

For responses provided over a network such as the Internet Network 130, the following design elements may assist to reduce distance and avoid congestion: mirrored Web sites with unique Web site addresses (each serving as a information gathering system 112) located in geographically centered locations; one published Web site address, which is redirected to one or more mirrored Web sites ideally located in geographically centered locations near the user's SP 112; and unique Web sites hosted by individual Internet SPs 185 or approved information gathering systems 112. FIG. 9B illustrates the option of the Internet computer 160 forwarding the registration and the response information to the Internet SP 185.

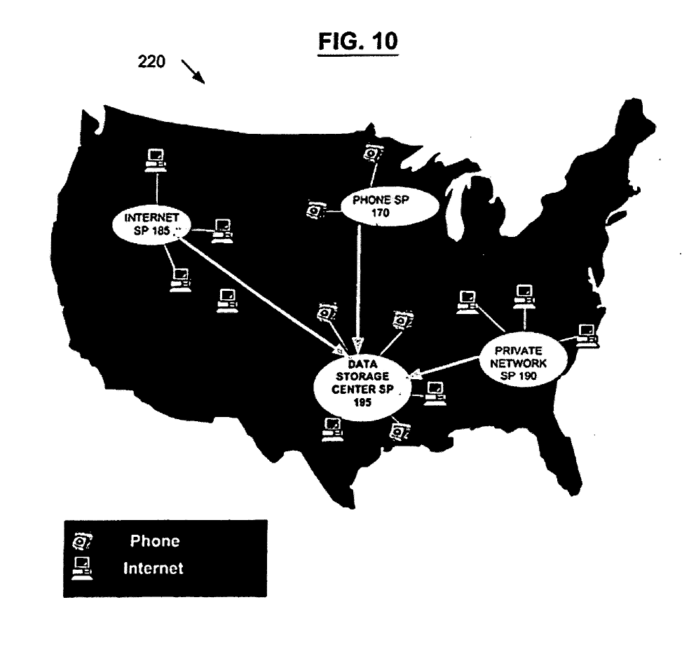

FIG. 10 shows how the information gathering system 112 sends the registration and the response information to the data storage center 195. The registration and the response information is sent to the information gathering systems 112 that may be hosted by a SP network. A CR\overline{A}V Web site may also be set up to be the information gathering system 112. This CR\overline{A}V Web site may be housed at the same location as the data storage center 195. Once the CR\overline{A}V ad has concluded, the information gathering system 112 forwards the registration and the response information to the data storage center 195 on a time-scheduled, synchronized basis. Once the consumers' 110 data is received and verified by the data storage center 195, the response information may be programmed for automatic erasure by the information gathering system 112. FIG. 10 illustrates three information gathering systems 112 for forwarding registration and response information: an Internet SP 185, a Phone Company SP 170, and a private network SP 190.

CR\overline{A}V ad Winners Selected and Prizes Distributed

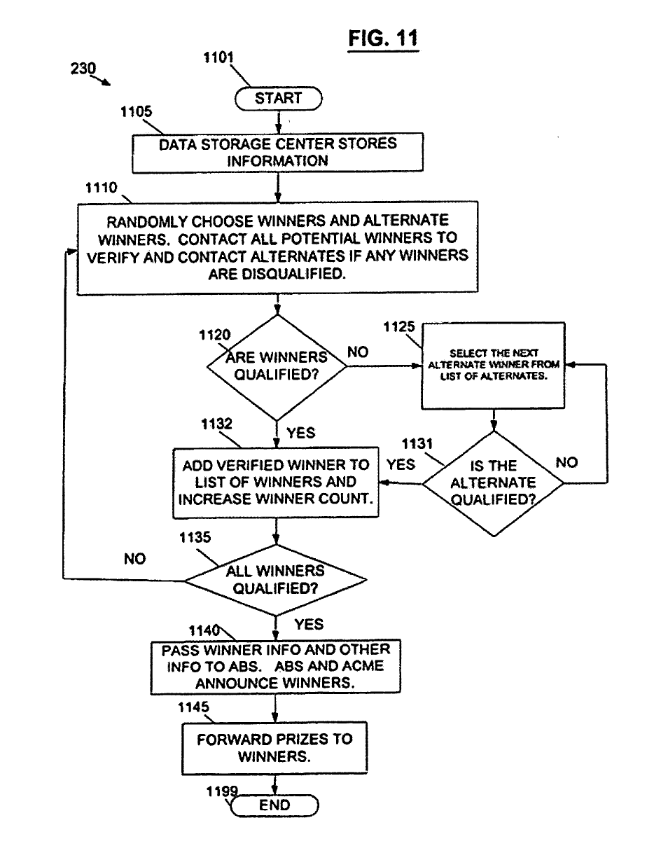

FIG. 11 is a flow diagram illustrating an exemplary process describing how the promoters select winners and distribute prizes, as set forth in step 230 of FIG. 2. Turning now to FIG. 11, an exemplary CR\overline{A}V ad process 230 is initiated at the “START” step 1101. In step 1105, the data storage center 195 stores the registration information in the PDC 197 and the response information in the DCS 196. In step 1110, the promoters or a third party service provider randomly choose winners and alternate winners from the DCS 196 database. The DCS 196 database includes a list of the consumers 110 who have correctly answered all required questions. The promoters, the advertisers, or a third party service provider, also contact the potential winners. (This third party service provider may also offer fulfillment services including information on consumer answers and coupons.) Based upon the process selected by the promoters or the advertisers, the potential winner identities and the truthfulness of the potential winners' registration and response information may be verified. If this option is used, the promoters verify the identity by authenticating the consumers' registration and response information. The promoters may require potential winners to verify demographic or confidential data prior to awarding the prize. The promoters may repeat the one or more questions in the query 1820. The promoters may elect to disqualify potential winners who fail to provide responses that match their query 1820 responses.

In step 1120, it is determined if the winners are qualified for the prizes. If the answer to step 1120 is “NO”, the process moves to step 1125, and the next alternate winner is selected from the list of alternate winners. In step 1131, it is determined if the alternate winner is qualified. If the answer to step 1131 is “NO”, the process moves back to step 1125 and is repeated. If the answer to step 1131 is “YES”, the process then moves to step 1132.

If the answer to step 1120 is “YES”, the process moves to step 1132, and the verified winner is added to the list of winners and the winner count is increased. In step 1135, it is determined if all winners are qualified. If the answer to step 1135 is “NO”, the process moves to step 1110 and is repeated. If the answer to step 1135 is “YES”, the process moves to step 1140. In step 1140, the winner information and other opted information (i.e., demographically pertinent data and query 1820 response results) may be forwarded to advertisers and/or other interested entities, particularly if consumers 110 have approved the forwarding of the information. The promoters, the advertisers, or a third party service provider also announce the winners. In step 1145, the promoters, the advertisers, or third party service provider forwards the prizes to the winners. The process then ends at step 1199.

Other Applications for CR\overline{A}V Ads

While the above description is ideally suited for visual mass-media technology such as the TV and the Internet 130, it may also be utilized in alternate mass-media channels, using audio-only technology like radio, or visual-only broadcast mediums, such as a magazine or newspaper ad. The CR\overline{A}V ads may be answered with complicated, highly-developed computer devices 111, or simply by using the Phone 145. Those practiced in the art will recognize the above invention may be implemented with any broadcast medium and response medium. In addition, the invention is not limited to providing ads within entertainment content, but can be extended to providing other types of information. Finally, while the invention has been discussed in the context of the consumers 110, the promoters, and the advertisers, those experienced in the art will recognize that other entities can be used. For example, a third party service provider can be responsible for: gathering the registration and response information, screening the registration and response information to validate it, mining the registration and response information to extract pertinent data, randomly selecting the winners and alternate winners, and providing prize fulfillment and delivery verification services.

### EXAMPLE

To better illustrate the CR\overline{A}V ad process, a representative example is provided. The promoter is ABS Broadcasting Company (“ABS”) and the advertiser is ACME Motors (“ACME”). The consumers 110 are a four person family in Largo, Fla. Mr. Daly is 60 years old and Mrs. Daly is 58. Two sons live at home. Mike is 25, Mark is 23.

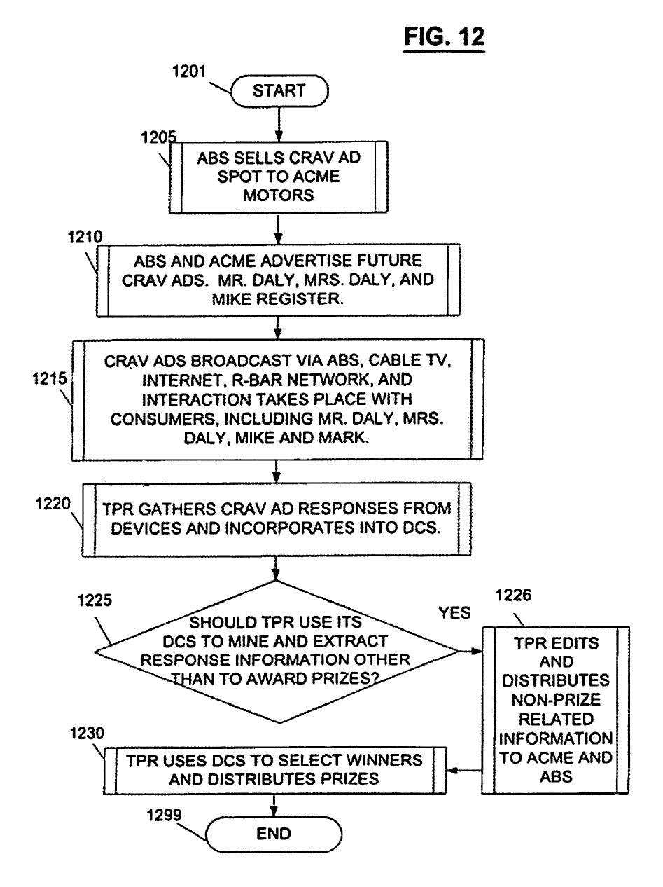

FIG. 12 is a flow diagram illustrating a CR\overline{A}V ad example. An exemplary process is initiated in step 1201. In step 1205, ABS sells two two-minute CR\overline{A}V ad slots to ACME Motors (“ACME”). In step 1210, ABS and ACME advertise the future broadcast of CR\overline{A}V ads, and as a result, the Dalys register. In step 1215, the CR\overline{A}V ads are broadcast. In step 1220, the CR\overline{A}V AD responses are gathered. In step 1225, the DCS is utilized to use the gathered information for purposes other than awarding prizes. In step 1226, the DCS mines, extracts, edits, and forwards the non-prize winner related information. In step 1230, the DCS is utilized to select the winners and distributes the prizes.

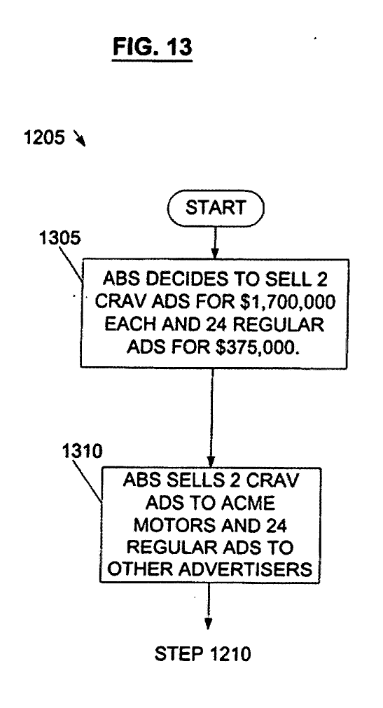

FIG. 13 is a flow diagram illustrating how the Ad slots are sold, as set forth in step 1205 of FIG. 12. Turning now to FIG. 13, ABS decides to sell the two CR\overline{A}V ads for $1,700,000 each and the twenty-four regular ads for $375,000 each, as set forth in step 1305. ABS sells the two CR\overline{A}V ads to ACME and the twenty-four regular ads to other advertisers, as set forth in step 1310. The process then moves to step 1210 of FIG. 12.

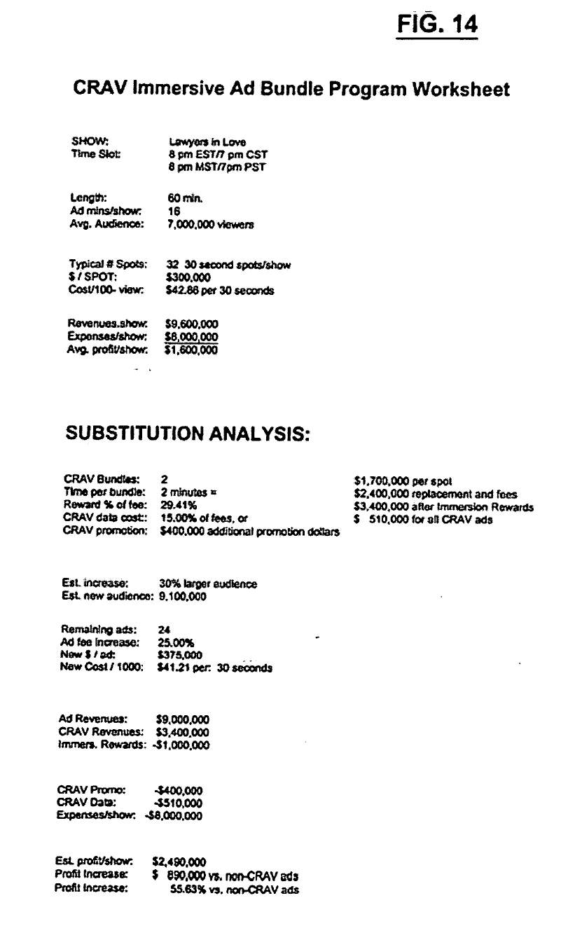

To determine the ad price, ABS follows the chart set forth in FIG. 14. ABS determines the average profit for a show “Lawyers in Love”. “Lawyers in Love” is shown at 8 PM EST/8 PM MST (broadcast over delayed time slots) and has a length of 60 minutes. The show's average viewing audience is 7 million consumers 110. ABS has allocated 16 advertising minutes (32 30-second spots) for the show. ABS charges $300,000 per 30-second spot to advertisers, earning $9.6 million revenue per show. The show expenses are $8,000,000. Thus, the average profit is show revenue ($9.6 million)−show expenses ($8 million)=net profit ($1.6 million). The average cost to the advertiser per 1000 consumers 110 is $42.86, without taking the CR\overline{A}V ads into account.

ABS then determines the substitution analysis. The two CR\overline{A}V ads priced at $1,700,000 replace (8) 30-second ad slots, for which ABS had formerly garnered $2.4 million in revenue. ABS also wishes to allocate $1 million for prizes, bringing the CR\overline{A}V ad price to $3.4 million. The CR\overline{A}V data gathering cost is $510,000. ABS pays this fee to TPR, a third party information warehousing and collection organization equipped with CR\overline{A}V related registration and information gathering system 112. TPR will also select winners and alternates, authenticate winner responses, provide a list to ABS and ACME, and will handle the prize distribution process. ABS spends $400,000 promoting the future CR\overline{A}V ads.

ABS estimates the CR\overline{A}V ad contest will increase the audience by 30%. ABS therefore increases the traditional ad price by 25%. The new ad price is $375,000 for each 30-second slot. The advertisers are therefore paying $375,000 per 30-second regular ad (as opposed to $300,000), but are in exchange potentially achieving higher immersion levels, and their regular ads are being broadcast to a larger audience at a lower cost per impression. The new cost per 1000 consumers 110 is lower: $42.21.

This $75,000 increase per slot, over 24 slots, adds $1.8 million in additional revenues to ABS. This is offset by the $400,000 additional cost to promote the upcoming CR\overline{A}V ads, plus $510,000 for CR\overline{A}V information collection, compilation and winner selection/verification. Thus, ABS realizes $890,000 in additional net profit. This increases the show's profitability by over 55%.

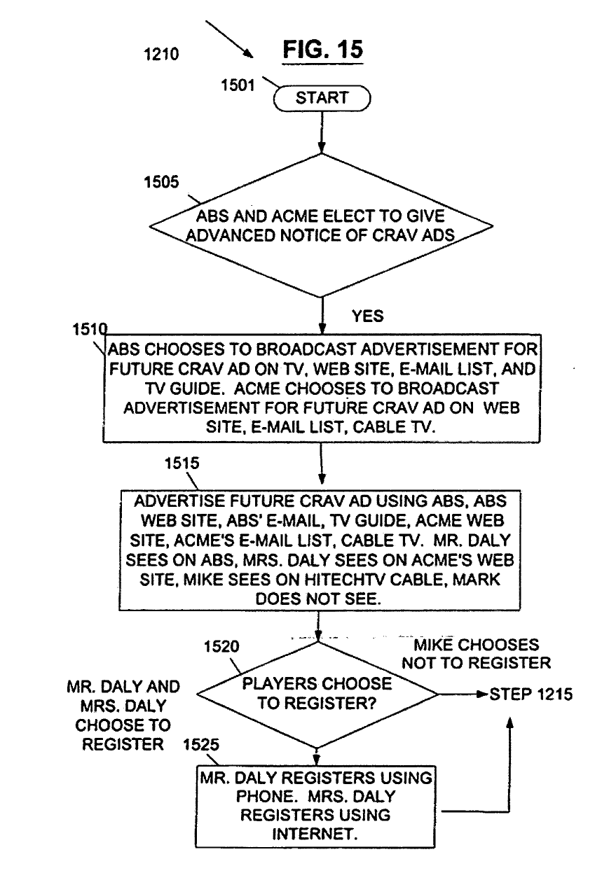

FIG. 15 is a picture flow diagram illustrating an exemplary CR\overline{A}V ad process for ABS and ACME to promote future CR\overline{A}V ads, as set forth in step 1210 of FIG. 12. In step 1501, the process 1210 is initiated at the “START” button 1501. In step 1505, ABS and ACME elect to promote and give advanced notice of the CR\overline{A}V ads. In step 1510, ABS chooses to promote the CR\overline{A}V ads on TV, the Internet 130, e-mail, and TV guide, and ACME chooses to promote the CR\overline{A}V ads on the Internet 130, e-mail, and cable TV. As set forth in step 1515, during the weeks before the broadcast, ABS promotes the upcoming “CR\overline{A}V/ACME New Car Giveaway” promotion on its own ABS network. ABS also purchases TV guide magazine ads, posts information on the ABS Web site, and sends out information to its e-mail lists. Also promoting the CR\overline{A}V ads are ACME's own banners on its Web site and e-mail notification to its 3.5 million subscribers. ACME also advertises on the HiTechTV cable channel network. Mr. Daly sees the CR\overline{A}V ads promoted on ABS. Mrs. Daly sees the CR\overline{A}V ads promoted on ACME's Web site while surfing the Internet 130. Mike sees the CR\overline{A}V ads promoted on HiTechTV cable. Mark does not see the CR\overline{A}V ads promoted. The CR\overline{A}V ad promotion states: “Watch ‘Lawyers in Love’ on Sunday at 8:00 EST and you may win 1 of 50 new ACME convertibles. Register at www.CR\overline{A}V.tv or by calling 1-800-CR\overline{A}VNOW.” All broadcast promotions for the future ACME CR\overline{A}V ads include this registration information. Registration is conducted by TPR.

Following step 1520, Mr. Daly and Mrs. Daly choose to register. Mike chooses not to register at this time. Mark does not know he may register, and therefore does not register. As set forth in step 1525, Mr. Daly registers using the Phone 145, and Mrs. Daly registers using the Internet computer 160. The process then moves forward to step 1215.

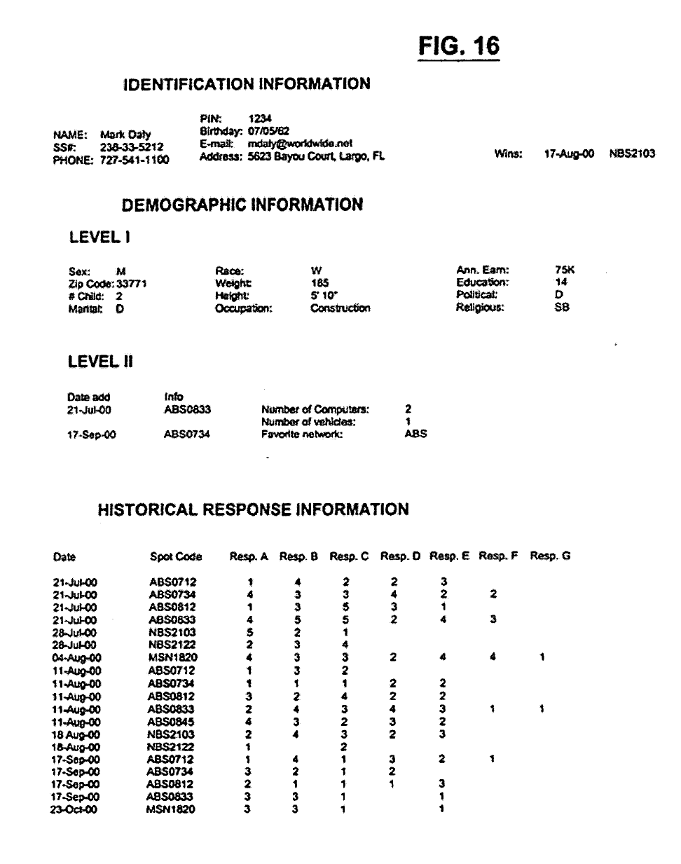

The registration process involves having Mr. Daly and Mrs. Daly enter registration information. FIG. 16 shows a sample CR\overline{A}V record, which may include a name, Social Security number, phone number, PIN, birthday, e-mail, address, and any wins. The promoters may also ask the consumers 110 to enter demographic information, which may include sex, zip code, number of children, marital status, race, weight, height, occupation, annual earnings, education, political affiliation, and religious affiliation. This information may be supplemented and updated with information including: the number of TVs and computers owned, the number of vehicles owned, and the favorite TV network. The historical response information provides information on the responses the consumers 110 have given to prior CR\overline{A}V ads.

While the consumers 110 may enter demographic information during the registration process, the query 1820 also provides an opportunity to gather demographic information. This information may be added to the CR\overline{A}V demographic information, or may be added to the historical response data. In this case, a Level II demographic record may be incorporated into the record, for easier search and compilation in the future. Level II demographic information is collected after the initial registration point and thus may contain information for some, but not all, consumers 110. As a result, Level II demographic information may limit the total survey population, as opposed to the primary Level I demographic information, which is provided by all registrants at initial registration.

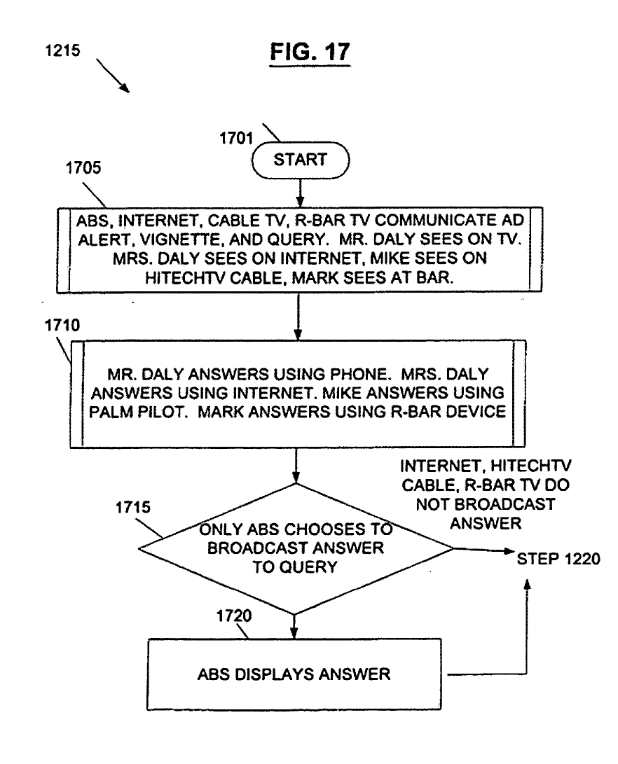

FIG. 17 is a flow chart illustrating an exemplary embodiment of step 1215, where ABS broadcasts the alert 1805, the vignette 1810, and the query 1820. Turning now to FIG. 17, the process 1215 is initiated at the “START” step 1701. In step 1705, ACME elects to utilize the MultiSimulcast concept, by offering simultaneous ACME CR\overline{A}V ad broadcasts over multiple devices. ACME chooses to show the ACME CR\overline{A}V ad on ABS, ACME's Web site, HiTechTV Cable, and the R-BAR Network simultaneously at 8:33 PM EST on Sunday. Therefore, identical ACME CR\overline{A}V ads are MultiSimulcast on these mediums at 8:33 PM EST. Mr. Daly sees the ACME CR\overline{A}V ad while watching “Lawyers in Love” on ABS 120. Mrs. Daly sees the ACME CR\overline{A}V ad while logged on to the Internet 130. (Mrs. Daly already provided her CR\overline{A}V ID when she logged on.) Mike is watching HiTechTV Cable 135 in his room, and sees the ACME CR\overline{A}V ad. Mark sees the ACME CR\overline{A}V ad at a local bar, using the R-Bar Network 125. In step 1710, the consumers 110 answer. Mr. Daly answers using the Phone 145. Mrs. Daly answers using the Internet computer 160. Mike answers using his Palm Pilot PDA 150, although Mike has not yet registered. Mark answers using the R-Bar device 165. The answer 1830 to the query 1820 is shown only on ABS, as set forth in step 1715-1720. The answer 1830 is not shown on the Internet 130, the HiTechTV Cable 135, and the R-Bar Network 125.

FIG. 18 illustrates the CR\overline{A}V ad the consumers 110 see, as set forth in FIG. 17. In step 1805, the alert 1805 is pictured. The alert 1805 states: “Memorizing the following ACME CAR COMPANY CR\overline{A}V ad may make you a winner of 1 of 50 new ACME convertibles.” This alert 1805 is shown for 10 seconds. In step 1810, the vignette 1810 is broadcast. The vignette 1810 is a 60-second entertaining and informative ad suitable for broadcast in non-CR\overline{A}V ads as well. In step 1820, the query 1820 is broadcast. The query 1820 includes three questions: an immersion verification question 1820a broadcast over broadcast network 105, including ABS, ACME's web site, HiTechTV, and R-BAR private broadcast network; and an advertiser question 1820b, and polling question 1820c, both of which are distributed via devices 111, including a telephone network, ACME's Web Site, R-Bar private Network, and Palm Pilot PDA Network. The immersion verification question 1820a asks “What new ACME model features side impact air bags?” The multiple choice responses are displayed or vocalized: 1) SD2020, 2) XP2030, 3) XX2040, 4) XYZ123. The second question, the advertiser question 1820b, is communicated. This is a question designed by the advertiser, posed to the consumers 110 while responding through the various devices 111. This question asks “When do you plan on buying a new car?” The multiple choice responses are displayed or vocalized: 1) 2 years or over, 2) within 2 years, 3) within 1 year, 4) within 6 months. In step 1820c, the third question, the polling question 1820c, is displayed or vocalized. This question is designed for a contracted pollster, posed to the consumers 110 while responding through the various devices 111. This question asks “Assuming the following choices, for whom do you plan to vote for U.S. President in 2008?” The multiple choice responses are displayed or vocalized: 1) Hillary Clinton, 2) Colin Powell 3) Jeb Bush 4) Frank Maggio. In step 1830, the correct answer to question 1 is displayed or vocalized: XP2030.

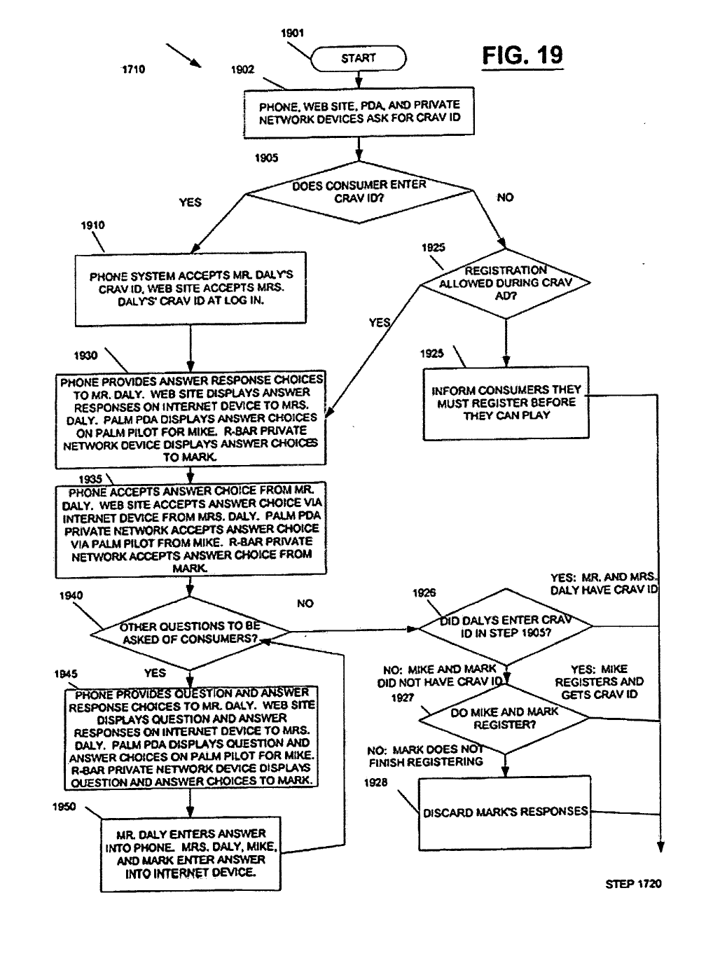

FIG. 19 is a flow diagram illustrating how the CR\overline{A}V ads are answered by the Dalys, as set forth in step 1710 of FIG. 17. For Mr. Daly, the process is as follows. Mr. Daly answers using the Phone 145, by dialing a phone number he was given when he registered. The phone number connects to an answering service, which asks Mr. Daly for his CR\overline{A}V ID, as set forth in step 1902. Mr. Daly has already registered, so he enters his CR\overline{A}V ID and it is accepted in step 1910. In step 1930, the Phone 145 plays Mr. Daly the first question 1820a with answer choices. In step 1935, he answers “SD2020” by pressing 1 on his touch-tone Phone 145, as prompted. (This is not the correct response.) Another question is asked, so the process moves from step 1940 to step 1945. In step 1945, Mr. Daly is asked the second question 1820b with answer choices. In step 1950, Mr. Daly answers “2 years and over” by pressing 1 on his Phone 145. A third question 1820c is asked, so the process moves from step 1940 to step 1945. In step 1945, Mr. Daly is asked the third question. In step 1950, Mr. Daly answers he will vote for “Frank Maggio” for President by pressing 4 on his Phone 145. (This is evidence of his political acumen.)

For Mrs. Daly, the process is as follows: Mrs. Daly answers using the Internet Computer 160. As Mrs. Daly already provided her CR\overline{A}V ID automatically when she logged on (steps 1902-1910), she only needs to answer the questions. In step 1930, the Internet 130 shows the immersion verification question 1820a. In step 1935, Mrs. Daly selects “XP2030”. In step 1945, the Internet Network 130 shows the advertiser question 1820b with answer choices. In step 1950, Mrs. Daly selects “within 2 years”. Because there is another question, the process moves from step 1940 to step 1945 again. In step 1945 the polling question 1820c with answer choices is shown. In step 1950, Mrs. Daly selects “Frank Maggio” representing her choice for President. (Intelligence runs in the Daly household.)

For Mike, the process is as follows: Mike uses his Palm Pilot 150 to access the Web site shown on HiTechTV Cable 135. Mike has not registered, but registration is allowed, so the process moves from step 1905, to step 1925, where registration is allowed, and then to step 1930. In step 1930, the immersion verification question 1820a with answer choices is displayed. In step 1935, Mike answers 3 (“XX2040”). There is another question so the process moves from step 1940 to 1945. In step 1945, the advertiser question 1820b with answer choices is displayed. In step 1950, Mike answers 3 (“within 1 year”). The same process is followed for the polling question 1820c, and Mike answers it. There are no additional questions, so the process moves from step 1940 to step 1926. In step 1926, because Mike does not have a CR\overline{A}V ID, the process moves to step 1927 and Mike registers and gets a CR\overline{A}V ID, which is automatically entered. The process then moves to step 1720.

For Mark, the process is as follows: Mark uses the bar's private network, which broadcasts the CR\overline{A}V ads and presents the query 1820 to the consumers 110 located within the bar who are connected to the private network and who have enrolled to play. Mark is asked for his CR\overline{A}V ID in step 1902. Mark has not pre-registered, so Mark types “NONE”, and the process moves to step 1905, and then to 1925. In step 1925, registration is allowed during the CR\overline{A}V ad, so the process moves to step 1930. In step 1930, the immersion verification question 1820a with answer choices is displayed. In step 1935, Mark answers 3 (“XX2040”). Another question is asked, so the process moves from step 1940 to 1945. In step 1945, the advertiser question 1820b with answer choices is displayed. In step 1950, Mark answers 3 (“within 1 year”). Another question is asked, so the process moves from step 1940 to 1945. In step 1945, the polling question 1820c with answer choices is displayed. In step 1950, Mark answers 1 (“Hillary Clinton”). No other questions are asked, so the process moves from step 1940 to step 1926. In step 1926, the device recognizes that Mark does not have a CR\overline{A}V ID. The process moves to step 1927, and Mark is asked if he wishes to follow the registration process (to obtain a CR\overline{A}V ID) or lose his query 1820 response information. Mark starts to complete the registration information, but is distracted and logs off. Because he does not complete the registration, he is not assigned a CR\overline{A}V ID, and his responses are discarded, as set forth in step 1928.

In step 1220 of FIG. 12, the CR\overline{A}V ad answers are gathered. This is done by the Phone Company SP 170, the Internet SP 185, the PDA SP 175, and the R-Bar Private Network SP 190 forwarding the response and applicable registration information to TPR's DCS 195.

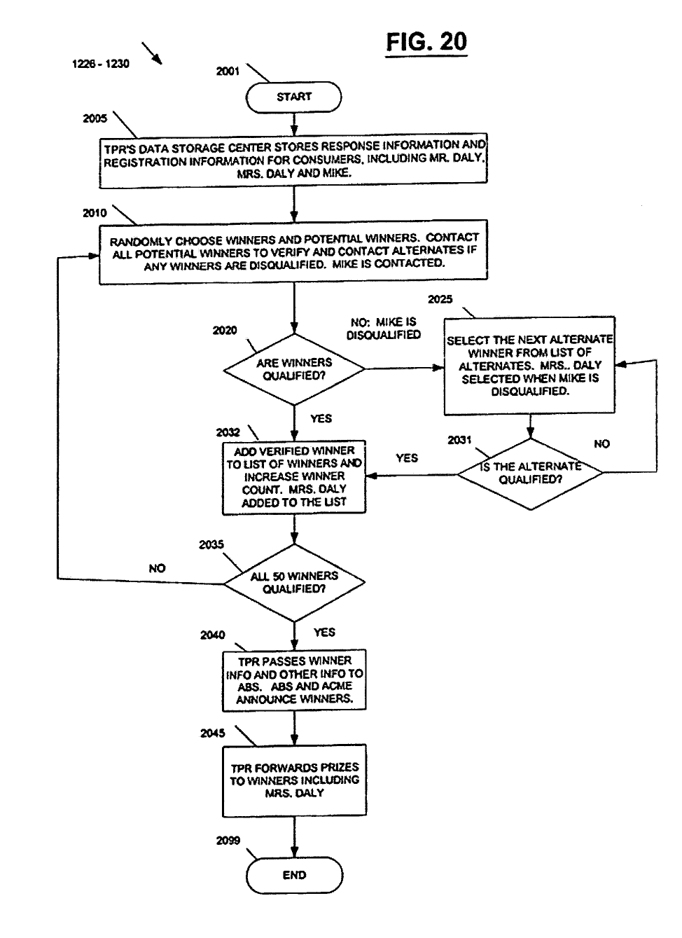

FIG. 20 is a flow diagram illustrating how TPR uses the data storage center 195 to select winners and distribute the prizes, as set forth in step 1226 and 1227 of FIG. 12. In step 2001, the process is initiated at the “START” button. In step 2005, TPR's data storage center 195 stores the registration information (for those who registered during game play) and the DCS 196 stores the response information for all the registered consumers 110, including Mr. Daly, Mrs. Daly, and Mike. In step 2010, the potential and alternates winners are randomly chosen and extracted from all the correct answers for question 1820a stored within the DCS 196. Mike is chosen as a one of 50 winners and Mrs. Daly is chosen as the first of 50 alternate winners. TPR begins the verification process by contacting all 50 winners. Each winner is qualified in step 2020, and as each winner is verified their name is added to the list of verified winners in step 2035, and the winner counter is increased. Ultimately, TPR contacts Mike in step 2010 to verify his CR\overline{A}V ID, registration information, and response information in step 2020. Mike's registration information was falsified (he said he was 60 when registering, but in reality he is 25), so he is disqualified, because truthful answers are required as a condition of winning according to ABS Promotion rules. All of Mike's data is also purged from the data storage center 195 to avoid potentially false or misleading information. This is done to maintain data base integrity. According to step 2020, because Mike's information is not correct, the first alternate winner at the top of the list is chosen, as set forth in step 2025. Mrs. Daly is the first alternate winner, so her information is verified in step 2025. Because Mrs. Daly's immersion verification question was correct, and her demographic data is proven to be accurate and verified in step 2031, so she is selected as a verified winner and added to the list in step 2032.

In step 2035, once all 50 winners have been selected and verified, the process moves to step 2040, where TPR forwards to ABS the information as to the identities of all winners, including Mrs. Daly. In step 2040, ABS and ACME also jointly announce the name of all winners, including Mrs. Daly. Included in the information passed to ABS from TPR in step 2040 is a report including demographic information for all consumer responses for the ACME and pollster designed questions, which ABS may elect to pass along to ACME or to survey organizations that have contracted ABS to acquire polling statistics. This report is derived and data mined from the registration and response data. This information includes statistics indicating that of the 5.532 million female consumers 110, 534,461 live in households with average incomes in excess of $75,000 per year. This information also indicates that, of these, 6.5% live in the state of Florida and are over 50 years old, and 3.443% expect to purchase a car within the next six months, 5.2% live in the metropolitan NYC area, and 0.8429% expect to purchase a new car within the next six months. The statistics also indicate that across all age groups, and all occupations, Frank Maggio will be elected President in 2008 by a 59.8% share of the popular vote.

In step 2045, TPR forwards a convertible to Mrs. Daly and the other winners. The process ends in step 2099.

Other Applications

While the above description is ideally suited for visual mass-media broadcast technology such as the Broadcast TV 120, Cable TV 135, Satellite TV 140, Private Networks 125, other Networks 141, and the Internet 130, it may also be utilized in alternate mass-media channels, using audio-only technology like radio, or visual-only broadcast mediums, such as a magazine or newspaper ad. The CR\overline{A}V ads may be answered with complicated, highly developed computer devices 111, or simply by using the Phone 145. Those practiced in the art will recognize the above invention may be implemented with any broadcast medium and response medium. In addition, the invention is not limited to providing ads with entertainment content, but can be extended to providing other types of information.

Printed Response Devices

As mentioned above, in an exemplary embodiment, the other response device 166 can comprise a printed response device, which can be delivered subsequently to the data storage center 195. Printed response devices can provide a cost-effective means of interacting and can rely upon an information gathering system 191, such as the U.S. Postal service network or Private Delivery services (ranging from couriers to overnight mail service center networks), to deliver the printed responses to the data storage center 195. Additionally, printed responses can be forwarded to the data storage center 195 via a facsimile machine, or can be scanned and forwarded via e-mail or other computer media.

In an exemplary embodiment, consumers (recipients) can interact with CR\overline{A}V ads through printed responses, which can be forwarded subsequently to a data storage center 195 for compilation utilizing manual methodologies. Other compilation methodologies may be employed such as Optical Character Recognition (OCR) or Optical Mark Recognition (OMR), which will facilitate a quicker and more efficient compilation of data contained on the printed responses when compared to manual data entry.

In one embodiment of a CR\overline{A}V printed response, other elements of a CR\overline{A}V ad can be included on the printed response device itself, in effect converting the printed response to a self-contained, printed CR\overline{A}V ad, complete with the “alert,” printed “vignette,” and Immersion verification query (or an area upon the printed response to enter the response, after broadcast of the Immersion verification query via another medium, such as Television or Internet).

Production and Distribution of CR\overline{A}V Printed Responses

The means by which the consumer may obtain a printed response may include, but are not limited to, newspaper (local or national) printed responses printed as content on the pages or as a separate insert; magazine (local or national) printed responses printed as content on the pages or as a separate insert; e-mail delivery to registered CR\overline{A}V players that have elected this service; Internet download from the CR\overline{A}V promoter, advertiser, or affiliated site, in .pdf, .txt, .doc, or other format; direct mail (either upon request or as part of a direct mail promotion); physical distribution points, such as grocery stores, gas stations, or other affiliated establishments; and facsimile delivery to registered CR\overline{A}V players who have elected this service, or to those who have requested a facsimile printed response.

OCR and OMR Technology

OCR (Optical Character Recognition) involves electronic reading of text from paper and translating the images into a form that the computer can manipulate. An OCR system enables feeding a document directly into an electronic computer file. The text can be written in any method acceptable to the OCR system. For example, the text can be written with a dark pencil or ink and in a legible manner. Any difficulties the computer develops when identifying a character may involve manual intervention. While this method does require more manual intervention than OMR, discussed below, it is significantly quicker than pure manual entry for all data to be captured.

OMR (Optical Mark Reading) is a process to detect the presence of intended, marked responses. An OMR form comprises response areas (“bubbles”), which a consumer marks to indicate a response. A mark, such as a darkened bubble, registers significantly less light than the surrounding paper. In order to be detected, a mark should be positioned correctly on the paper (within the bubble) and significantly darker than the surrounding paper. While being the most accurate and quickest method of capturing data, OMR forms are larger than OCR forms due to the included bubbles.

Sample CR\overline{A}V Printed Responses

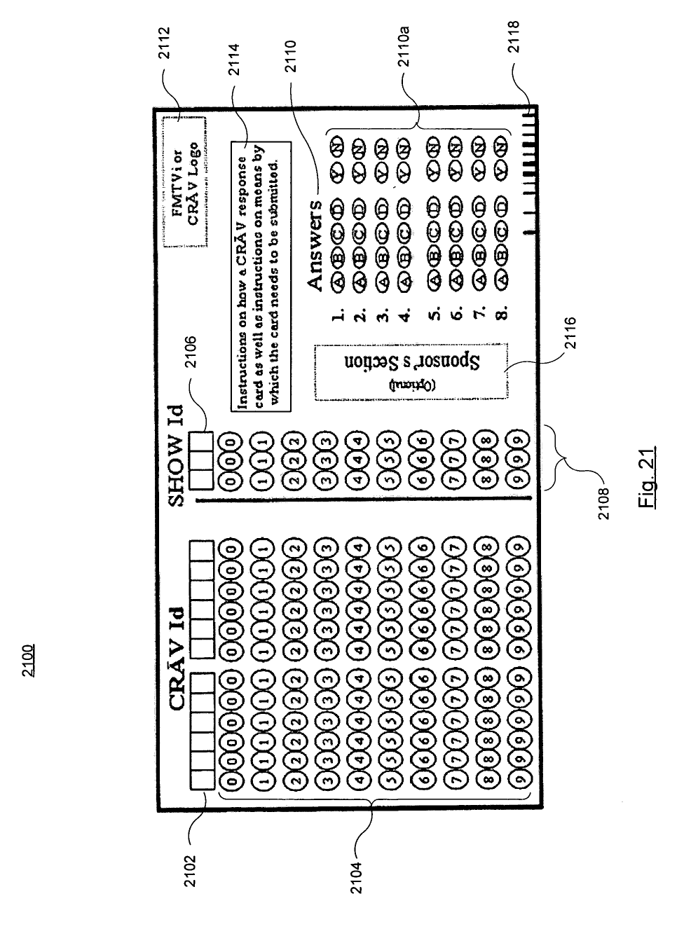

FIGS. 21-24 illustrate representative printed responses according to exemplary embodiments of the present invention. FIG. 21 illustrates a representative OMR printed response 2100 according to an exemplary embodiment of the present invention. As shown in FIG. 21, the printed response 2100 comprises CR\overline{A}V identification number blocks 2102 and corresponding OMR bubbles 2104. Accordingly, a registered recipient can enter his CR\overline{A}V identification number in the blocks 2102 and can darken the corresponding bubbles in the bubbles 2104.

The printed response 2100 also comprises show identification number blocks 2106 and corresponding OMR bubbles 2108. The recipient can enter the show identification number in the blocks 2106 for the particular show in which the recipient reviewed the CR\overline{A}V advertisement and can darken the corresponding bubbles 2108. The printed response 2100 can be used for multiple CR\overline{A}V-enabled shows by allowing the recipient to enter in blocks 2106 the particular show identification number for which the recipient is responding to the query. Accordingly, the printed response 2100 can provide greater flexibility and longevity for distribution channels, such as physical distribution points.

An answer section 2110 comprises OMR bubbles 2110a for each query. In the exemplary embodiment of FIG. 21, the answer section 2110 includes OMR bubbles 2110a for eight Queries. To answer a query about a vignette, the recipient darkens one of the OMR bubbles 2110a corresponding to the answer choice for a particular query. As illustrated in FIG. 21, the OMR bubbles 2110a can comprise four multiple choice answers A-D, as well as a yes/no answer choice for each query. The yes/no answer choices can allow a recipient to answer an optional advertiser fulfillment question for each query.

The printed response 2100 also can comprise an alert 2112 to indicate that the recipient can receive substantial awards by answering a question about a corresponding broadcast advertisement. In an exemplary embodiment, the alert 2112 can comprise the FMTVi or CR\overline{A}V logo. In an alternative exemplary embodiment, the alert 2112 can provide additional information to inform the consumer to watch a particular televised CR\overline{A}V ad or ad pod comprising the vignette and/or query. An advertisement pod comprises multiple advertisements, at least one of which comprises a CR\overline{A}V advertisement. The multiple advertisements of an advertisement pod can be presented together in a group, individually at different times, or as a combination of individual and group advertisements.

An instruction section 2114 informs the recipient how to complete and submit the printed response 2100 to qualify for the substantial rewards. For example, submission instructions can include a postal address or facsimile phone number. In an alternative embodiment, the instructions can be provided separately from the printed response. For example, the instructions can be provided in the corresponding advertisement, a separate advertisement, a website, or other location. In a sponsor's section 2116, advertising space can be sold to a sponsor to produce revenues that offset printing and distribution costs of the printed response 2100. A return address (not shown) can be provided on the back of the printed response 2100. The return address can inform the recipient of the address for submitting the printed response 2100. A bar code 2118 provides a registration mark for the OCR and OMR scanning equipment.

In operation, a recipient completes and submits the printed response 2100. An OMR reader detects the blackened bubbles in sections 2104, 2108, and 2110a to verify immersion by determining whether the recipient correctly answered the query.

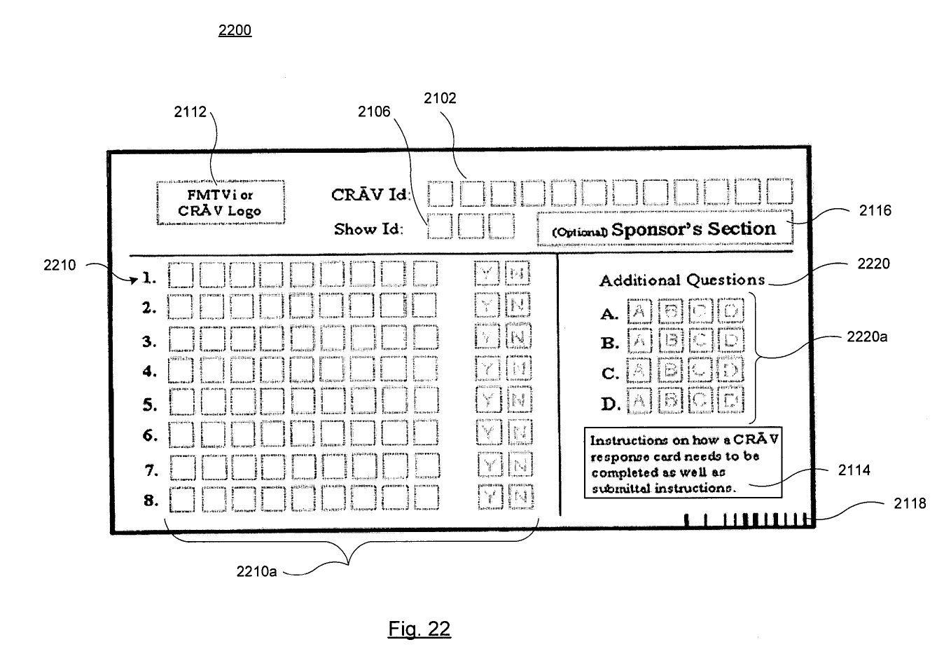

FIG. 22 illustrates a representative OCR printed response 2200 according to an exemplary embodiment of the present invention. As shown in FIG. 22, the printed response 2200 comprises the CR\overline{A}V identification number blocks 2102 and the show identification number blocks 2106. However, because an OCR reader can detect the written characters in the blocks 2102 and 2106, corresponding OMR bubbles are not provided.

An answer section 2210 provides answer blocks 2210a in which a recipient can enter the response to the query. With the OCR printed response 2200, a recipient's answers are not confined to multiple choices. Accordingly, a recipient can enter any characters in the answer blocks 2210a. Additionally, as shown, a recipient can answer an optional yes/no advertiser fulfillment question for each query in the corresponding Y/N blocks.

In the exemplary embodiment illustrated in FIG. 22, an additional questions section 2220 allows a recipient to respond to additional questions asked by an advertiser. As shown, the additional questions section 2220 comprises answer blocks 2220a in which the recipient can enter a response to each of several additional questions. As illustrated, the additional question answer blocks 2220a can present a multiple-choice answer selection in an undetectable color to indicate the expected character for the recipient to enter.

In operation, a recipient completes and submits the printed response 2200, and an OCR reader detects the characters in blocks 2102, 2106, 2210a, and 2220a to verify immersion by determining whether the recipient correctly answered the query.

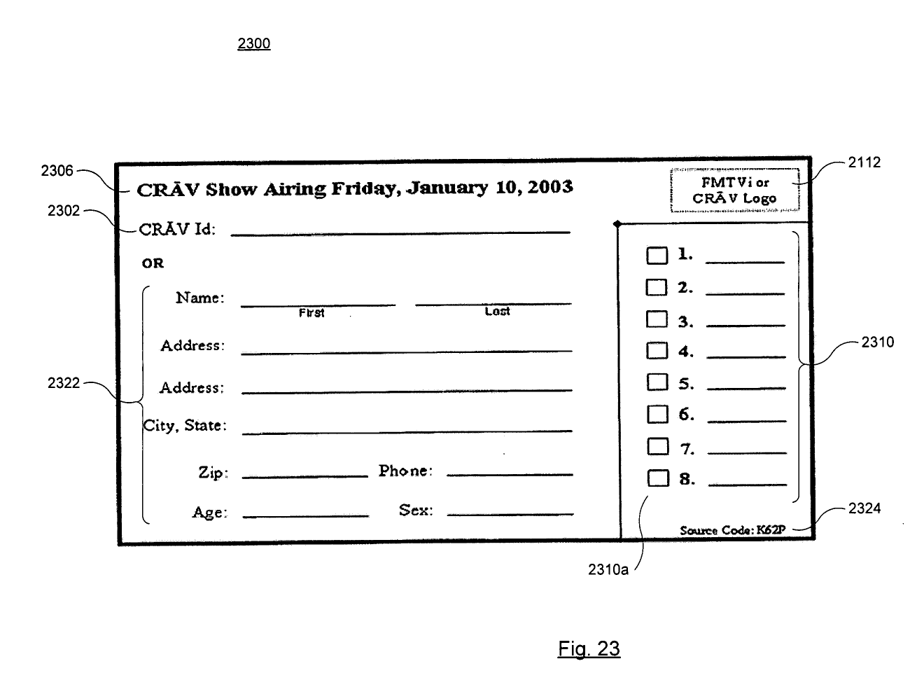

FIG. 23 illustrates a representative manual data entry printed response 2300 according to an exemplary embodiment of the present invention. The manual data entry printed response 2300 does not require any special paper stock and can be printed easily on newsprint, magazine, or other stock. As illustrated in FIG. 23, the printed response 2300 comprises a CR\overline{A}V identification section 2302, a registration section 2322, and an answer section 2310. Each section 2302, 2322, and 2310 allows a recipient to write in all data in the blanks provided. The registration section 2322 allows a recipient to register at the time the recipient submits the answers to the query. Alternatively, the recipient can enter a pre-registered CR\overline{A}V identification number in the section 2302. In the answer section 2310, a recipient writes answers in the blanks corresponding to the respective query. Additionally, the recipient can check a fulfillment box 2310a provided next to each query number to indicate that the recipient has provided an answer for that query.

The printed response 2300 also comprises a predetermined show identification section 2306 to indicate the particular show for which the printed response 2300 applies. Accordingly, the printed response 2300 can be used for only the particular show identified in section 2306, thereby providing a one time, one-game use printed response.

A source code 2324 provides information regarding the location where the recipient obtained the printed response 2300.

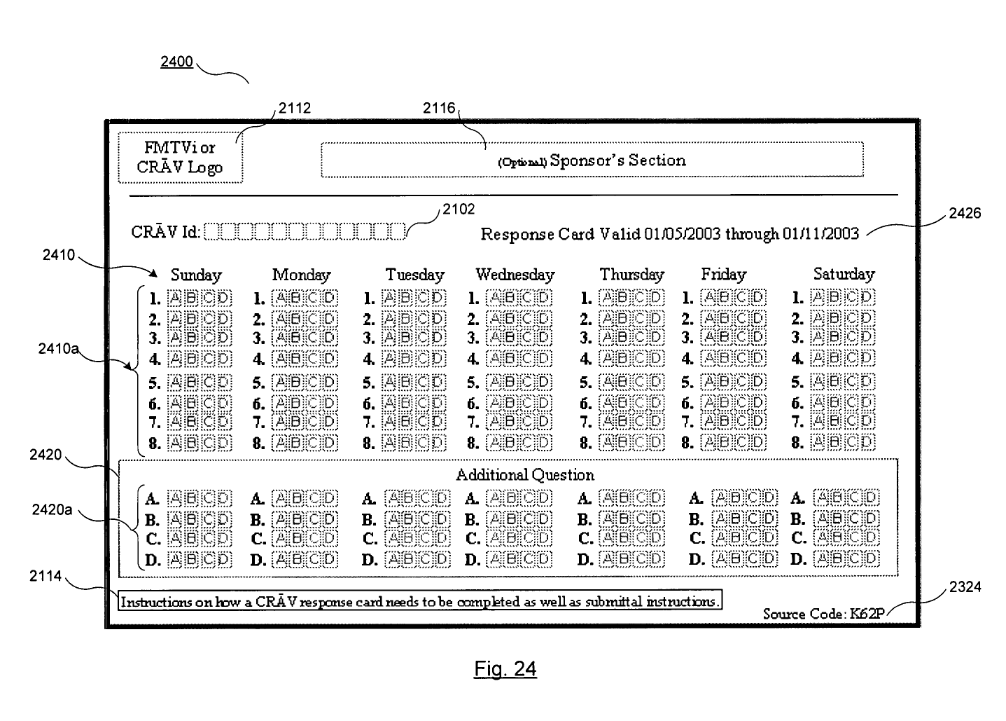

FIG. 24 illustrates a representative multiple-entry printed response 2400 according to an exemplary embodiment of the present invention. As illustrated in FIG. 24, the printed response 2400 comprises a weekly printed response having daily answer sections 2410 for an entire week of scheduled CR\overline{A}V advertisements. Each daily answer section 2410 comprises answer blocks 2410a in which a recipient can enter a response to multiple Queries for advertisements broadcast during the respective day. The exemplary printed response 2400 comprises OCR answer blocks 2410a. In an alternative embodiment, the printed response 2400 can comprise OMR answer blocks. The printed response 2400 also comprises an additional questions section 2420 comprising additional daily question blocks 2420a for each respective day of the week.

A validity field 2426 indicates the effective date of the printed response 2400. The printed response 2400 can allow multiple days of CR\overline{A}V ads to be verified on a single printed response. The weekly printed response 2400 illustrated in FIG. 24 can be distributed once a week, or smaller printed responses could be distributed daily. In an exemplary embodiment, weekly and daily printed responses can be delivered to the recipients via national or local newspapers, or other print media.

The exemplary printed responses illustrated in FIGS. 21-24 are not limited to the specific features discussed above. Other features can be added to the printed responses within the scope of the present invention. Additionally, combining features from different printed responses discussed above is within the scope of the present invention.

Delivery of Printed Response to the Data Center

All versions of the printed response, regardless of the type of process used to process the data, can be transmitted or mailed to recipients utilizing a private or public delivery network, such as the United States Postal Service. Versions of the printed response that will be processed manually also can be transmitted by facsimile to the recipients.

The recipients can return the printed responses by mail, facsimile transmission, or other electronic methods to the data storage center 195. The data storage center 195 receives mailed printed responses and processes them manually or through OCR/OMR to capture the data on each printed response. The data storage center 195 can print printed responses received by facsimile transmission and can process the printed responses in a similar manner. Additionally, if the data storage center 195 captures the faxed printed response via facsimile server, then data input personnel can view the faxed printed response on a screen to process the data, thereby alleviating the need to print the faxed printed response.

In exemplary embodiments, recipients can utilize other methods to return the printed responses to the data storage center 195. For example, the recipients can hand deliver the printed responses (personally or via courier), as well as deliver the printed responses by overnight or priority delivery. The allowed methods of delivery depend on the promoter, who can establish the particular methods acceptable for each response based on volume processing needs.

Combined CR\overline{A}V ad and Printed Response

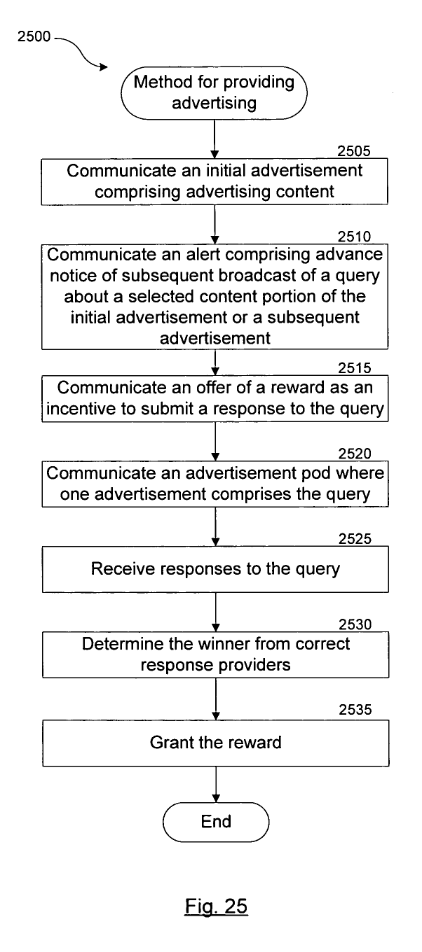

In an exemplary embodiment, a CR\overline{A}V printed response can combine elements of a CR\overline{A}V ad itself. When those elements are combined with the written interactive portion of the reply, the printed response can serve as a self-contained CR\overline{A}V promotion. Such a combination will be described with reference to FIG. 25.

FIG. 25 is a flow chart depicting a method 2500 for providing advertising that combines CR\overline{A}V ad elements with the interactive portion of a reply according to an exemplary embodiment of the present invention. In step 2505, the promoter communicates an initial advertisement to multiple recipients via a mass-media, non-interactive broadcast network. The initial advertisement comprises advertising content for a promotion and is communicated prior to subsequent advertisements related to the initial advertisement. In step 2510, the promoter communicates an alert that provides advance notice of subsequent broadcast of a query about a selected content portion of the initial advertisement. The alert can provide notice that the query will be presented during one of multiple advertisements broadcast at a subsequent time. In an exemplary embodiment, the alert can be communicated in the initial advertisement. In an alternative exemplary embodiment, the alert can be communicated separately from the initial advertisement.

In step 2515, the promoter communicates an offer of a reward as an incentive for the recipients to submit a response to the query. Accordingly, the offer can provide an incentive for the recipients to become exposed to the subsequent broadcast of the query to be able to submit a response.

In step 2520, the promoter communicates an advertisement pod to multiple recipients via a mass-media, non-interactive broadcast network. The advertisement pod comprises multiple advertisements, at least one of which comprises a CR\overline{A}V advertisement. One of the multiple advertisements can comprise the query, as indicated in the alert. The recipients then respond to the query, and the data storage center 195 receives the responses in step 2525. In step 2530, the data storage center 195 processes the responses and determines one or more winners of the reward, based on correct responses to the query. Finally, in step 2535, the promoter grants the reward to each winner.

In an exemplary embodiment, the initial advertisement can be communicated on or with a printed response. Accordingly, the recipients can respond to the query by indicating their response on the printed response and forwarding the printed response to the data storage center 195 for processing.

For example, HammerTime Hardware store publishes a printed advertisement in a national newspaper, such as USA Today. In the advertisement, HammerTime prints the CR\overline{A}V logo (qualifying as an alert), and utilizes the advertisement's content portion of the promotion to educate the recipients about several new benefits of HammerTime's newly renovated stores. Among the benefits described is the “3 or Free” promotion, under which a consumer waiting more than 3 minutes in a checkout line at HammerTime receives one item free.

The alert also can inform the recipient that a query about a selected content portion of HammerTime's newspaper advertisement will be broadcast subsequently on the CRS TV network during a televised CR\overline{A}V advertisement pod airing Monday evening during the 8:00 PM program hour. The advertisement also can comprise an offer of a reward by indicating that HammerTime will award fifty 24k gold hammers to recipients that respond correctly to the query. That offer can serve as a clue that the CR\overline{A}V ad within the advertisement pod will be an advertisement by HammerTime Hardware.

The newspaper advertisement further can comprise a printed response section to be completed by the recipient. The printed response can comprise an area for insertion of a CR\overline{A}V ID number, or a section to register, an answer area to darken bubbles for A, B, C, D responses to the query, and a yes/no question asking if the consumer wants to receive a $10 coupon redeemable at the nearest HammerTime Hardware store.

Such a CR\overline{A}V advertisement, combined with a printed response, might appear as a typical printed advertisement, with an alert logo on the page or printed response, and comprising a printed response similar to one of the exemplary printed responses illustrated in FIGS. 21-24. In this example, the Immersion verification query will be distributed via network television, and the advertisement or printed response comprises the alert and vignette elements of a CR\overline{A}V advertisement.

The CRS network broadcasts a plurality of ads, including a HammerTime ad, on CRS during the 8:00 PM Monday evening hour. The CRS network also broadcasts the Immersion verification query, “How many minutes will you wait before one item you are buying is free?” The query can be correctly answered by immersion in either the newspaper or TV HammerTime advertisement. The recipient views the plurality of ads and the query and selects one of the answer choices a) 1, b) 2, c) 3, and d) 5 minutes on the printed response. The recipient can darken the “c” bubble, enter their CR\overline{A}V ID number, and mail the clipped printed response to the instructed address to qualify for substantial rewards. The recipient may choose to receive a free $10 coupon as well.

Additional Considerations for Printed Responses

Printed responses have several benefits when compared to live, immediate responses delivered via the Internet or telephone. The greatest benefit of printed responses is the ease of distribution (via most publishing methodologies, or via direct mail), and the simple nature of interaction that is available to virtually everyone who can read. However, the deferred time between submission of a response by a recipient and receipt by the promoter allows for the consumer to potentially research the CR\overline{A}V advertisement before submitting a response, which potentially can lessen the quality of Immersion. For example, a recipient could tape a program containing CR\overline{A}V ads and could simply rewind to the portion of the CR\overline{A}V advertisement that presents the Immersion verification query. Then, the recipient could seek out only that element of the advertisement that comprises the query and could avoid the remainder of the advertisement. Alternatively, the recipient could pay less attention to some portions while focusing only on the topic subject to the query (in our example, the number of wait minutes.) The consumer might not need to memorize an advertisement to be better able to successfully verify Immersion. On the other hand, the deferred player may be afforded the time to tape and replay the advertisements multiple times, which provides for repeat exposure of the advertisements to the consumer.

If a promoter believes that memorization is a key element for obtaining Immersion, and that delayed verification (say, by printed response, or via Internet after a predetermined time frame has elapsed) is not desirable, then the promoter can provide differing levels of awards based on the type of Interaction. For instance, in the above example, the promoter can announce that forty of the fifty gold hammers will be awarded to recipients that respond within sixty seconds of the broadcast advertisement pod. The balance of ten hammers will be awarded to recipients that successfully respond within forty-eight hours (or other time frame) of the advertisement pod broadcast. That prizing structure rewards live interaction and memorization more while allowing slower methods of response.

Additionally, the deferred response prizing structure can apply to a deferred response from any response device. For example, a recipient that responds within sixty seconds, or any predetermined time frame, can qualify for a specified reward or reward pool. The recipient can respond within the time frame by any response device. For example, the recipient can respond within the time frame by telephone, Internet, faxed printed response, or other response device. The recipient can qualify for a different level of reward or reward pool by responding after the initial time frame and before the closing of the response period. Again, the recipient can respond by any response device to qualify for the different reward level. For example, the recipient can respond within the time frame by telephone, Internet, faxed printed response, mailed printed response, or other response device.

The promoter also can determine whether to distribute long-term printed responses (such as the weekly printed response 2400 of FIG. 24), daily printed responses, or single use printed responses (as in the HammerTime example above). An entire week of scheduled CR\overline{A}V ads could be verified on a single printed response distributed once a week (for example, in a national newspaper). Alternatively, daily or single-use printed responses could be distributed daily in a local newspaper and can allow interaction with consumers that missed the weekly printed response distribution. Additionally, the weekly printed response also could be distributed every day in a daily publication, which might increase advertisement size and corresponding advertisement cost to the promoter. Weekly printed responses potentially can provide savings to recipients in postage when compared to daily or single use printed responses, especially when drop-off locations are not convenient or when printed responses do not have prepaid postage.

promoters also can consider the cost of collecting data submitted on printed responses, particularly data submitted on printed responses printed in publications having paper stock that is not suitable for OCR and OMR machines (such as newsprint). Printed responses may be submitted via postal delivery and may be folded and inserted into an envelope, potentially requiring the fulfillment and verification process to include opening of envelopes and manual data entry (both of which add to promotional costs). Promoters may avoid some of those costs with weekly printed responses to reduce envelope opening to once a week.

Additional data collected during a CR\overline{A}V advertisement (such as polling information) is obtained more cost-effectively when the additional queries are presented during the response process, as opposed to during the more expensive broadcast for which the promoter must purchase additional air time. To provide interaction to these additional queries on a printed response, the promoter can include the queries on the printed response.

A weekly printed response may provide areas for response interaction for nine advertisements per day, for seven days, totaling sixty-three response areas. To make a CR\overline{A}V pod of four advertisements more effective, the promoter wants recipients to pay attention to all four advertisements even if only one advertisement in the pod comprises an actual CR\overline{A}V advertisement. Such a level of attention can provide all advertisers with high levels of Immersion. Accordingly, the promoter can structure the printed response to prevent the printed response from providing a clue to the particular CR\overline{A}V advertisement within the pod. For instance, in the HammerTime example discussed above, the promoter attempts to avoid indicating that the second question of the third pod on Monday will be sponsored by HammerTime Hardware. Therefore, in some cases, the promoter may not provide non-Immersion Verification queries, or related query interaction areas, on a printed response, to avoid providing clues that potentially impact other advertisements in a pod negatively.

In such an instance, where only Immersion Verification responses and ID information are provided on a mailed-in or delivered printed response, the promoter can ask the recipient to place his CR\overline{A}V ID number on the face of the envelope. Then, the promoter may elect to draw envelopes at random to award prizes, thereby avoiding opening and data entry costs for all non-winning printed response submissions. That process works best when the promoter sees little or no value in the non-Immersion Verification responses (such as polling responses). Alternatively, the promoter can have the CR\overline{A}V ID numbers manually entered from the envelope fronts, if the promoter deems that information to be valuable. The promoter also can ask the recipient to place on the envelope's outside the number of CR\overline{A}V advertisements to which the consumer is responding (e.g., 27 of 63 advertisements were viewed in a week). The promoter may value that data, which can be entered without incurring the costs of opening all envelopes and entering all data.

The CR\overline{A}V system and process can be utilized across any mass-media broadcast network 105. For example, the mass-media broadcast network 105 can comprise TV, cable, satellite, radio, outdoor media (billboards, signs, buses), print media (newspapers, magazines), direct mail, the Internet, or other broadcast network, as well as private networks. Private networks can comprise networks having connected Personal Recording devices such as a TiVo®. Additionally, a convergence of multiple mass-media broadcast networks 105, when utilized together, can broaden the reach and effectiveness of CR\overline{A}V ads. “Concentrated segments” of CR\overline{A}V ads can saturate consecutive segments of time. For example, concentrated CR\overline{A}V segments can be broadcast as a game show, or through a dedicated network of continuous CR\overline{A}V ads. That concentrated process can allow a promoter, advertiser(s), or network(s) to increase the portion of mass-media time (or in the example of print media, space) that can be allocated to revenue-generating CR\overline{A}V ads, while lowering the portion of time once dedicated to costly content. The consumers will support the concentrated ads, provided the substantial rewards associated with CR\overline{A}V ads remain a central component of the game show or dedicated network.

Types of Mass Media CR\overline{A}V Ads

Radio

Radio programs are distributed over the airwaves, and/or over the Internet. As with the television industry, ad revenues garnered by radio stations are utilized to offset the costs of content (music, news, sports, etc.) and its production, as well as overhead costs such as staff and marketing. As with television, ads and ad pods are embedded between content segments. Consumers tend to avoid radio ads by switching channels, listening to alternate forms of entertainment (such as CDs, DVDs, television, etc.), or by turning off the radio.

Within radio program segments, single CR\overline{A}V ads or CR\overline{A}V ad pods can be broadcast. Some or all ads within the program may be CR\overline{A}V ads. CR\overline{A}V ads can contain “alert” tones or specific alert wording to entice immersion. The alert can be provided at the beginning of a program or program segment, or at the beginning or end of an ad or ad pod. After the ads (audio “vignettes”) are broadcast, listeners can be provided with log-in instructions. The instructions can suggest immersion verification via telephone or cellular phone. Additionally, the instructions can suggest immersion verification through any of the response devices 111. Accordingly, consumers can register and/or provide query responses to immersion verification or other queries through the response devices 111. The Queries can be broadcast on air, before or after the CR\overline{A}V ad. Alternatively, the Queries can be provided during the query-response interaction process utilizing devices 111 over networks provided by Service Providers 112.

Promoters may desire to provide multiple queries to make cheating more difficult. For example, cheating can include one consumer learning the content and providing the query and answer to subsequent players. Promoters may also desire to limit the amount of time allowed for interaction. In addition to Immersion Verification queries, other queries can be included. For example, the other queries can comprise sponsor-designed questions, polling questions, demographic questions, etc., similarly to television use of CR\overline{A}V ads.

Aspects of the television industry's use of CR\overline{A}V ads discussed above mirror the radio industry. Those aspects comprise the advance promotion and registration of CR\overline{A}V players, the assignment of CR\overline{A}V ID numbers, research, and the substantial prizing and prize fulfillment aspects. Those practiced in the art will recognize the similarities between the radio broadcast and television broadcast industries, as well as the similarities in the methods, analysis, and sales techniques utilized by promoters to determine the sales price and costs of CR\overline{A}V ads.

Print Media: Books/Magazines/Newspapers

Books, magazines, and newspapers are distributed to subscribers through vending or printed work sales outlets. Additionally, on-line versions of those printed materials may be distributed via the Internet. Over-air broadcast mass-media (such as television and radio) have costs affiliated with time. In other words, radio and television costs of content are measured in units of time, and ad units are sold as units of time. On the other hand, print mass-media content costs are affiliated with space, such as ad size on printed pages. The more printed pages, the higher the cost of a printed work.

Ad revenues garnered by print media are utilized to offset the costs of paper, printing costs, distribution, development of written and photographic content and its production, and staff and marketing overhead. Ads of different sizes can be embedded between content segments or sections of the print media. Consumers tend to avoid print ads by ignoring the ad, reading around the ad, turning the page, or discontinuing reading the written work.

Within and between printed content segments, CR\overline{A}V ads of different sizes can be printed or distributed. The ads can comprise an alert mark or logo to entice immersion. Additionally, specific printed instructions can be provided within the ad to entice immersion. Internet distribution of magazines (e-magazines or e-zines) or newspapers also can comprise audio or visual alerts. An alert logo can be provided on a printed ad to invite immersion in the content of that individual ad. Alternatively, an alert logo can be provided on multiple ads to invite immersion in the content for a section of ads or for one of the ads in the section. The multiple ads can comprise the printed version of an ad pod.

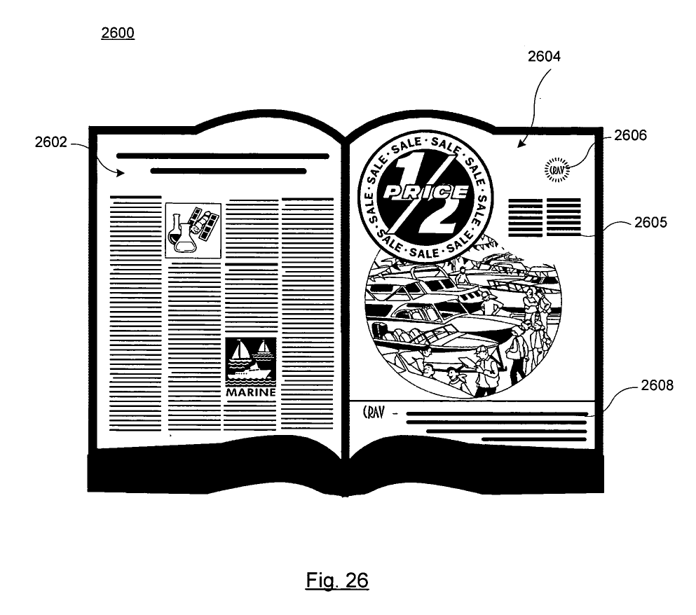

FIG. 26 illustrates a print media advertisement 2600 according to an exemplary embodiment of the present invention. As shown, the print media ad 2600 comprises content 2602 and a CR\overline{A}V ad 2604. The CR\overline{A}V ad 2604 comprises advertising content 2605, which can comprise a vignette. The CR\overline{A}V ad 2604 also comprises an alert logo 2606, which alerts the consumer to a possible reward for becoming immersed in the CR\overline{A}V ad content 2605. A CR\overline{A}V instruction/verification section 2608 can provide one or more of a query about a selected portion of the advertising content 2605, instructions for responding to the query, prize information, an alert to subsequent broadcast or distribution of a query, or other information.

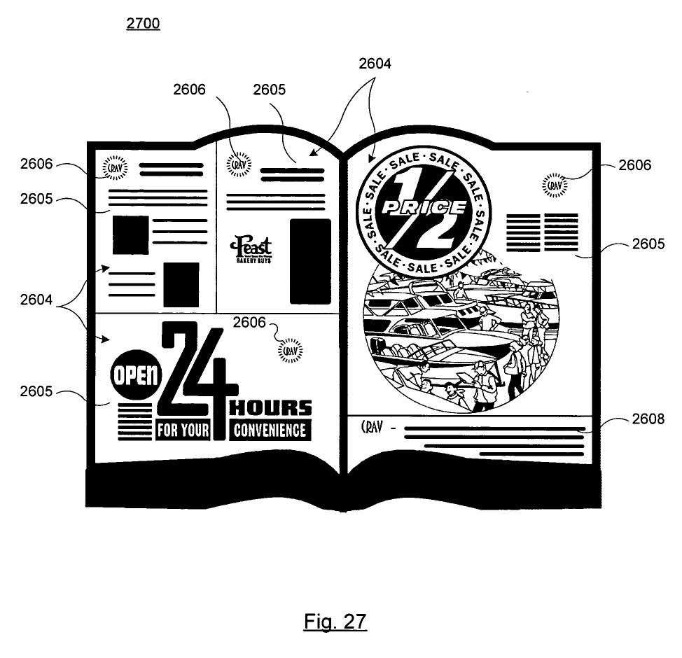

FIG. 27 illustrates a print media advertisement pod 2700 according to an exemplary embodiment of the present invention. As shown, the print media ad pod 2700 comprises multiple CR\overline{A}V ads 2604. Each CR\overline{A}V ad 2604 comprises advertising content 2605, which can comprise a vignette. Additionally, each CR\overline{A}V ad 2604 comprises the alert logo 2606, which alerts the consumer to a possible reward for becoming immersed in the CR\overline{A}V ad content 2605. The CR\overline{A}V instruction/verification section 2608 can provide one or more Queries about a selected content portion of one or more of the multiple ads 2604. Additionally, the CR\overline{A}V instruction/verification section 2608 can provide one or more of instructions for responding to the query, prize information, an alert to subsequent broadcast of a query, or other information.

After the consumers review the print media ads, they can register and/or provide a query response through the various response devices 111. In exemplary embodiments, the Immersion verification query can be printed on the ad, hidden elsewhere within the printed publication, or provided only during the query interaction/response process through the response devices 111. Providing the query during the interaction/response process can enhance immersion by requiring memorization of the ad to assist in expeditious answering of the query.

As discussed above, promoters may desire to provide multiple queries to make cheating more difficult. Promoters can attempt to allow a consumer to interact with an ad only once, further increasing the likelihood of serious desire to play properly and increasing the likelihood and effectiveness of immersion. To prevent subsequent reviewing of the ad, promoters can limit the amount of time allowed for interaction, or can allow interaction and immersion verification within a limited, announced timeframe. Accordingly, the consumers can rely on memory to correctly and timely answer the query. In addition to immersion verification queries, other queries can be included. For example, other queries can comprise sponsor-designed questions, polling questions, demographic questions, etc.

Most aspects of the television industry's use of CR\overline{A}V ads discussed above mirror the mass-media print industry. For example, similarities include advance promotion and registration of CR\overline{A}V players, the assignment of CR\overline{A}V ID numbers, research, and the substantial prizing and prize fulfillment aspects. Those practiced in the art will recognize the similarities between the radio and television broadcast industries, when compared to the print industry, as well as the methods, analysis, and sales techniques utilized by promoters to determine the sales price and costs for CR\overline{A}V ads.

Outdoor Media

Outdoor media can comprise billboards, fixed signs on or inside buildings, and mobile signs on taxis, buses, plane banners, or blimps. Outdoor mass-media advertising can rely on capturing the attention of passing consumers for short time periods. To create outdoor media, promoters utilize printed materials such as billboard “wraps” or printed card inserts for taxis, paint applied directly to boards or buildings, and electronic billboards. Electronic billboards can display advertising messages and entertainment content, such as news headlines, sports headlines, etc. However, most outdoor media comprise advertising messages and do not comprise substantial amounts of traditional content.

Ad revenues generated by outdoor media promoters are utilized to offset the costs of development of written and photographic content and its production, paper, printing costs, paint, distribution, installation, material costs, overhead, rental fees, or other fees charged by billboard property owners, taxi cab, or advertising facility owners. Consumers tend to avoid outdoor media ads by ignoring them, or by looking away.

A CR\overline{A}V version of an outdoor mass-media ad can comprise a recognized visual “alert” mark or logo on an outdoor media ad to entice immersion. Alternatively, the outdoor media ad can comprise an audible tone to entice immersion. The audible tone can be provided over radio waves or can emanate from the outdoor media item itself. The outdoor media CR\overline{A}V ad also can provide log-in instructions, allowing interaction through the various response devices 111 for consumers to register and/or to provide query responses. The Immersion verification query can be printed on the outdoor media ad. Alternatively, the Immersion verification query can be provided during the query interaction/response process through the response devices 111.

As discussed above, promoters may desire to provide multiple queries to make cheating more difficult. Promoters can attempt to allow a consumer to interact with an ad only once, further increasing the likelihood of serious desire to properly play and increasing the likelihood and effectiveness of immersion. To prevent subsequent reviewing of the ad, promoters can limit the amount of time allowed for interaction, or can allow interaction and immersion verification within a limited announced timeframe. Accordingly, the consumer can rely on memory to correctly and timely answer the query. In addition to immersion verification queries, other queries can be included. For example, other queries can comprise sponsor-designed questions, polling questions, demographic questions, etc.

Aspects of the television industry's use of CR\overline{A}V ads discussed above mirror the outdoor media industry. For example, those aspects comprise the advance promotion and registration of CR\overline{A}V players (a billboard promoter could advise passerby's of “WATCH THIS SPACE FOR FUTURE CR\overline{A}V ADS”), the assignment of CR\overline{A}V ID numbers for registered players, research aspects of registration and query responses, and the substantial prizing and prize fulfillment aspects. Those practiced in the art will recognize the similarities between the radio and television broadcast industries, when compared to the outdoor media, as well as the methods, analysis, and sales techniques utilized by promoters to determine the sales price and costs for CR\overline{A}V outdoor ads.

Direct Mail

Direct mail relies on capturing the attention of consumers while opening their mail. Many Direct Mail promoters utilize printed materials (envelopes, printed advertising fliers, brochures, coupons, etc.) and incur substantial costs in distributing their advertising. Most direct mail media, like outdoor media, do not comprise substantial amounts of traditional content and are typically dominated by advertising messages. However, in some respects, direct mail promoters face many of the cost structures of the print media industries because costs are determined by space rather than broadcast time.

Direct mail promoters can mail one advertising insert, or multiple ad inserts, to a mass mailing list, taking advantage of economies of scale such as bulk mail rates. In the event of multiple mailed pieces within one envelope (the direct mail version of an ad “pod”), costs of distribution are shared by multiple advertisers, lowering the costs per insert. Ad revenues garnered by direct mail media promoters are utilized to offset the costs of paper, printing costs, distribution and postage, handling, overhead, and development of written and photographic content and its production. Consumers tend to avoid direct mail media ads by discarding them while sorting incoming mail, often before even opening the envelopes.

A CR\overline{A}V version of a direct mail ad can comprise a recognized visual alert mark or logo on the envelope or on the insert itself. An alert logo can be added to a single printed insert to invite immersion in that individual CR\overline{A}V ad. Alternatively, an alert can apply and invite immersion for all inserts in the event of multiple inserts (a direct mail ad pod.) The CR\overline{A}V envelope or CR\overline{A}V ad can provide printed log-in instructions, allowing interaction facilitated through the various response devices 111. Accordingly, consumers can register and/or provide query responses through the response devices 111. The Immersion verification query also can be printed on the envelope or insert. Alternatively, the query can be provided during the query response/interaction process.

As discussed above, promoters may desire to provide multiple queries to make cheating more difficult. Promoters can attempt to allow a consumer to interact with an ad only once, further increasing the likelihood of serious desire to play properly and increasing the likelihood and effectiveness of immersion. To prevent subsequent reviewing of the ad, promoters can limit the amount of time allowed for interaction, or can allow interaction and immersion verification within a limited announced timeframe. Accordingly, the consumer can rely on memory to correctly and timely answer the query. In addition to immersion verification queries, other queries can be included. For example, other queries can comprise sponsor-designed questions, polling questions, demographic questions, etc.

Aspects of the television industry's use of CR\overline{A}V ads discussed above mirror the direct mail media industry. Those aspects comprise the advance promotion and registration of CR\overline{A}V players (initial mailings can advise recipients of future mailings bearing the CR\overline{A}V logo or pre-registration), the assignment of CR\overline{A}V ID numbers for registered players, research aspects of registration and query responses, and the substantial prizing and prize fulfillment aspects. Those practiced in the art will recognize the similarities between the radio and television broadcast industries, when compared to the direct mail media industry, as well as the methods, analysis, and sales techniques utilized by promoters to determine the sales price and costs for direct mail CR\overline{A}V ads.

Internet

Mass distribution of CR\overline{A}V ads over the Internet can take multiple forms, each of which can share aspects of other mass-media types. In addition, the Internet can save promoters certain costs affiliated with less modern forms of mass-media. For example, Internet promoters can create “broadcast e-mail ads.” In such ads, a promoter can mass broadcast e-mails to a list of e-mail addresses, simulating a direct mail campaign without bearing the costs of materials and postage.

Internet promoters also can “stream” video versions of televised or radio content and embedded ads, or merely the ads themselves, to consumers. In “requested streamed Internet ads,” the promoters can stream the content to consumers upon request. Alternatively, in “simulcast broadcast ads,” the promoters can stream simulcast versions of televised or radio content and embedded ads, which are mass broadcast over a web site. In the example of streaming audio or video feeds, promoters bear bandwidth costs, which must be considered when calculating the cost to the advertiser for sending streaming ads, or streaming CR\overline{A}V ads, to consumers.

Some distributors of printed materials offer “Internet mirrored display ads.” For example, newspaper distributors can offer on-line versions of their printed works on a website. Internet consumers of the printed work can review content and ads in the newspaper on the website. Those Internet mirrored display ads are similar to the printed media ads discussed above.

Internet promoters also use “mass-media banner ads” as a means of Internet advertising. A promoter can create a CR\overline{A}V mass-media banner ad by consistently posting the ad on a mass-media website in a non-targeted fashion without linking the advertiser directly to the consumer. The CR\overline{A}V banner ad can comprise an alert and can provide substantial rewards to some of the consumers who register and verify immersion in the ad's content. Those CR\overline{A}V ads are different from the types of targeted Internet ads displayed only to consumers that meet specified criteria.

Consumers tend to avoid Internet ads by closing browser windows containing ads, or avoiding web sites that comprise ads altogether. However, Internet CR\overline{A}V ads can overcome the consumers' tendencies by drawing the consumers' attention to the ads. Each of the Internet ads discussed above can comprise a CR\overline{A}V ad by implementing the alert and Immersion Verification processes for the ad itself. Multiple CR\overline{A}V ads within a requested stream, simulcast broadcast, mirrored display, or mass-media banner broadcast can comprise a “pod” of ads, whereby an Immersion verification query can be posed about one or more of the ads in the pod. The CR\overline{A}V ads can comprise alert logos or tones, or specific alert wording to entice immersion.

After the ads are broadcast by stream, display, or banner with video and/or audio vignettes, consumers can be provided with log-in instructions, typically suggesting log-in for immersion verification via the Internet, but also available through the other response devices 111. Accordingly, consumers can register and/or provide query responses to immersion verification queries using the response devices 111. Queries also can be broadcast following the vignette or before or after the CR\overline{A}V ad. Alternatively, the Queries can be provided during the query response/interaction process utilizing the response devices 111 over networks provided by Service Providers 112.

As discussed above, promoters may desire to provide multiple queries to make cheating more difficult. Promoters can attempt to allow a consumer to interact with an ad only once, further increasing the likelihood of serious desire to play properly and increasing the likelihood and effectiveness of immersion. To prevent subsequent reviewing of the ad, promoters can limit the amount of time allowed for interaction, or can allow interaction and immersion verification within a limited, announced timeframe. Accordingly, the consumer can rely on memory to correctly and timely answer the query. In addition to immersion verification queries, other queries can be included. For example, other queries can comprise sponsor-designed questions, polling questions, demographic questions, etc.

Aspects of the television industry's use of CR\overline{A}V ads discussed above mirror CR\overline{A}V ads over the Internet. Those aspects comprise the advance promotion and registration of CR\overline{A}V players, the assignment of CR\overline{A}V ID numbers, research, and the substantial prizing and prize fulfillment aspects. Those practiced in the art will recognize the similarities between the Internet and television broadcast industries, as well as the methods, analysis, and sales techniques utilized by promoters to determine the sales price and costs for CR\overline{A}V ads.

Private Networks

Private networks can exist across all mass-media industries. For example, private networks comprise a mailing list (distribution of materials over the U.S. Postal Service delivery network), magazine subscription list, e-mail address distribution list, taped music distributed to subscribers (like Muzak), a connected network of broadcast content linked to interactive devices within bars and restaurants (such as NTN), consumers connected through a cable system to Video on Demand servers, and owners on a Personal Video Recorder network.

For mass-media broadcasting of CR\overline{A}V ads over a private network, the private network requires the ability to cost effectively distribute (i.e., broadcast) ads across the entire network. That broadcasting differs from targeted media, which include distributing interactive ads to a segment of consumers connected to the private network based on targeted profiles, such as demographics.

In general, ads distributed over a private network are subject to the same consumer avoidance techniques indicative of the industry (i.e., print ads can be avoided by turning the page). Similarly, the implementation of CR\overline{A}V ads across a private network will enhance immersion, just as it would across the public network version of the same CR\overline{A}V ads.

Convergence

To enhance the effectiveness of CR\overline{A}V ads, the CR\overline{A}V ads can be broadcast across a convergence of multiple media forms (“cross-media” broadcasting). For example, a promoter can distribute CR\overline{A}V ads comprising the same message about a new automobile across the radio, television, Internet, and print mediums. The ads can be presented simultaneously or at different times on the multiple media forms. While the ads can have different appearances based upon restrictions of each media, the immersion verification query can be the same across all media.

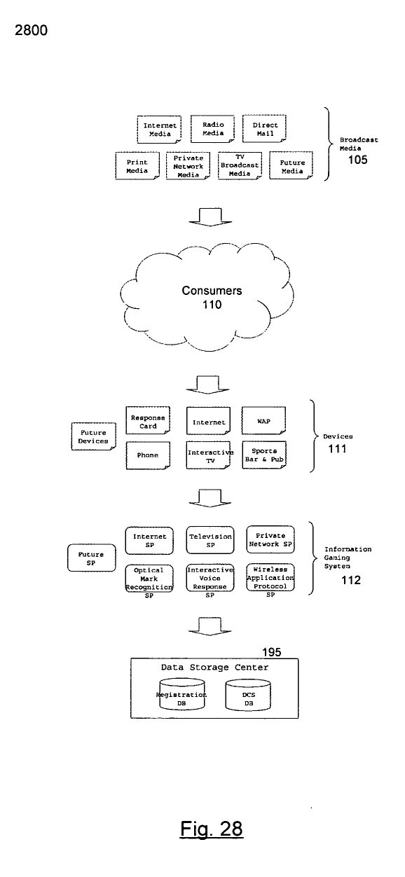

FIG. 28 illustrates a CR\overline{A}V ad broadcast over a convergence 2800 of mass-media formats according to an exemplary embodiment of the present invention. As shown, a promoter can broadcast to consumers 110 a CR\overline{A}V ad or ad pod over two or more of the broadcast networks 105. The CR\overline{A}V ad or ad pod can be broadcast simultaneously or independently over the multiple broadcast networks 105. The consumers 110 can react to the CR\overline{A}V ad or ad pod by responding to an immersion verification query about a selected content portion of a CR\overline{A}V ad or pod. The consumers 110 can respond to the query through one or more of the response devices 111. The query can be provided over one or more of the multiple broadcast networks 105. Alternatively, the query can be provided over the response devices 111. The response devices 111 communicate the consumers' query responses to the data storage center 195 through the respective Service Provides 112. A reward can be granted to a consumer that responds correctly to the query.

In an exemplary embodiment, a promoter or advertiser can bundle CR\overline{A}V ads across all media, and the interaction process also can be triggered by each media individually or through instructions provided in one of the media (for example, television). In an exemplary embodiment, one media can provide “clues” to assist CR\overline{A}V players in correctly answering CR\overline{A}V ads in another media. For example, a local newspaper might publish an ad with a CR\overline{A}V logo. The ad can explain that a televised CR\overline{A}V ad sponsored by the same advertiser will be broadcast within a CR\overline{A}V ad pod during a certain timeframe that evening, over a specified television network. In an exemplary embodiment, immersion verification can be available only after the televised CR\overline{A}V ad airs. The query can be broadcast on air, provided in the original ad, or provided during the response/interaction process. Accordingly, the CR\overline{A}V logo on the print ad can provide the future televised CR\overline{A}V ad viewer with a clue as to which ad in the indicated CR\overline{A}V pod is the ad for which the immersion query applies. This convergence methodology can be implemented over the radio, or in unison with radio, print, television, well-timed direct mail, private networks, or other broadcast media. Additionally, such a “detached” CR\overline{A}V ad can be distributed in various parts over various mass-media formats.

Another exemplary form of convergence is the utilization of the bandwidth provided over a high definition signal. This bandwidth can be divided into multiple signals, which can include data, Internet, radio, and televised content. Multiple-channel use of this bandwidth can provide delivery of normal or high definition televised or radio CR\overline{A}V ads, while also providing Internet content that might include Immersion Verification Queries. Similarly, the Internet signal might include CR\overline{A}V ads (stream, display, or banner with video and/or audio vignettes). As indicated above, those Internet CR\overline{A}V ads can utilize the same Immersion Verification Queries as other cross-media CR\overline{A}V ads in the marketplace. Additionally, the multiple media formats can provide clues to viewers of televised CR\overline{A}V ads as to which ad or ads in a scheduled televised pod will be subject to immersion verification.

Another exemplary form of convergence comprises “back channel” technology, which provides a data feed from television set top boxes or private video recorders (“PVRs”). The set top boxes and PVRs receive broadcast content signal over a satellite or cable network and display the signal on a monitor. The monitor can comprise a TV. Consumers can access the back channel of the set top boxes or PVRs to send data from the set top boxes or PVRs to a third party. This back channel signal can be delivered by a second signal source. The second signal source can comprise broadband or dial-up Internet access, telephone, cable, or satellite. The back channel signal also can provide two-way communication. Accordingly, immersion verification, registration, and response/interaction can be performed utilizing the back channel capabilities of the set top boxes or PVRs.

For set top boxes and PVRs, CR\overline{A}V ads (or elements of CR\overline{A}V ads) can be delivered to the consumer via a convergence of mass-media formats. For example, the alert and vignette can be delivered via television broadcast, while the immersion verification query and interaction elements can be delivered via Internet.

In an exemplary embodiment, while watching a CR\overline{A}V ad, the consumer can press a button on the set top box, PVR, or the remote control, which opens a second CR\overline{A}V ad. The second CR\overline{A}V ad can comprise a display ad or even full motion video and can provide some or all of the elements of the on-air CR\overline{A}V ad. That exemplary embodiment can expose the consumer to a second branded CR\overline{A}V advertisement.

Those skilled in the art will recognize that the present invention applies to any mass-media broadcast network and that new types of delivery technologies can serve as new mass-media platforms for the delivery of content and ads, including CR\overline{A}V ads. Those future media will form part of the CR\overline{A}V ad delivery and interaction system and will be able to participate in the cross-media convergence methodologies discussed above.

Concentrated CR\overline{A}V Ads

CR\overline{A}V ads can be concentrated to create an entire program comprising continuous or contiguous CR\overline{A}V ads. The concentrated ads can generate sponsorship revenues for the promoters for each CR\overline{A}V ad “content” segment, thereby converting content from a cost generating item to a revenue generating item. Concentration allows broadcasting a series of back-to-back CR\overline{A}V ads or pods without interruption by traditional content, which also can include a period of time for query responses between ads. In an exemplary embodiment, concentrated CR\overline{A}V can comprise a new game show format that allows a promoter or Broadcaster to utilize a greater percentage of the program hour (or publication) to generate revenue, providing promoters with the ability to realize a paradigm shift in the advertising-supported, mass-media industry.

Over time, CR\overline{A}V players can become authorized and indoctrinated players of CR\overline{A}V games and game shows across all mass-media models, including television, radio, print, direct mail, Internet, private networks, and outdoor media. Accordingly various extended (or even 24-hour) broadcast networks of CR\overline{A}V ads can be established to broadcast consecutive CR\overline{A}V ads or CR\overline{A}V pods.

Consumers can immediately find and interact with CR\overline{A}V ads on these extended broadcast networks. In a mature and evolved market, where CR\overline{A}V consumers are considered a valuable and voluminous portion of the general public, traditional broadcast networks or publications supported by advertising can sell blocks of advertising time or space to the promoters or owners of an extended CR\overline{A}V network. That block of advertising can temporarily boost the number of consumers viewing a simulcast CR\overline{A}V ad or pod on both the traditional and extended CR\overline{A}V broadcast networks. The selling network can provide the promoter with discounted pricing for the amount of space or time being purchased, in exchange for which the Seller can avoid sales costs and can generate net incremental revenues. The promoter can increase the fees charged to advertisers (or even to the traditional broadcast network) for airing CR\overline{A}V ads during the simulcast or multi-print platform segment. Indeed, multiple broadcast networks (across multiple industries) can sell synchronized advertising or ad pod time to the extended CR\overline{A}V network to simulcast identical CR\overline{A}V ads to a connected synchronous network of television, radio, and Internet consumers. The synchronized advertising can enhance the audience size and the substantial rewards available to successfully immersed and validated consumers.

CR\overline{A}V Game Show or Publication

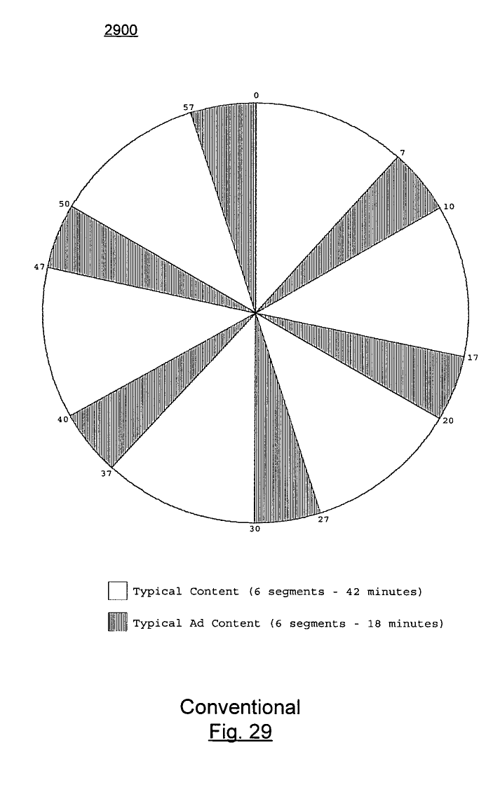

FIG. 29 illustrates the ratio 2900 of ad minutes to content minutes in a conventional programming hour-long broadcast. As shown, the conventional programming hour comprises six content segments lasting seven minutes each for a total of forty-two content minutes. The conventional programming hour also comprises six ad segments lasting three minutes each for a total of eighteen ad minutes. Accordingly, the ad to content ratio 2900 of the conventional programming hour is eighteen to forty-two.

FIG. 30 illustrates the ratio 3000 of ad minutes to hosted program minutes in a CR\overline{A}V game show hour-long broadcast according to an exemplary embodiment of the present invention. As shown, the CR\overline{A}V game show hour comprises twenty ad segments lasting two minutes each for a total of forty ad minutes. The CR\overline{A}V game show hour also comprises ten hosted content segments lasting two minutes each for a total of twenty hosted content minutes. Accordingly, the ad to hosted content ratio 3000 of the CR\overline{A}V game show hour is forty to twenty.

When compared to a CR\overline{A}V ad or ad pod, a feature of a CR\overline{A}V game show is that individual CR\overline{A}V ads or pods take on the characteristics of content. Traditional content can be reduced or eliminated over an extended period of time. For example, a televised CR\overline{A}V game show can last thirty or sixty minutes and can provide hosted segments between four minute, self-contained CR\overline{A}V ads or pods. As shown in FIG. 30, an hour-long CR\overline{A}V game show can comprise forty minutes of CR\overline{A}V ads, which generate revenues, while containing only twenty minutes of hosted content. Accordingly, the CR\overline{A}V game show can virtually reverse the conventional ratio of content cost to advertising revenue illustrated in FIG. 29.

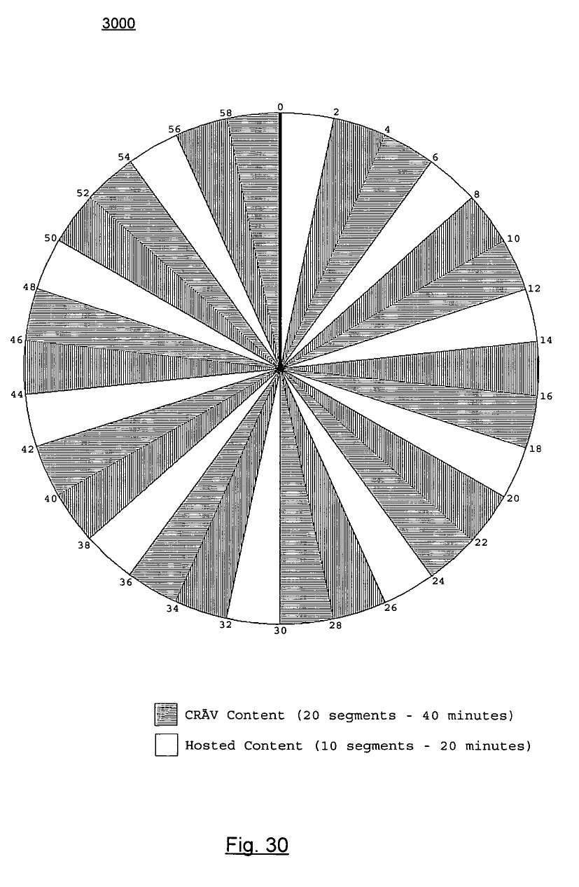

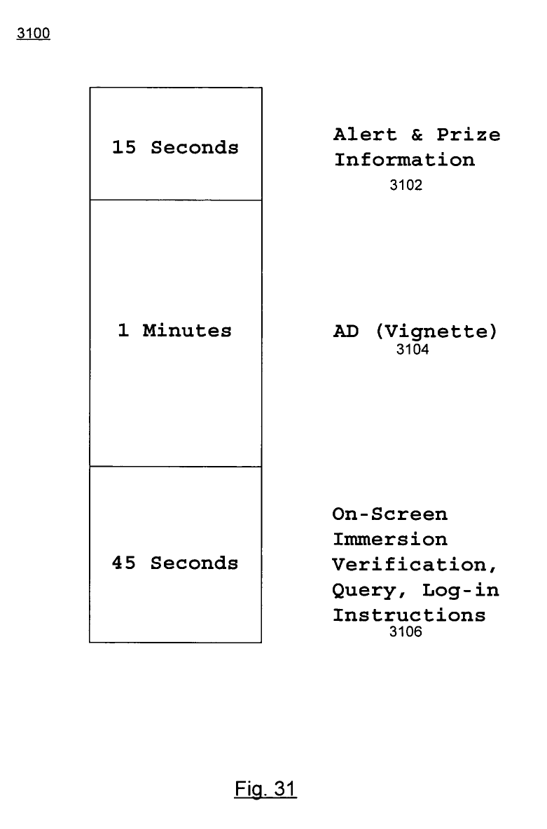

FIG. 31 illustrates a representative CR\overline{A}V game show two minute segment 3100 according to an exemplary embodiment of the present invention. As shown, the segment 3100 comprises fifteen seconds of alert and prize information 3102, a one minute vignette 3104, and forty-five seconds of on-screen Immersion verification query posting and log-in instructions 3106. The forty-five second portion 3106 also can comprise on-screen awards and a query answer period.

This continuous game show format and system also can be transitioned from traditional shows with embedded CR\overline{A}V ads to a CR\overline{A}V game show with little or no traditional content by way of a hybrid version of a CR\overline{A}V game show. In such a hybrid version, the “content” can reference the embedded CR\overline{A}V ads or pods, beginning the process by which consumers will become accustomed to, and ultimately accepting and desirous of, higher concentration of CR\overline{A}V ads during certain time frames.

In an exemplary embodiment, a hybrid version of a CR\overline{A}V game show can comprise “reality” programming where the consumers starring or winning on the program itself were selected from consumers who successfully verified immersion to CR\overline{A}V ads that aired in prior weeks. In such a program, program content can become closely associated with the CR\overline{A}V ad pods broadcast between content segments.

CR\overline{A}V game shows (or hybrid versions) also can be presented over the radio, Internet, private networks, or any other form of mass-media. For example, a publication containing CR\overline{A}V ads and little other content can comprise a CR\overline{A}V game. Consumers can immerse themselves in the CR\overline{A}V ad content and interact over the Internet or phone by answering one or more immersion verification questions of some ads in the publication. The questions can be generated at random from a pre-designed list of questions created by the promoter or advertiser. The questions can include time limitations so that the consumer must commit the CR\overline{A}V ads to memory due to the insufficient time allowed for the consumer to re-review the ad and subsequently to provide the answer.

Another exemplary form of a hybrid game show (which verges on a form of a hybrid network) can be “manufactured” with the use of Personal Video Recorders (“PVRs”) tied to a broadcast network such as television or the Internet. Since PVRs can record programs based on air times or tags embedded within the signal that notifies the recorder to record a segment, CR\overline{A}V ads or pods also can be scheduled or tagged for recording over the course of a timeframe (hours or days). The PVRs can record all programs that meet a certain criteria, such as name of show, starring actor, type of programs, etc. Accordingly, a CR\overline{A}V ad tag can be added as search criteria, and PVR's can strip the traditional program content away from the ads. Then, the consumer can watch back to back CR\overline{A}V ads or pods. If immersion verification can be watched on a delayed, or “time shifted” basis, then the consumer can review a virtual game show of CR\overline{A}V ads manufactured from the individual CR\overline{A}V ads or pods broadcast over the designated recording period.

The manufactured CR\overline{A}V game show also can be created over the Internet. In that case, a multi-media computer can search for CR\overline{A}V ads, store them in a section of a hard drive, and thereafter allow the consumer to view, read, or listen to CR\overline{A}V ads saved and stored within the computer.

Concentrated CR\overline{A}V Network

A more saturated form of CR\overline{A}V advertising can be broadcast over a continuous network feed, comprising a series of back to back CR\overline{A}V ads or pods. This feed can be delivered by traditional or newer forms of broadcast networks 105 and can be received for commercial purposes. For example, the continuous feed can be broadcast to a television network that can retransmit some or the entire signal to consumers. Alternatively, the continuous feed can be broadcast directly to consumers via a 24-hour CR\overline{A}V television network channel.

The direct-to-consumer network can allow a promoter to sell CR\overline{A}V ads or pods to advertisers interested in placing CR\overline{A}V ads on a network dedicated entirely to CR\overline{A}V ads. Consumers can turn to the CR\overline{A}V broadcast at any time to view, hear, or read CR\overline{A}V ads. Such availability can provide consumers with a rewarding alternative to the non-CR\overline{A}V ads being embedded within other programs.

Ultimately, during non-CR\overline{A}V commercial breaks (“conventional commercial breaks”) on conventional television, radio, Internet, or private network broadcasts, a consumer can elect to temporarily (or permanently) change channels to the continuous CR\overline{A}V broadcast. Accordingly, a consumer can avoid being exposed to conventional advertising (non-CR\overline{A}V advertising) by turning to the CR\overline{A}V ads on the continuous CR\overline{A}V broadcast.

In an exemplary embodiment, the conventional broadcasts can substitute the continuous CR\overline{A}V signal during the conventional commercial breaks. Currently, conventional networks must sell their ad time directly to advertisers, or to media companies, who place the ads with their Clients. Utilizing the concentrated CR\overline{A}V process, the conventional network can sell a three minute block of time to the promoter of the CR\overline{A}V network. That three minute block of time can be scheduled for distribution during a commercial break between conventional content segments of the conventional broadcast. Then, the promoter can add the viewing audience from the traditional network, when calculating the audience size for the particular CR\overline{A}V pod airing during that three minute time period. Additionally, the promoter can implement that process across multiple networks and media (such as radio and television). In that manner, the promoter can package a “road block” of CR\overline{A}V ads appearing simultaneously on multiple media and multiple channels within those media, as well as on the concentrated CR\overline{A}V network.

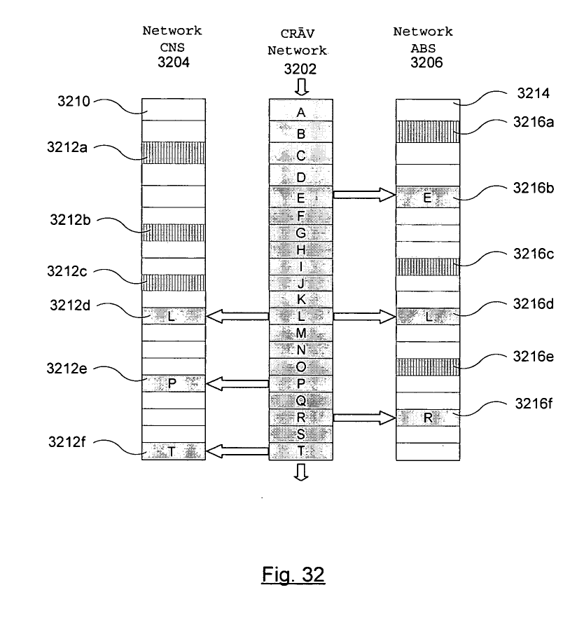

FIG. 32 illustrates the substitution of conventional advertising segments with CR\overline{A}V ad segments broadcast on a continuous CR\overline{A}V network 3202 according to an exemplary embodiment of the present invention. As shown, the continuous CR\overline{A}V network 3202 can broadcast three-minute CR\overline{A}V ads or ad pods A-T in a continuous manner during the illustrated hour-long segment. Simultaneously, CNS network 3204 can broadcast two conventional thirty-minute programs, comprising content segments 3210 with three-minute ad segments 3212a-f. Additionally, ABS network 3206, on another channel, can broadcast a conventional one-hour program comprising content segments 3214 and three-minute ad segments 3216a-f.

As shown in FIG. 32, the networks 3204, 3206 can link with the continuous CR\overline{A}V network 3202 during selected ad segments 3212d-f and 3216b, d, and f, respectively. During those linked segments, the conventional ad segment on networks 3204, 3206 are replaced with (substituted by) the CR\overline{A}V ad pods E, L, P, and T being broadcast on the continuous CR\overline{A}V network 3202 during the corresponding time slot.

FIG. 32 illustrates that during the first thirty minutes, CNS network 3204 does not link with the CR\overline{A}V network. However, during the second thirty minutes, all of the ads within the CNS network 3204 broadcast program are synchronized to the CR\overline{A}V network 3202 pods L, P, and T. Accordingly, the CR\overline{A}V network pods L, P, and T are substituted for the corresponding CNS network 3204 ad segments. Meanwhile, on ABS network 3206, the second ad pod on the program is synchronized with pod E from the CR\overline{A}V network 3202, as are pods L and R, but the remaining three pods in the program are not CR\overline{A}V ads. Accordingly, the CR\overline{A}V network pods E, L, and R are substituted for the corresponding ABS network 3204 ad segments.

In the example illustrated in FIG. 32, CR\overline{A}V network pod L is shown on three networks. Accordingly, the audience for CR\overline{A}V pod L is larger than other pods on any of the three networks individually.

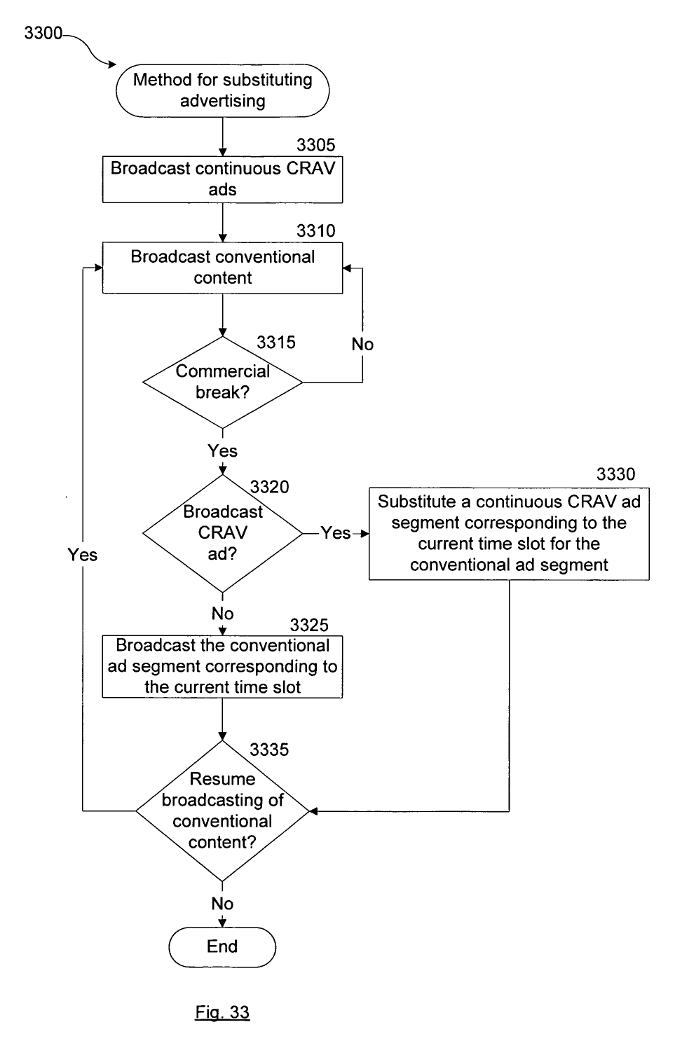

FIG. 33 is a flowchart depicting a method 3300 for substituting a CR\overline{A}V advertisement for a conventional advertisement according to an exemplary embodiment of the present invention. Referring to FIG. 33, the CR\overline{A}V network 3202 broadcasts continuous CR\overline{A}V ads or ad pods in step 3305. In step 3310, the CNS network 3204 simultaneously broadcasts conventional content. In step 3315, the CNS network 3204 determines whether it is time for a commercial break in the conventional content. If not, then the CNS network 3204 continues broadcasting the conventional content (step 3310). If it is time for a commercial break, then the method 3300 branches to step 3320.

In step 3320, the CNS network 3204 determines whether to broadcast a CR\overline{A}V ad segment during the commercial break. If not, then the method 3300 branches to step 3325. In step 3325, the CNS network 3204 broadcasts a conventional ad segment corresponding to the current time slot. The method then proceeds to step 3335 in which the CNS network 3204 determines whether to resume broadcasting of the conventional content. If yes, then the method branches back to step 3310 to broadcast the conventional content. If not, then the method ends.

If the method 3300 determines in step 3320 to broadcast a CR\overline{A}V ad segment during the commercial break, then the method branches to step 3330. In step 3330, the CNS network 3204 substitutes the continuous CR\overline{A}V ad segment being broadcast during the corresponding time slot of the commercial break for the conventional ad segment. To substitute the CR\overline{A}V ad segment for the conventional ad segment, the CNS network 3204 can receive the continuous broadcast CR\overline{A}V ads and can rebroadcast those ads over the CNS network 3204. The method then proceeds to step 3335 discussed above.

The CR\overline{A}V ad segment substituted for the conventional ad segment can comprise any of the CR\overline{A}V features, such as the alert, vignette, query, answer, response instructions, etc. In an exemplary embodiment, a three-minute CR\overline{A}V ad segment on the CR\overline{A}V network can comprise three thirty-second vignettes, one sixty-second vignette, and thirty seconds of on-screen immersion verification information, which can comprise prize information, log-in instructions, and live awarding and correct answer broadcast. However, the ad pod can comprise any combination of vignettes and immersion verification, as well as an alert and other CR\overline{A}V elements.

When promoting CR\overline{A}V pods on the CR\overline{A}V network, the promoter achieves audience size “spikes” based on the number and audience sizes of the traditional networks that also broadcast the CR\overline{A}V network ads or pods over the traditional network. During these spike periods, the promoter can increase the cost of the CR\overline{A}V ads and the size of the substantial rewards being awarded for the effected CR\overline{A}V ad or pod.

The traditional network can elect, during entire program segments, days, or even permanently, to provide, produce, and broadcast only traditional content, and can sell some or all of its commercial inventory time to the CR\overline{A}V network promoter. That process can eliminate or reduce the traditional network's sales operating costs and activities related to selling advertising time to advertisers. In that case, the CR\overline{A}V network promoter can add to its own audience size and share the audience size and share of the traditional network during all CR\overline{A}V ad pods that are “piggybacked” by the traditional networks.

In addition to increasing the number of CR\overline{A}V ads being broadcast and the number and size of substantial rewards being awarded, consumer acceptance of CR\overline{A}V ads can allow traditional broadcasters to partition ad segments differently. For example, ad pods can be located at the end of a program, or during a single, extended ad period, as opposed to interrupting content numerous times over the course of a program. Consumers tend to find content interruptions intrusive and disruptive and desire greater spans of uninterrupted content delivery. For example, consumers pay additional fees for premium channels that show uninterrupted content without advertising support. Accordingly, CR\overline{A}V ads tied to a CR\overline{A}V network can change the landscape of traditional mass-media delivery, where sections of programs (television, magazines, web sites, etc.) can be distinctly set aside as CR\overline{A}V ad sections, and traditional content can be easier to locate and enjoy in uninterrupted segments.

By recognizing the value of a consumer's time and feedback and by offering CR\overline{A}V ads instead of traditional, non-rewarding ads, the mass-media providers can phase out the practice of interrupting content with advertising as a means of forcing consumers to be exposed to ads. The providers can replace the entire ad process with a more civil, friendly approach to delivering consumer-desired ads. This new approach can be built on the principals of mutual respect between networks, advertisers, and consumers, where consumers acknowledge that advertisement provides them with lower cost (or free) programming, and consumers agree to watch, interact, and even embrace CR\overline{A}V ads during extended CR\overline{A}V ad segments in exchange for which networks deliver longer segments of uninterrupted content.

CR\overline{A}V Subscription Services

Subscription fees can further enhance the efficacy of CR\overline{A}V ads by increasing audience sizes and excitement through increased prizing levels or pools promoted across one or more broadcast (mass-media) networks. In addition to collecting traditional advertising fees for embedded advertising within entertainment content, the promoter can charge a subscription fee to consumers who purchase access to the broadcast signal (or other broadcast communications medium). The promoter can redistribute a portion of the subscription fee to the subscriber base in exchange for skill-based correct or random responses to queries about content, CR\overline{A}V ads, or a combination thereof. The subscription fees also can subsidize or pay for the costs of technical and human resource infrastructure required to develop, support, and broadcast televised content across the network or networks. To attract larger and more diverse audiences, multiple networks with targeted content channels can broadcast simultaneously, and the promoter can combine subscription fees with CR\overline{A}V ad premiums from all channels to increase the CR\overline{A}V prize pools. The larger CR\overline{A}V prize pools can entice more consumers (recipients) to participate in the reactive CR\overline{A}V ad process. The promoters can charge the CR\overline{A}V ad premiums because consumers are more likely to immerse themselves in CR\overline{A}V ad content.

Subscription channels can be targeted to a particular demographic. For example, subscription channels can comprise targeted entertainment content that attracts certain demographics of consumers. Then, a query regarding a CR\overline{A}V ad or channel content can be directed to the type of consumer more likely to watch that channel. In that case, the CR\overline{A}V or program content query will more likely target the consumer, even though that target consumer can comprise a minority of the consumer viewing audience in general. That process can attract advertisers offering products that have a targeted appeal. The advertisements can promote the products of the advertisers. Alternatively, the advertisements can promote upcoming content that will be broadcast on the subscription channel.

Promoters can combine subscription fees and CR\overline{A}V premiums from cooperating channels to increase the CR\overline{A}V ad prize pools. For example, promoters can offer a cumulative pool of prizes to viewers of multiple subscription channels to attract an increased number of targeted consumers to targeted channels. Combining prize pools and synchronizing ad breaks across combined channels also can simplify synchronizing and collecting reactive responses to CR\overline{A}V ads. Enhanced CR\overline{A}V prize pools can increase the excitement level and audience size of those consumers willing to immerse themselves in advertising messages. Promoters can enhance CR\overline{A}V prize pools by combining CR\overline{A}V ad premiums from multiple channels or mass-media types and by collecting subscription fees, some or all of which can be allocated to CR\overline{A}V prize levels.

Subscription fees can offset a network's complete or partial reliance upon advertising premiums. Subscription fees also can reduce the number of ads per hour needed to generate sufficient revenue compared to the number of ads needed on a non-subscription broadcast network. Broadcast networks that broadcast fewer non-rewarding ads will attract audiences that wish to frequent broadcast networks with limited ads and interruptions.

Subscription fees also can offset the costs of producing or acquiring program content and the costs of obtaining carriage by multi-system operators (MSOs) via cable and satellite signal distributors. Additionally, a portion of the subscription fees can be combined with, or can replace, CR\overline{A}V ad premiums to increase the prize pool available to consumers who react to CR\overline{A}V ad queries or reactive program content. Increased prize pools can increase audience sizes, which begins the cycle of allowing the network to attract more advertising dollars, increasing the prize pool once more, and attracting even larger audiences.

Multiple broadcast formats across one network can further attract subscribers to the subscription channels. The network can use the more ubiquitous over-air broadcast channels to promote the other subscription-based channels available across the network. The over-air broadcast channel also can alert the consumer that CR\overline{A}V ad prizes are dramatically higher to successfully immersed and selected consumers who are also subscribers to the entire network of channels.

In an exemplary embodiment, the information gathering system 112 can provide CR\overline{A}V ad queries based upon the demographic profile of the registered consumers. For example, a broadcast network 105 can broadcast a CR\overline{A}V ad pod comprising separate advertisements for an automobile, a vacation holiday, a perfume, a soft drink, and a long distance telephone service provider. The broadcast network can broadcast a query about the soft drink ad to all consumers. However, when a 29 year-old female calls or logs in to respond to the query, the information gathering system 112 can identify her demographic and can pose a query about the perfume ad to that consumer. Additionally, the information gathering system 112 can ask subsequent questions to that consumer about perfume purchase habits and can offer a free sample of perfume. The availability of queries for any of the ads within the ad pod can increase the attention level and immersion for all ads in the pod.

Synchronized, scheduled diverse CR\overline{A}V ad pods distributed across multiple channels on the broadcast network 105 can allow the information gathering system 112 and its resources to better prepare for and manage the reactive response periods throughout the broadcast day. Such synchronized CR\overline{A}V ads can be more efficient than a random distribution of CR\overline{A}V ads and queries across multiple channels and time zones. For example, a scheduled flight of CR\overline{A}V ads broadcast simultaneously between 7:11 and 7:15 PM on eight channels can allow each channel to promote the cumulative prize pools offered by all eight channels. Additionally, the promoter can combine prize and winner on-air announcements, which can reduce the amount of individualized production required for each channel. If CR\overline{A}V ad reaction is limited to a brief period following the last ads in the synchronized ad pods, then operators can deactivate the call centers and web sites of the information gathering system 112 when the response deadline occurs. During deactivation, the information gathering system 112 can clear extraneous information in preparation for the next reactive period.

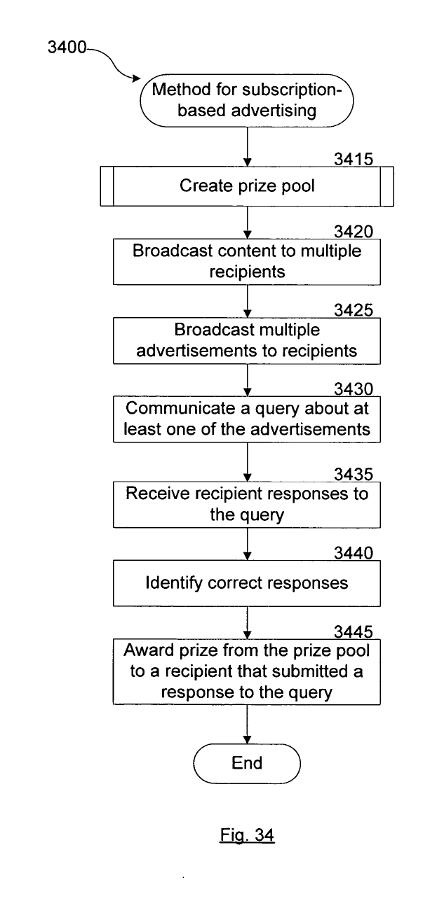

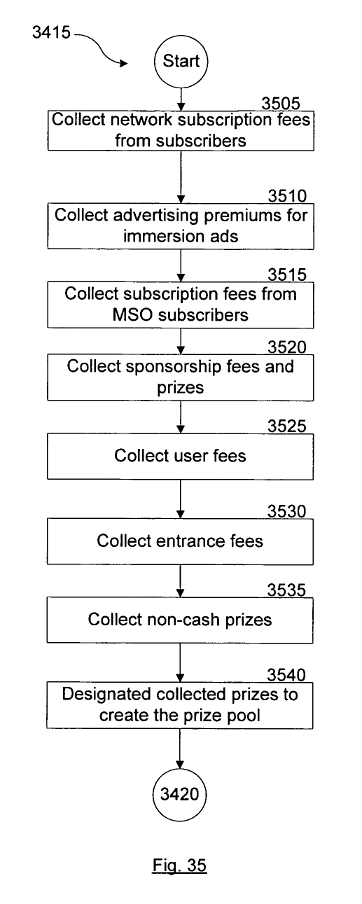

With reference to FIGS. 34-36, a single, CR\overline{A}V-enabled subscription-based mass-media network will be described. FIG. 34 is a flow chart depicting a method 3400 for immersion-based advertising according to an exemplary embodiment of the present invention. In step 3415, the promoter creates a prize pool from which to award prizes to recipients that respond to queries about a selected portion of an advertisement. Step 3415 is discussed in more detail below with reference to FIG. 35.

In step 3420, the network 105 broadcasts content to multiple recipients that subscribe to the network 105. In step 3425, the network 105 broadcasts multiple advertisements to the subscriber recipients. In an exemplary embodiment, the promoter or advertiser can broadcast the multiple advertisements by purchasing the airtime from the network 105.

In step 3430, a query is communicated about a selected portion of the content of at least one of the broadcast advertisements. In an exemplary embodiment, the promoter or advertiser can communicate the query by broadcasting the query over the network 105. In another exemplary embodiment, the promoter or advertiser can communicate the query to recipients via the information gathering system 112. For example, the promoter can communicate the query to the recipient via the telephone or internet when the recipient uses those response devices to react to the CR\overline{A}V ads.

In step 3435, the promoter or advertiser receives responses to the query from recipients that choose to interact or “react” to the CR\overline{A}V ads. In an exemplary embodiment, one or more of the advertisements can include the CR\overline{A}V logo or other indication (an alert) to indicate that the corresponding ad is a CR\overline{A}V ad and to invite the recipients to react to the CR\overline{A}V ad. The recipients can immerse themselves in the CR\overline{A}V ad in anticipation of responding to the query. If the query is broadcast via the network 105, then the recipient uses a response device 111 to communicate a response to the query to the data storage center 195 via the information gathering system 112. Alternatively, the recipient can connect to the information gather system 112 via a response device 111 and can receive the query communicated via the response device 111. Then, the recipient can communicate a response to the query via the response device 111 to the data storage center 195. In any case, the promoter or advertiser receives the communicated responses at the data storage center 195.

In step 3440, the data storage center 195 identifies correct responses to the query by determining whether each response includes a correct reply to the query.

In step 3445, the data storage center selects a recipient that submitted a response to the query as a winner and awards to the winner a prize (reward) based on the prize pool created in step 3415. In an exemplary embodiment, the winning recipient can comprise any recipient that submitted a response to the query, even if the response was incorrect. For example, all recipients that submit a response to the query can qualify to win a random drawing for the prize. In an alternative exemplary embodiment, the winning recipient can comprise a recipient that submitted a correct response. For example, only recipients that submit a correct response to the query can qualify for a random drawing for the prize. Alternatively, recipients that submit a correct response to the query can qualify for a prize from a larger prize pool, and recipients that submit an incorrect response can qualify for a prize from a smaller prize pool. In another alternative exemplary embodiment, the winner can be selected from recipients that correctly answer one or more follow-up questions after submitting the initial response to the query. The follow-up question(s) can narrow the field of potential winning recipients. The follow-up question(s) can comprise a trivia question, a demographic-based question, a skill-based question, or other suitable question.

FIG. 35 is a flow chart depicting a method 3415 for creating a prize pool according to an exemplary embodiment of the present invention, as referred to in step 3415 of FIG. 34. In step 3505, a subscription-based broadcast network 105 or a promoter collects subscription fees from recipient subscribers to the network 105. For example, the network 105 can charge a $5 per month subscription fee to recipients that desire to receive the content and/or ads broadcast on the subscription-based network 105.

In step 3510, the promoter or the network 105 collects advertising premiums for CR\overline{A}V immersion verification ads. Because the CR\overline{A}V ads according to exemplary embodiments of the present invention increase recipient immersion in ad content, advertisers will pay a premium to purchase the CR\overline{A}V ads.

In step 3515, a promoter collects subscription fees from MSO subscribers that desire to broadcast CR\overline{A}V channel(s) (comprising content and immersion ads) via the MSO's network 105. For example, an MSO may desire to broadcast the content and ads of the CR\overline{A}V channel(s) to subscribers to the MSO's broadcast network. The promoter can charge the MSO a monthly subscription fee for the right to broadcast the CR\overline{A}V channel(s) via the MSO's broadcast network 105.

In step 3520, the promoter or the network 105 collects sponsorship fees from advertisers. For example, a car manufacturer may desire to purchase the title of the preferred or official car of CR\overline{A}V. The car manufacturer can pay a sponsorship fee for the right to advertise its cars with that title. Additionally, the advertisers can provide products, coupons, or other incentives related to the preferred or official product, which the promoter can collect for the prize pool.

In step 3525, the promoter or the network 105 collects user fees for services related to the CR\overline{A}V ads. For example, the data storage center 195 can comprise an internet service provider (ISP), which can provide internet access to users of the ISP's services. A portion of the user fee paid by each user of the ISP's services can be allocated to the prize pool.

In step 3530, the promoter or the network 105 collects entrance fees from recipients that desire eligibility for specific prizes. For example, recipients that pay an entrance fee can be eligible for a larger prize pool because all or a portion of the entrance fee can be allocated to that prize pool. Alternatively, recipients can pay an entrance fee to become eligible for a prize available only to those recipients that pay the entrance fee. In an exemplary embodiment, recipients can pay a one-time, hourly, daily, monthly, annual, or lifetime entrance fee to become eligible for the certain prizes available during the corresponding time period.

In step 3535, the promoter or the network 105 collects non-cash prizes from advertisers. The advertisers can provide products, coupons, gift certificates, or other non-cash items, which can be used as prizes.

Then, in step 3540, the promoter designates prizes collected in steps 3505-3535 to create the prize pool from which to award prizes to recipients that respond to queries about a selected portion of an advertisement. All or a portion of any of the items collected in steps 3505-3535 can be designated for the prize pool. In an exemplary embodiment, the promoter can create the prize pool from the advertising premiums collected from the advertisers in step 3510. The promoter can use all or only a portion of the advertising premiums for the prize pool. In another exemplary embodiment, the promoter can create the prize pool from the network subscription fees collected in step 3505. The promoter can use all or only a portion of the network subscription fees for the prize pool. In yet another exemplary embodiment, the promoter can create the prize pool by combining advertising premiums and subscription fees. According to other exemplary embodiments, the prize pool can include network subscription fees, advertising premiums, MSO subscription fees, sponsorship fees, sponsorship prizes, user fees, entrance fees, and/or other non-cash prizes. Any reward (prize) given to responding, winning recipients can be based on the created prize pool. The reward can comprise cash from the prize pool, an item purchased with cash from the prize pool, and/or consumer goods or other non-cash items provided by the advertisers.

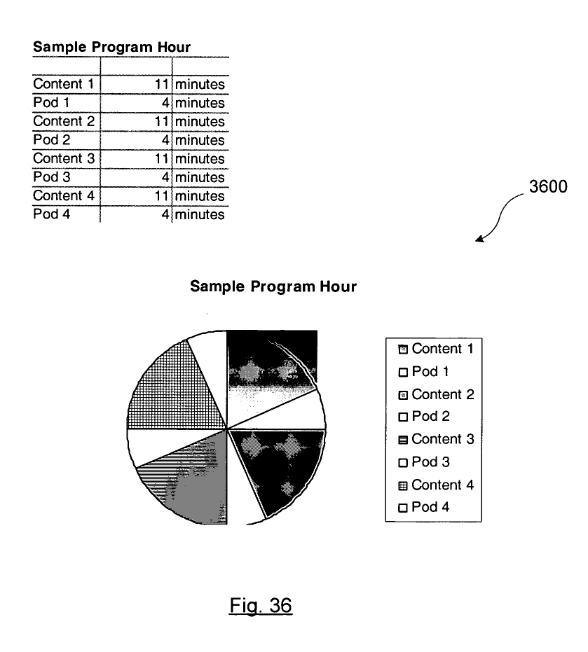

FIG. 36 is a pie chart 3600 depicting a broadcast hour according to an exemplary embodiment of the present invention. The pie chart 3600 represents a sample broadcast hour for an exemplary subscription mass-media cable network channel called “CR\overline{A}V TV” that distributes program content with general mass appeal. As illustrated, during each half hour, CR\overline{A}V TV distributes (broadcasts) 11 consecutive minutes of program content 1, followed by a 4-minute CR\overline{A}V ad pod 1 and interaction period, followed by a second 11-minute block of programming content 2 and a second 4-minute CR\overline{A}V ad pod 2 and interaction period. CR\overline{A}V TV repeats that broadcast distribution during the second half hour of each program hour.

CR\overline{A}V TV can charge its advertisers a premium over normal prices charged by similarly sized competitors who attract similar audience sizes and demographics. CR\overline{A}V TV can charge the premium because all ads on CR\overline{A}V TV are CR\overline{A}V ads and therefore can provide advertisers with greater consumer immersion. The CR\overline{A}V ads also can provide marketing access for advertisers to registered consumers who meet the specific demographic profile of the advertisers. In another exemplary embodiment, CR\overline{A}V TV can broadcast CR\overline{A}V ads and conventional ads and can charge the ad premium for only the CR\overline{A}V ads. However, CR\overline{A}V TV can charge a premium for a conventional ad broadcast in an ad pod that comprises at least one CR\overline{A}V ad because the immersion-enticing benefits of the CR\overline{A}V ad can increase immersion in the conventional ad broadcast in the same ad pod.

CR\overline{A}V TV also can charge subscriber recipients a subscription fee. For example, the subscription fee can be $5.00. The subscription fee can be allocated to one or all of CR\overline{A}V TV's costs, overhead, or profit, or an increased CR\overline{A}V ad prize pool. The increased CR\overline{A}V ad prize pool can entice more recipients to subscribe to CR\overline{A}V TV, thereby further increasing the prize pool and the audience size for CR\overline{A}V TV.

In an exemplary embodiment, the $5 monthly fee per subscriber can be allocated as follows: $0.50 to the multi-system cable operator and satellite distributors who enroll subscribers to CR\overline{A}V TV; $2.50 to additional CR\overline{A}V prizing and fulfillment; and $2.00 to CR\overline{A}V TV programming, overhead, and profit.

In another exemplary embodiment, the method described previously with reference to FIG. 34 can be applied to a multi-channel, CR\overline{A}V-enabled, subscription-based, mass-media network. In an exemplary embodiment, a representative multi-channel network (“CR\overline{A}V Network”) can comprise a mass-media broadcast and cable network of ten channels. Some or all of the channels can feature distinct, targeted programming. In addition to the anchor broadcast channel (CR\overline{A}V TV), the exemplary CR\overline{A}V Network also has nine other cable channels, including:

CR\overline{A}V TV West—The West Coast cable feed of CR\overline{A}V TV

CR\overline{A}V NEWS—A 24-hour news channel

CR\overline{A}V Family—A family-friendly channel of kids and family programming

CR\overline{A}V Sports 1— A 24-hour sports channel

CR\overline{A}V GAMES—A game show and interactive content channel

CR\overline{A}V Beauty—A female-oriented channel

CR\overline{A}V Classic Movies—A 24-hour movie channel

CR\overline{A}V HOT Music—A channel featuring today's contemporary music videos

CR\overline{A}V Country—A channel featuring today's contemporary country music videos

The cumulative program content distributed through the CR\overline{A}V Network can appeal to a wider audience than a single channel or network. Accordingly, the CR\overline{A}V Network can attract a wide variety of viewers, mass advertisers, and targeted advertisers.

All ad breaks on all channels of the CR\overline{A}V Network do not have to include CR\overline{A}V ads, and synchronizing ad breaks across all channels in not required. However, the cumulative effect of including more CR\overline{A}V ads and synchronizing CR\overline{A}V ads (and response periods) across the channels can allow the CR\overline{A}V Network to combine the CR\overline{A}V premiums and or subscription fees received from each channel into one pool of prizes. All channels can promote the combined, larger, and more attractive prize pool, including channels that have smaller audiences, thereby attracting more viewers to all channels. If a channel cannot synchronize a particular ad break with other channels, then that channel can promote a smaller, more-targeted prize based on the recipients watching only that channel.

Table I below illustrates an exemplary, sample program hour across all ten channels of the CR\overline{A}V Network according to an exemplary embodiment of the present invention. Table I represents synchronized and non-synchronized ad pods and reflects the prize pool values for each pod. As shown, the exemplary ad pods 1, 3, 4, and 5 are synchronized over all ten channels and have a combined prize pool of $109,550 available to winning recipients that respond to CR\overline{A}V queries. Four channels broadcast a synchronized ad pod 2, resulting in a combined prize pool of $66,500 available to recipients of those four channels. The CR\overline{A}V Beauty channel broadcasts a non-synchronized ad pod 2 having a prize pool of $8,400 available to recipients of that channel. During non-synchronized ad breaks, the ads, queries, and prizes can be targeted more toward the typical recipient demographic viewing the corresponding channel. For example, during ad pod 2, the CR\overline{A}V Beauty channel can offer ads, queries, and prizes targeting its female viewers. During synchronized ad breaks, the cumulative prize pool can include prizes having more mass appeal. Mass appeal prizes can include cash, televisions, computers, automobiles, food, etc. As illustrated by the four CR\overline{A}V Network channels that synchronize ad pod 2, any number of channels can synchronize ads, combine subscription or ad premium fees to create a larger prize pool, or direct ads to a larger demographic.

TABLE I
Prizing Analysis, 7:00-8:00 PM

| | | | Non- | | Non- | | Non- | | Non- | | Non- |
|---|---|---|---|---|---|---|---|---|---|---|---|
| | Viewing | Synch. | Synch. | Synch. | Synch. | Synch. | Synch. | Synch. | Synch. | Synch. | Synch. |
| | House- | Pod 1 | Pod 1 | Pod 2 | Pod 2 | Pod 3 | Pod 3 | Pod 4 | Pod 4 | Pod 5 | Pod 5 |
| Channel | holds* | prize | prize | prize | prize | prize | prize | prize | prize | prize | prize |
| CR\overline{A}V | 14.20 | $49,700 | n/a | $49,700 | n/a | $49,700 | n/a | $49,700 | n/a | $49,700 | n/a |
| TV | | | | | | | | | | | |
| CR\overline{A}V | 1.40 | $4,900 | n/a | $4,900 | n/a | $4,900 | n/a | $4,900 | n/a | $4,900 | n/a |
| TV West | | | | | | | | | | | |
| CR\overline{A}V | 2.30 | $8,050 | n/a | $8,050 | n/a | $8,050 | n/a | $8,050 | n/a | $8,050 | n/a |
| NEWS | | | | | | | | | | | |
| CR\overline{A}V | 1.60 | $5,600 | n/a | n/a | n/a | $5,600 | n/a | $5,600 | n/a | $5,600 | n/a |
| Family | | | | | | | | | | | |
| CR\overline{A}V | 3.10 | $10,850 | n/a | n/a | n/a | $10,850 | n/a | $10,850 | n/a | $10,850 | n/a |
| Sports | | | | | | | | | | | |
| CR\overline{A}V | 2.50 | $8,750 | n/a | n/a | n/a | $8,750 | n/a | $8,750 | n/a | $8,750 | n/a |
| G\overline{A}MES | | | | | | | | | | | |
| CR\overline{A}V | 2.40 | $8,400 | n/a | n/a | $8,400 | $8,400 | n/a | $8,400 | n/a | $8,400 | n/a |
| Beauty | | | | | | | | | | | |
| CR\overline{A}V | 1.50 | $5,250 | n/a | n/a | n/a | $5,250 | n/a | $5,250 | n/a | $5,250 | n/a |
| Classic | | | | | | | | | | | |
| Movies | | | | | | | | | | | |
| CR\overline{A}V | 1.10 | $3,850 | n/a | $3,850 | n/a | $3,850 | n/a | $3,850 | n/a | $3,850 | n/a |
| HOT | | | | | | | | | | | |
| Music | | | | | | | | | | | |
| CR\overline{A}V | 1.20 | $4,200 | n/a | n/a | n/a | $4,200 | n/a | $4,200 | n/a | $4,200 | n/a |
| Country | | | | | | | | | | | |
| | | $109,550 | $0 | $66,500 | $8,400 | $109,550 | $0 | $109,550 | $0 | $109,550 | $0 |

*=Millions
Prizes based on $3,500 per million prize allocation

The CR\overline{A}V Network can facilitate “road blocking” of ads by synchronizing ad pods across multiple channels. For example, a mass advertiser can purchase thirty-second ads on all ten channels during the 7:11 PM ad pod to ensure that all viewers on the entire CR\overline{A}V network become exposed to the ad. In an exemplary embodiment, the advertiser can elect to have identical placement locations within the pod on each channel. For example, the advertiser can place the ad as the first of five ads, insuring simultaneous exposure across all channels. Alternatively, the advertiser can elect a different or random location within the ad pod. Even that different or random location can be an effective road block because ad pods comprising a CR\overline{A}V ad can maintain viewers throughout the entire pod more successfully than conventional ad pods that tend to lose viewers over the duration of the pod. Road blocking of CR\overline{A}V ads also is possible across multiple networks or channels that are owned by multiple ownership groups.

In another exemplary embodiment, the method described previously with reference to FIG. 34 can be applied to subscription and non-subscription network channels. The cumulative program content distributed through the CR\overline{A}V Network can appeal to a wider audience than a single channel or network. Accordingly, the CR\overline{A}V Network can attract a wide variety of viewers and also mass advertisers and targeted advertisers. Additionally, some or all of the channels can be subscription-based as discussed above, or some of the channels can be subscription-based with one or more “free” channels being commonly distributed or over-air broadcast channels.

In an exemplary embodiment, the CR\overline{A}V TV channel on the CR\overline{A}V Network can be freely available as an over-air broadcast to all recipients. Additionally, the CR\overline{A}V News and CR\overline{A}V Family channels can be freely available over the cable network. The remaining seven channels on the CR\overline{A}V Network can be available only to subscribing recipients. The cumulative prize levels can be promoted across all channels, including the over-air CR\overline{A}V TV channel and the freely-available CR\overline{A}V News and CR\overline{A}V Family channels. In that case, the promotion can include the clarification that a smaller prize pool is available for non-subscribers and a larger prize pool is available to subscribers.

Table II below illustrates exemplary total CR\overline{A}V and subscription premiums allocated to a 7:11 CR\overline{A}V ad break across the ten channels of the CR\overline{A}V Network. The data of Table II is based on the following assumptions: CR\overline{A}V Network subscribers pay a $10 per month subscription fee for the nine cable channels, two of which are also available for free to non-subscribers; the CR\overline{A}V Network subscribers comprise forty percent of all viewers of the “free” over-air CR\overline{A}V TV channel, sixty percent of the viewers of the free cable channels, and ninety percent of viewers of the seven subscriber-only cable channels; and the remaining ten percent of viewers of subscriber-only cable channels comprise non-subscribers viewing the cable channels at a location outside of their home.

During the exemplary 7:11 ad pod illustrated by the statistics in Table II, the alert and query ads can explain that approximately $109,550 in prizes is available to ALL viewers, based on a prize premium of $3,500 per million viewers. The alert and query ads also can explain that over $261,000 in prizes is available to CR\overline{A}V network subscribers due to an additional $151,000 worth of prizes from subscription fees.

TABLE II
Prizing analyis, 7:11 PM Pod

| | | | | | Prizes from |
|---|---|---|---|---|---|
| | | Viewing | | Viewing Sub | CR\overline{A}V |
| Channel | Type | Households* | % Sub | Households* | Premiums |
| CR\overline{A}V TV | Over-air-free | 14.20 | 40% | 5.68 | $49,700 |
| CR\overline{A}V TV West | Cable-sub | 1.40 | 90% | 1.26 | $4,900 |
| CR\overline{A}V NEWS | Cable-free | 2.30 | 60% | 1.38 | $8,050 |
| CR\overline{A}V Family | Cable-free | 1.60 | 60% | 0.96 | $5,600 |
| CR\overline{A}V Sports | Cable-sub | 3.10 | 90% | 2.79 | $10,850 |
| CR\overline{A}V G\overline{A}MES | Cable-sub | 2.50 | 90% | 2.25 | $8,750 |
| CR\overline{A}V Beauty | Cable-sub | 2.40 | 90% | 2.16 | $8,400 |
| CR\overline{A}V Classic Movies | Cable-sub | 1.50 | 90% | 1.35 | $5,250 |
| CR\overline{A}V HOT Music | Cable-sub | 1.10 | 90% | 0.99 | $3,850 |
| CR\overline{A}V Country | Cable-sub | 1.20 | 90% | 1.08 | $4,200 |
| | | | | | $109,550 |

| | | | |
|---|---|---|---|
| CR\overline{A}V Premium/million: | 3,500 | $151,875 | sub prize allocation |
| CR\overline{A}V sub households- | 40.50 million | $261,425 | total prizes this pod |
| CR\overline{A}V monthly sub- | $10 per month | | |
| Prize allocation- | $4.50 per month | | |

| | | | | | |
|---|---|---|---|---|---|
| Daypart prize allocation- | 12 AM-5:59 AM | 5% | 6 hours = | $0.00125 per sub/hour | $0.00031 per sub/pod |
| | 6 AM-9:59 AM | 15% | 4 hours = | $0.00563 per sub/hour | $0.00141 per sub/pod |
| | 10 AM-11:59 AM | 5% | 2 hours = | $0.00375 per sub/hour | $0.00094 per sub/pod |
| | 12 PM-4:59 PM | 12% | 5 hours = | $0.00360 per sub/hour | $0.00090 per sub/pod |
| | 5 PM-6:59 PM | 15% | 2 hours = | $0.01125 per sub/hour | $0.00281 per sub/pod |
| | 7 PM-11 PM | 40% | 4 hours = | $0.01500 per sub/hour | $0.00375 per sub/pod |
| | 11 PM-11:59 PM | 8% | 1 hours = | $0.01200 per sub/hour | $0.00300 per sub/pod |
| | | 100% | 24 | | |

* = Millions

When a recipient registers in the data storage center 195, the recipient can indicate whether he is a subscriber to the CR\overline{A}V Network. The data storage center 195 can store that data as a demographic “tag.” In an environment where CR\overline{A}V prizes are awarded to subscribers and non-subscribers, the “subscription” tag can differentiate between the two criteria. The cable MSO or satellite programming distributors can confirm the recipient's subscription status at the time prize winners are verified and validated.

According to an exemplary embodiment, the prize pool can be allocated based on the value of the audience and size. For example, Table II indicates that the 7-11 PM viewing period (“prime time”) consists of a four-hour window. Prime time comprises only ⅙^{th} of the programming day. However, forty percent of the prize pool is allocated to prime time because the audience size is largest during that time, which can further enhance the prize levels and entice more viewers to the network and its channels.

The exemplary embodiments described above utilize “clustered” pod formats of CR\overline{A}V ad distribution having one or more CR\overline{A}V ads clustered together in a pod during an ad break. The clustered pod also can comprise one or more conventional ads. Other exemplary embodiments can utilize “interspersed” pod formats comprising multiple pods of advertisements that include a CR\overline{A}V ad. For example, each pod of ads can include at least one CR\overline{A}V ad featuring an alert such as a logo or tone that denotes the ad as a CR\overline{A}V ad. The interspersed CR\overline{A}V ads can be broadcast during multiple ad pods within a give time period. Then, a query about one or more of the ads that featured the alert can be communicated at the end of the given time period. In exemplary embodiments, the time period can comprise an hour or a half hour. The interspersed format can provide heightened attention to all ads within the broadcast program.

The embodiments described above are ideally suited for television broadcast communications mediums. However, the present invention is not limited to that medium and has applications in various other forms of mass-media. For example, the methods described above can be implemented in radio, magazine and newsprint, outdoor media, Internet broadcast, and direct mail applications. Radio and Internet broadcasting can significantly mirror the applications applied to television, especially with the deployment of subscription based radio stations and Internet web sites. Magazines and newsprint distributors already charge a subscription fee. They could charge a supplemental fee to subsidize increased CR\overline{A}V prizes. Similarly, an opt-in, subscription fee-based direct mail promotional campaign could utilize the fees to subsidize CR\overline{A}V prizes.

Radio, print, Internet, outdoor, and direct mail applications also can combine multiple channel CR\overline{A}V prize pools to increase the promoted value of the prize pool. For example, fifty radio stations can broadcast CR\overline{A}V versions of single or multiple ads and can pool the ad premiums or subscription fees. Additionally, each station can promote the combined prize pool. Such a format also can apply to multiple magazines and/or newspapers, Internet web sites, or direct mail houses.

The embodiments described above also apply to a converged platform (across multiple mass-media networks). For example, CR\overline{A}V ad premiums and subscription fees from radio or other mass-media can be added to the prize pool previously described in Table II (from both subscription and advertising). Additionally, CR\overline{A}V ad premiums and subscription fees from a print CR\overline{A}V campaign that directs readers to the radio ads or televised ads on the CR\overline{A}V network also can be added to the prize pool.

Although specific embodiments of the present invention have been described above in detail, the description is merely for purposes of illustration. Various modifications of, and equivalent steps corresponding to, the disclosed aspects of the exemplary embodiments, in addition to those described above, also can be made by those skilled in the art without departing from the spirit and scope of the present invention defined in the following claims, the scope of which is to be accorded the broadest interpretation so as to encompass such modifications and equivalent structures.

What is claimed is:

1. A method for providing advertising, comprising the steps of:
collecting a subscription fee from a plurality of subscriber recipients of a mass-media, non-interactive broadcast network;
creating a prize pool comprising at least a portion of the subscription fee;
communicating via the mass-media, non-interactive broadcast network a plurality of advertisements to the subscriber recipients, the plurality of advertisements comprising advertising content for each advertisement;
communicating a query about a selected portion of the advertising content of at least one of the advertisements;
presenting an offer of a reward as an incentive for each subscriber recipient to become exposed to the advertisements and to submit a response to the query, the reward comprising one of at least a portion of the prize pool and a prize purchased with at least a portion of the prize pool; and
collecting, through a medium other than the mass-media, non-interactive broadcast network, the respective response to the query from each of responding ones of the subscriber recipients,
wherein receipt of each response having a correct reply to the query verifies that the responding subscriber recipient has been exposed to at least the selected portion of the advertising content.

2. The method of claim 1, wherein the mass-media, broadcast network comprises a plurality of channels, and
wherein the step of communicating the advertisements comprises communicating the advertisements to the subscriber recipients via the plurality of channels on the mass-media, non-interactive broadcast network.

3. The method of claim 2, wherein the step of communicating the advertisements comprises simultaneously communicating the advertisements to the subscriber recipients via the plurality of channels on the mass-media, non-interactive broadcast network.

4. The method of claim 1, wherein the step of communicating the advertisements comprises simultaneously transmitting the advertisements via a plurality of mass-media, non-interactive broadcast networks for delivery to the subscriber recipients.

5. The method of claim 1, wherein the prize pool further comprises at least a portion of an advertising premium charged for at least one of the advertisements.

6. The method of claim 1, further comprising the step of granting the reward to at least one of the subscriber recipients submitting the response to the query.

7. The method of claim 1, further comprising the step of communicating an alert informing the subscriber recipients to pay attention to a communication of the selected portion of the advertising content.

8. The method of claim 7, wherein presentation of the alert to the subscriber recipients is separate from presentation of the selected portion of the advertising content to the subscriber recipients.

9. The method of claim 7, wherein the alert is presented to the subscriber recipients at a first time and the selected portion of the advertising content is presented to the subscriber recipients at a second time, and
wherein the first time is different from the second time.

10. The method of claim 7, wherein presentation of the alert to the subscriber recipients is accomplished via a first communications medium and presentation of the advertisements to the subscriber recipients is accomplished via a second communications medium, the first communications medium being different from the second communications medium.

11. The method of claim 7, wherein delivery to the subscriber recipients of the alert and the advertisements is independent from presentation of the alert and the advertisements to the subscriber recipients.

12. The method of claim 1, wherein the step of communicating the query comprises communicating the query via a communications medium that is different than the communications medium of the mass-media, non-interactive broadcast network.

13. The method of claim 1, wherein the step of communicating the advertisements comprises:
broadcasting to the subscriber recipients an advertisement comprising a vignette including the selected portion of the advertising content; and
broadcasting to the subscriber recipients an advertisement comprising the query including at least one question, thereby performing the step of communicating a query, wherein the subscriber recipients can respond to the query by submitting the response, each response comprising an answer to at least one question of the query.

14. The method of claim 13, wherein the step of communicating the advertisements further comprises broadcasting an advertisement comprising an alert that provides the subscriber recipients with advance notice that the vignette is scheduled for subsequent delivery to the subscriber recipients.

15. The method of claim 14, wherein the step of communicating the advertisements further comprises broadcasting a sneak peek vignette that communicates to the subscriber recipients at least a portion of the vignette to assist in answering the query.

16. A method for providing advertising, comprising the steps of:
collecting a subscription fee from a plurality of subscriber recipients of a mass-media, non-interactive broadcast network comprising a plurality of channels, at least one of the channels being available to non-subscriber recipients;
creating a prize pool comprising at least a portion of the subscription fee;
communicating via the plurality of channels on the mass-media, non-interactive broadcast network a plurality of advertisements to the subscriber recipients and the non-subscriber recipients, the plurality of advertisements comprising advertising content for each advertisement;
communicating a query about a selected portion of the advertising content of at least one of the advertisements;
presenting an offer of a reward as an incentive for each subscriber recipient and non-subscriber recipient to become exposed to the advertisements and to submit a response to the query, the reward being based on the prize pool; and
collecting, through a medium other than the mass-media, non-interactive broadcast network, the respective response to the query from each of responding ones of the subscriber recipients and the non-subscriber recipients,
wherein receipt of each response having a correct reply to the query verifies that the respective responding subscriber recipients and non-subscriber recipients have been exposed to at least the selected portion of the advertising content.

17. The method of claim 16, wherein the step of communicating the advertisements comprises simultaneously communicating the advertisements to the subscriber recipients and the non-subscriber recipients via the plurality of channels on the mass-media, non-interactive broadcast network.

18. The method of claim 16, wherein the step of creating a prize pool comprises creating a first prize pool for subscriber recipients and a second prize pool for non-subscriber recipients,
wherein the step of presenting an offer of a reward comprises presenting an offer of a first reward based on the first prize pool to subscriber recipients and an offer of a second reward based on the second prize pool to non-subscriber recipients.

19. The method of claim 18, wherein the first prize pool is larger than the second prize pool.

20. The method of claim 18, wherein the first prize pool comprises the at least a portion of the subscription fee, and
wherein the second prize pool does not comprise a portion of the subscription fee.

21. The method of claim 16, wherein the prize pool further comprises at least a portion of an advertising premium charged for at least one of the advertisements.

22. The method of claim 16, further comprising the step of granting the reward to at least one of the subscriber recipients and the non-subscriber recipients submitting the response to the query.

23. The method of claim 16, further comprising the step of communicating an alert informing the subscriber recipients and the non-subscriber recipients to pay attention to a communication of the selected portion of the advertising content.

24. The method of claim 23, wherein presentation of the alert to the subscriber recipients and the non-subscriber recipients is accomplished via a first communications medium and presentation of the advertisements is accomplished via a second communications medium, the first communications medium being different from the second communications medium.

25. The method of claim 23, wherein delivery of the alert and the advertisements to the subscriber recipients and the non-subscriber recipients is independent from presentation of the alert and the advertisements to the subscriber recipients and the non-subscriber recipients.

26. The method of claim 16, wherein the step of communicating the query comprises communicating the query via a communications medium that is different than the communications medium of the mass-media, non-interactive broadcast network.

27. The method of claim 16, wherein the step of communicating the advertisements to the subscriber recipients and the non-subscriber recipients comprises:
broadcasting an advertisement comprising a vignette including the selected portion of the advertising content to the subscriber recipients and the non-subscriber recipients; and
broadcasting an advertisement comprising the query including at least one question to the subscriber recipients and the non-subscriber recipients, thereby performing the step of communicating a query, wherein the subscriber recipients and the non-subscriber recipients can respond to the query by submitting the response.

28. The method of claim 27, wherein the step of communicating the advertisements further comprises broadcasting an advertisement comprising an alert that provides the subscriber recipients and the non-subscriber recipients with advance notice that the vignette is scheduled for subsequent delivery.

29. The method of claim 28, wherein the step of communicating the advertisements further comprises broadcasting a sneak peek vignette for communicating to the subscriber recipients and the non-subscriber recipients at least a portion of the vignette to assist in answering the query.

30. A system for providing advertising, comprising:
a mass-media, non-interactive broadcast network operative to communicate a plurality of advertisements to a mass audience comprising a plurality of subscriber recipients that receive the broadcast network upon payment of a subscription fee, the plurality of advertisements comprising advertising content for each advertisement;
a communications medium operative to communicate a query about a selected portion of the advertising content of at least one of the advertisements;
a reward communications medium operative to communicate an offer of a reward as an incentive to submit a response to the query, the reward based on a prize pool that comprises at least a portion of the subscription fee;
a plurality of response devices, each operative by one of the subscriber recipients to communicate, through a medium other than the mass-media, non-interactive broadcast network, a respective response to the query; and
an information gathering system operative to collect each response to the query communicated from the respective response devices,
wherein receipt of each response having a correct reply to the query verifies that the responding subscriber recipient has been exposed to at least the selected portion of the advertising content.

31. The system of claim 30, wherein the mass-media, non-interactive broadcast network comprises a plurality of channels and communicates the advertisements to the subscriber recipients via the plurality of channels.

32. The system of claim 31, wherein the mass-media, non-interactive broadcast network simultaneously communicates the advertisements to the subscriber recipients via the plurality of channels.

33. The system of claim 30, wherein the prize pool further comprises at least a portion of an advertising premium charged for at least one of the advertisements.

34. The system of claim 30, further comprising a plurality of the mass-media, non-interactive broadcast networks, each operative to communicate the advertisements to the mass audience.

35. The system of claim 34, wherein each of the broadcast networks is operative to simultaneously communicate the advertisements for reception by the mass audience.

36. The system of claim 34, wherein the plurality of broadcast networks comprises one or more of cable, satellite, streaming Internet, and private networks.

37. The system of claim 30, further comprising a database that stores the responses to the query in response to receiving the responses collected by the information gathering system, the database further operative to store identifying information for at least the subscriber recipients registered in advance to submit the responses to the query, the identifying information useful to match the responses to the query to the subscriber recipients that have registered to submit the responses.

38. The system of claim 30, wherein a grant of the reward occurs after the submission of each response by the subscriber recipients and is provided at a time subsequent to communication of the advertisements to the subscriber recipients based upon confirmation of a correct response to the query.

39. The system of claim 30, further comprising an alert communications medium operative to communicate an alert that informs the subscriber recipients to pay attention to communication of the advertisements.

40. The system of claim 39, wherein the alert is presented to the subscriber recipients at a first time and the content is presented to the subscriber recipients at a second time, and wherein the first time is different from the second time.

41. The system of claim 39, wherein the alert communications medium is different from the mass-media, non-interactive broadcast network.

42. The system of claim 39, wherein the mass-media, non-interactive broadcast network comprises the alert communications medium.

43. The system of claim 39, wherein delivery to the subscriber recipients of the alert and the content is independent from presentation of the alert and content to the subscriber recipients.

44. The system of claim 30, wherein the query communications medium is different from the mass-media, non-interactive broadcast network.

45. The system of claim 30, wherein the mass-media, non-interactive broadcast network comprises the query communications medium.

46. The system of claim 30, wherein the plurality of advertisements comprises:
an advertisement comprising a vignette including the selected portion of the advertising content;
an advertisement comprising the query; and
an advertisement comprising an alert that provides notice of delivery of the vignette.

47. The system of claim 46, wherein the plurality of advertisements further comprises an advertisement comprising a sneak peek vignette comprising at least a portion of the vignette to assist in preparing a reply to the query.

48. The system of claim 46, wherein presentation of the query to the subscriber recipients is separate from presentation of the vignette to the subscriber recipients.

49. A method for providing advertising, comprising the steps of:
creating a prize pool;
communicating via a mass-media, non-interactive broadcast network a plurality of advertisements to a plurality of recipients, the plurality of advertisements comprising advertising content for each advertisement;
communicating a query about a selected portion of the advertising content of at least one of the advertisements;
presenting an offer of a reward as an incentive for each recipient to become exposed to the advertisements and to submit a response to the query, the reward being based on the prize pool;
collecting, through a medium other than the mass-media, non-interactive broadcast network, the respective response to the query from each of responding ones of the recipients, wherein receipt of each response having a correct reply to the query verifies that the responding recipient has been exposed to at least the selected portion of the advertising content; and
selecting a recipient that submits a response to the query as a winner of the reward.

50. The method of claim 49, wherein the creating step comprises the steps of:
collecting a subscription fee from recipients of the network; and
designating at least a portion of the subscription fee to the prize pool.

51. The method of claim 49, wherein the creating step comprises the steps of:
collecting an advertising premium for at least one of the advertisements; and
designating at least a portion of the advertising premium to the prize pool.

52. The method of claim 49, wherein the creating step comprises the steps of:
collecting a subscription fee from a multi-system operator (“MSO”) of the network; and
designating at least a portion of the MSO subscription fee to the prize pool.

53. The method of claim 49, wherein the creating step comprises the steps of:
collecting a sponsorship fee; and
designating at least a portion of the sponsorship fee to the prize pool.

54. The method of claim 49, wherein the creating step comprises the steps of:
collecting an entrance fee from recipients to make the recipients eligible to win the reward; and
designating at least a portion of the entrance fee to the prize pool.

55. The method of claim 49, wherein the creating step comprises the steps of:
collecting non-cash prizes; and
designating at least a portion of the non-cash prizes to the prize pool.

56. The method of claim 49, wherein the selecting step comprises the steps of:
identifying each recipient that submitted a correct response to the query; and
selecting one of the identified recipients as the winner of the reward.

57. The method of claim 49, wherein the selecting step comprises the steps of:
identifying each recipient that submitted a correct response to the query;
presenting at least one follow-up question to the identified recipients;
receiving responses to the at least one follow-up query from the identified recipients;
identifying each recipient that submitted a correct response to the follow-up query; and
selecting one of the recipients that submitted a correct response to the follow-up query as the winner of the reward.

58. The method of claim 57, wherein the follow-up question comprises at least one of a trivia question, a skill-based question, and a demographic-based question.

59. The method of claim 49, wherein the step of communicating the query comprises communicating the query via a communications medium that is different than the communications medium of the network.

60. The method of claim 49, wherein the step of communicating the advertisements comprises:
broadcasting to the recipients an advertisement comprising a vignette including the selected portion of the advertising content; and
broadcasting to the recipients an advertisement comprising the query including at least one question, thereby performing the step of communicating a query, wherein the recipients can respond to the query by submitting the response, each response comprising an answer to at least one question of the query.

61. The method of claim 60, wherein the step of communicating the advertisements further comprises broadcasting an advertisement comprising an alert that provides the recipients with advance notice that the vignette is scheduled for subsequent delivery to the recipients.

62. A method for providing advertising, comprising the steps of:
communicating via a mass-media, non-interactive broadcast network a plurality of advertisements to a plurality of recipients, the plurality of advertisements comprising advertising content for each advertisement;
collecting an advertising premium for at least one of the advertisements;
creating a prize pool comprising at least a portion of the advertising premium;
communicating a query about a selected portion of the advertising content of at least one of the advertisements;
presenting an offer of a reward as an incentive for each recipient to become exposed to the advertisements and to submit a response to the query, the reward being based on at least a portion of the prize pool;
collecting, through a medium other than the mass-media, non-interactive broadcast network, the respective response to the query from each of responding ones of the recipients, wherein receipt of each response having a correct reply to the query verifies that the responding recipient has been exposed to at least the selected portion of the advertising content; and
selecting a recipient that submits a response to the query as a winner of the reward.

63. The method of claim 62, wherein the advertising premium comprises a non-cash prize.

64. The method of claim 62, wherein the selecting step comprises the steps of:
identifying each recipient that submitted a correct response to the query; and
selecting one of the identified recipients as the winner of the reward.

65. The method of claim 62, wherein the selecting step comprises the steps of:
identifying each recipient that submitted a correct response to the query;
presenting at least one follow-up question to the identified recipients;
receiving responses to the at least one follow-up query from responding ones of the identified recipients;
identifying each recipient that submitted a correct response to the follow-up query; and
selecting one of the recipients that submitted a correct response to the follow-up query as the winner of the reward.

66. The method of claim 65, wherein the follow-up question comprises at least one of a trivia question, a skill-based question, and a demographic-based question.

67. The method of claim 62, wherein the mass-media, broadcast network comprises a plurality of channels, and
wherein the step of communicating the advertisements comprises communicating the advertisements to the recipients via the plurality of channels on the mass-media, non-interactive broadcast network.

68. The method of claim 62, further comprising the step of communicating an alert informing the recipients to pay attention to a communication of the selected portion of the advertising content.

69. The method of claim 68, wherein presentation of the alert to the recipients is accomplished via a first communications medium and presentation of the advertisements to the recipients is accomplished via a second communications medium, the first communications medium being different from the second communications medium.

70. The method of claim 62, wherein the step of communicating the query comprises communicating the query via a communications medium that is different than the communications medium of the mass-media, non-interactive broadcast network.

71. The method of claim 62, wherein the step of communicating the advertisements comprises:
broadcasting to the recipients an advertisement comprising a vignette including the selected portion of the advertising content; and
broadcasting to the recipients an advertisement comprising the query including at least one question, thereby performing the step of communicating a query, wherein the recipients can respond to the query by submitting the response, each response comprising an answer to at least one question of the query.

72. The method of claim 71, wherein the step of communicating the advertisements further comprises broadcasting an advertisement comprising an alert that provides the recipients with advance notice that the vignette is scheduled for subsequent delivery to the recipients.

73. A method for providing advertising, comprising the steps of:
communicating via a mass-media, non-interactive broadcast network a plurality of advertisements to a plurality of recipients, the plurality of advertisements comprising advertising content for each advertisement;
collecting an entrance fee from the recipients;
creating a prize pool comprising at least a portion of the entrance fee;
communicating a query about a selected portion of the advertising content of at least one of the advertisements;
presenting an offer of a reward as an incentive for each recipient to become exposed to the advertisements and to submit a response to the query, the reward being based on at least a portion of the prize pool;
collecting, through a medium other than the mass-media, non-interactive broadcast network, the respective response to the query from each of responding ones of the recipients, wherein receipt of each response having a correct reply to the query verifies that the responding recipient has been exposed to at least the selected portion of the advertising content; and
selecting a recipient that submits a response to the query as a winner of the reward.

74. The method of claim 73, wherein the selecting step comprises the steps of:
identifying each recipient that submitted a correct response to the query; and
selecting one of the identified recipients as the winner of the reward.

75. The method of claim 73, wherein the selecting step comprises the steps of:
identifying each recipient that submitted a correct response to the query;
presenting at least one follow-up question to the identified recipients;
receiving responses to the at least one follow-up query from responding ones of the identified recipients;
identifying each recipient that submitted a correct response to the follow-up query; and
selecting one of the recipients that submitted a correct response to the follow-up query as the winner of the reward.

76. The method of claim 75, wherein the follow-up question comprises at least one of a trivia question, a skill-based question, and a demographic-based question.

77. The method of claim 73, wherein the mass-media, broadcast network comprises a plurality of channels, and
wherein the step of communicating the advertisements comprises communicating the advertisements to the recipients via the plurality of channels on the mass-media, non-interactive broadcast network.

78. The method of claim 73, further comprising the step of communicating an alert informing the recipients to pay attention to a communication of the selected portion of the advertising content.

79. The method of claim 78, wherein presentation of the alert to the recipients is accomplished via a first communications medium and presentation of the advertisements to the recipients is accomplished via a second communications medium, the first communications medium being different from the second communications medium.

80. The method of claim 73, wherein the step of communicating the query comprises communicating the query via a communications medium that is different than the communications medium of the mass-media, non-interactive broadcast network.

81. The method of claim 73, wherein the step of communicating the advertisements comprises:
broadcasting to the recipients an advertisement comprising a vignette including the selected portion of the advertising content; and
broadcasting to the recipients an advertisement comprising the query including at least one question, thereby performing the step of communicating a query, wherein the recipients can respond to the query by submitting the response, each response comprising an answer to at least one question of the query.

82. The method of claim 81, wherein the step of communicating the advertisements further comprises broadcasting an advertisement comprising an alert that provides the recipients with advance notice that the vignette is scheduled for subsequent delivery to the recipients.
